(19) United States
(12) Patent Application Publication
(10) Pub. No.: US 2012/0274775 A1
(43) Pub. Date: Nov. 1, 2012

(54) Imager-based code-locating, reading and response methods and apparatus

(76) Inventor: Leonard Reiffel, Chicago, IL (US)

(21) Appl. No.: 13/317,547

(22) Filed: Oct. 20, 2011

Related U.S. Application Data
(60) Provisional application No. 61/575,938, filed on Aug. 31, 2011.
(60) Provisional application No. 61/405,086, filed on Oct. 20, 2010.

(51) Int. Cl. H04N 7/18

(52) U.S. Cl. 348/158; 348/E07.085

(57) ABSTRACT

In one form, an audience participation method and apparatus whereby mass audience members who are physically present in a venue can, upon being cued, convey quantitative data regarding their personal real-time individual and collective preferences, choices, opinions, and other personal responses concerning events taking place in the venue or otherwise, to digital image data processing systems, data bases and data transmission media by the act of posing passive, user-manipulated personal data-source devices, a multiplicity of such devices being visible within the Field of View (FOV) of one or more venue-associated digital imagers which can collect images of the devices and pass said images to image analysis computer programs with the analysis results being promptly available for uses by other venue systems such as those used for announcements and displays to the venue audiences as well as optionally being made available to information systems addressing audiences not within the venue.

This application claims priority to U.S. provisional applications 61/575,938 filed 31 Aug., 2011 and 61/405,086 filed 20 Oct., 2010, both in the name of Leonard Reiffel, both of which are incorporated herein by reference.

### 0.1 PROLOGUE

This document discloses novel methods, apparatus, components and elements which, when used in a given venue and operated with appropriate communications data-processing hardware, software programs, data-bases, displays and other interfaces to human users and, if desired, to other support elements all of which, taken together, constitute a LAR-System (Locate And React-System).

### BRIEF DESCRIPTION OF THE DRAWINGS

FIG. 1 is a schematic representation of a multi-color code.

FIG. 2 is a top schematic view of an adapter and accessories for use with PDAs, smartphones & other devices.

FIG. 3 is a front plan view of the adapter and accessories of FIG. 2.

FIG. 4 is a schematic representation of adapters and accessories for use with cellphones, PDA & other devices.

FIG. 5 is a schematic representation of one form of an imager that can be used with the invention.

FIG. 6 is a schematic representation of another form of an imager that can be used with the invention.

FIG. 7 is a schematic representation of another form of a code that can be used with the invention.

FIG. 8 is a schematic representation of another form of a code that can be used with the invention.

FIG. 9 is a schematic representation of a compound code that can be used with the invention.

FIG. 10 is a schematic representation of another form of a code that can be used with the invention.

FIG. 11 is a schematic representation of a code formed in a graphic that can be used with the invention.

FIG. 12 is a schematic representation of a code that employs both obscuration and disclosure mechanisms.

FIG. 13 is a schematic representation of several examples of LARsponders in a given area.

FIG. 14 is a schematic representation of a several other examples of LARsponders in a given area.

FIG. 15 is a schematic representation of a several other examples of LARsponders in a given area.

FIG. 16 is a schematic representation of a several other examples of LARsponders in a given area.

FIG. 17 is a schematic representation of a one form of LARsponders in a given area

FIG. 18 is a schematic representation of several forms of 3-dimensional Larcodes & LARsponders in a given area.

FIG. 19 is a schematic representation of several forms of 2-dimensional LARsponders located on various items.

FIG. 20 is a schematic representation of several forms of 2-dimensional LARsponders located on various items.

FIG. 21 is a schematic representation of several forms of 3-dimensional items that include Larsponders.

FIG. 22 is a schematic representation of several forms of 2-dimensional LARsponders located on various items.

FIG. 23 is a schematic representation of several forms of two-sided LARsponders.

FIG. 24 is a perspective view of a stadium containing various LAR-Readers.

FIG. 25 is a schematic representation of LAR-Readers used in a variety of settings.

FIG. 26 is a schematic representation of several forms of LARsponders.

Purely for purposes of introduction, a few examples of aspects of the novel disclosed Art used to create LAR-Systems are sketched below. These sketches are NOT intended as limiting or defining the Art to be disclosed in more detail in subsequent parts of this document:

1. Imaging methods and apparatus which adapt, accessorize, and enable use of a single imager to capture information for purposes of locating data sources in a venue, capturing and decoding, tracking, reading, and validating said source data which can be variable and which can convey relevant information based upon such data to LAR-Systems thereby eliciting appropriate responses or actions there-from, as well as to other systems, data-bases and/or to human users. Multiple single imagers with different lines of sight (LOS) and fields of view (FOV) can be used in a given venue. The imagers that can be adapted to the purposes described herein include (but are not limited to) those designed for commercial and consumer-level digital photography and videography. The imagers and can be installed on fixed, portable, mobile, or other platforms including but not limited to aircraft, helicopters (manned or unmanned such as the recently announced AR video “toy” device by Parrot AC), loitering drones, and aerostats, etc.

2. Novel forms of physical apparatus and methods of construction for creating sources of encoded data usable by a LAR-System and which are locatable and readable from substantial distances under a wide range of circumstances by a wide range of types of imagers adapted for LAR-System use. Such sources of encoded data and information, among other features, can contain very high density or only modest amounts of data and can be disposable and/or use-specific etc.

3. Methods and apparatus enabling users to control, modify, or manipulate the physical properties, qualifications, validity, appearance, information content, time or spatial behavior etc. of such information sources as described above thereby enabling two-way, real-time data communication from human users to LAR-Systems as well as from LAR-Systems to human users.

4. Methods and apparatus which can provide any or all members of an audience (ranging from a single individual to crowds of 100's of thousands or more) with capabilities for simultaneous participative, responsive, or other types of interactions with LAR-Systems and each other on sub-second time-scales thereby enabling voting, opinion-collection, instant large-scale market research, competitive “mob play” etc. involving whole audiences, sub-groups, individuals and/or combinations thereof. Data so collected can be salable to advertisers, media buyers, PR Agencies etc.

5. Venue activities can be based upon the moment-by-moment unrehearsed, even unscheduled live sports or other “live” happenings in a venue. Activities can employ additional material (replays, ads, instant contests, games, etc.) as presented on venue video screens and/or shared via individual displays. Out-of-venue “remote” participants can also be accommodated. Results can be rapidly known and can enhance emotional and/or competitive involvement in audiences of any size. Activities in venues equipped with LAR-Systems can have psychological appeal by facilitating spontaneous formation of “fans”, “groups”, or “community” atmospheres from among individuals located/seated relatively together or even among more distant participants with shared opinions, loyalties etc.

6. LAR-System-based activities can fill “down-time” in venue action (e.g. in an entire football game there are about 25 minutes of actual play) with new types of entertainment, contests, offers, thus benefiting venue owners, interested promoters/advertisers/media-buyers etc.

7. Open spaces which are accessible to the public such as parks, beaches, sidewalks, hotel lobbies, transportation system waiting areas and terminals become versatile highly interactive and exciting environments. Under-used, temporarily or permanently-closed venues such as dis-used motion picture theaters, meeting halls, amphitheaters etc. can be periodically re-opened to host special types of entertainments and/or revenue-producing “action”.

8. LAR-Systems can provide unique and versatile interactive capabilities and directed incentives to particular user types, qualifications, locations etc. and offer other opportunities to increase in-venue vendor sales including, for example, on-site automated auctions in venues such as Malls, large or small retail outlets etc in which bidders can participate conveniently and/on a pre-planned OR impulse basis. See Appendices for more details.

9. In a very wide range of LAR-System applications, there is no requirement for participants to make use personal equipment or to subscribe to or access specific communications services. LAR-System use need NOT involve any charges whatever against user smart-phone “connectivity minutes” and does not require that participants have some particular Software Application installed or particular “device” skill.

10. Non-traditional participative and entertainment areas such as passenger aircraft, trains and buses, when equipped with LAR-Systems can become collective interactive environments for product or other promotions, “team” games and entertainment of the occupants.

11. Many areas of the world, large populations still lack or are seriously under-served with regard to wireless networks, mobile phone ubiquity etc. Such populations can, nevertheless, participate in many types of LAR-System-based special events or venue-specific experiences almost immediately. The technology can be wholly self-sufficient and self-contained. Versions of it can be packaged to be installed in a venue, operated, and then removed quickly and economically.

### 0.2 APPLICANT'S RELEVANT ISSUED US PATENTS

The present Applicant has previously disclosed and patented certain particular types of coded data sources and associated imager apparatus and methods to be used with them. The following Table lists the US versions of these patents.

| | | | |
|---|---|---|---|
| 1 | 7,377,438 | [T] | Combined imaging coded data source data |
| | | | acquisition |
| 2 | 7,184,075 | [T] | Imaged coded data source tracking product |
| 3 | 7,161,581 | [T] | Annotating imaged data product |
| 4 | 7,137,711 | [T] | Multi-user retro reflector data input |
| 5 | 7,099,070 | [T] | Multi-imager multi-source multi-use coded data |
| | | | source data input product |
| 6 | 7,000,840 | [T] | Dual mode data imaging product |
| 7 | 6,945,460 | [T] | Image coded data source transducer product |
| 8 | 6,708,885 | [T] | Dual mode data imaging product |

Applicant's prior issued patents, as listed above, disclose among other concepts, codes in the form of passive generally planar entities carrying a group of pigmented regions such as colored Blocks or stripes or other simple shapes, each color being chosen from a specified repertoire. Data are encoded using combinations of regions in different colors and different positions on the code. Methods and apparatus are described, including, in particular and for example, regions that are retro-reflecting in the infra-red used as aids to locating and isolating coded ROIs (Regions of Interest).

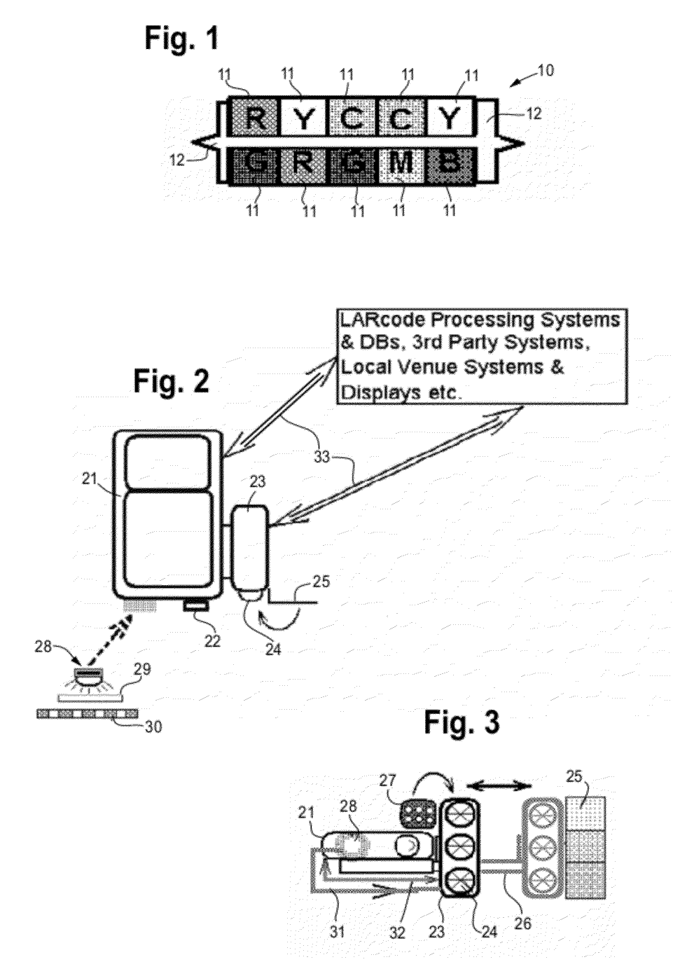

A simple example of a typical code 10 is shown in FIG. 1. Using the 6 basic colors typical of video color bars (RGBCMY—red, green, blue, cyan, magenta, yellow) in an array of 5×2 solid color Blocks 11 (plus two R & G Reference Blocks 12), each 0.4″×0.5″, which will be further discussed in Section B, offers a universe of ˜60 million code combinations in a strip 1″ wide and 2.75″ long. A code 10 can include one or more LOCATE “Blocks” 12 or “regions” of retro-reflective (sometimes referred to, herein, as “RR”) foil, or other RR material, which are next to or otherwise spatially-associated with color-coded “Block” portions or code “elements” 11 of the code 10. These RRs 12 (shown are merely examples of many possible types/shapes) aid in locating and tracking the codes within a scene and can also define a “Reading” direction for the code 10. In this example, shown in FIG. 1, two Retro-Reflective (RR) end-strips 12 add ˜0.75 inches to the overall length and each shaded Block 11 is one solid color. Codes 10 can be much smaller or larger than in this example. NOTE: Throughout the present document, different colors are conveyed as different monochrome shadings and patterns merely for convenience and avoid the necessity of color printing.

Images of a code color Block sequence and other information about the code 10, as acquired by suitable sensors, can be conveyed to information data processing systems. The color Block 11 sequence so acquired by the information system can inform it as to which of many Application Software programs available to it each specific code's instantaneous position, size, pose, etc. is to be routed.

Each color Block 11 on a code 10 can be of significant (specific but non-critical) width and height relative to the overall code dimensions. The code data conveyed by the code depends upon the overall configuration of the array of color areas. LARcodes 10 can be properly READ even though not sharply focused because colors used in a region in an image of a LARcode can be determined despite blurring. For a given type of optics and sensor resolutions, this also allows their use over a markedly extended range of stand-off distances. This property is in contrast to the need to determine precise details of a variable set of relative widths of monochrome black lines and their spacing (thin to wide) when, for example, typical BARcodes are used. NOTE: The previous remark is not intended to EXCLUDE the use of BARcodes or other encoding formats when the imagers being used to implement the novel methods and apparatus concepts taught herein have sufficient resolution to read them reliably. LARcodes 10 can take many forms and can be as simple as pieces of printed paper or a plastic strips, or in similar form that can be adhered or otherwise fastened on an item of interest or made structurally part of it.

One type of Imager described in the Applicant's previous patents is comprised of two imagers ideally sharing common Lines of Sight (LOS) and Fields of View (FOV). These are accompanied by a closely co-located Illuminator which may, for example, be an IR source. The first image can be an RGB color video camera (using one or more sensor elements intended for imaging in the visible spectrum or portions thereof. The second, in this example, can be a similar video camera selectively sensitive to IR.

The first Imager outputs traditional RGB color video of a scene. The second Imager provides monochrome IR video imagery LOCATE data (precisely spatially registered with the color video and time-synchronized with it) which can be processed to show only the bright IR retro-reflections from the RRs on the LARcode. This enables fast and computationally efficient isolation, analysis, and motion tracking of LARcode locations in the color video data and efficient Reading of the color-encoded data carried by such LARcodes. A second and functionally equivalent LAR-Reader, also disclosed in Applicant's prior patents consists of a pair of sensor arrays, one for the visible spectrum and one for IR (e.g. 2 CCD pixel arrays), which are combined in a single imager.

Since IR is not visible to the human eye, the presence and operation of LAR-Readers which use IR to execute RR LOCATE functions can, if necessary, remain covert, non-alerting, non-cueing and non-disturbing to occupants/users while the general environment's “normal” illumination is (or can be) arranged to provide sufficient visible light for the code Color imagers.

### 0.3 INTRODUCTION

The concepts and configurations, as taught by the above listed Patents, are useful. However, they have certain limitations which are overcome by the teachings disclosed in the present document. These teachings represent a significant advancement over the previous art and offer capabilities and features which are both novel and useful in a wide variety of commercially important applications.

In Part A of this Patent application, multiple new forms of LAR-Reader apparatus and methods are disclosed which are created by incorporating, accessorizing &/or augmenting various types of commercial imagers in unique ways and complementing them with novel software and information system features.

In Part B of this Patent application, new and unique forms of LARcodes per se are disclosed which serve new and useful functions, and which can also employ new methods & apparatus using combinations formed by associating LARcodes together &/or associating LARcodes with other code types.

In Part C, novel apparatus and methods are disclosed employing LARcodes (in some cases in combination with other codes, elements, structures or entities) as unique, versatile, and manipulable Responder devices (“LARsponders”).

In Part D, some general examples of LAR-System installations having novel functionality and/or significant utility in commercial venues are described.

In Part E, a more specific discussion is presented regarding novel methods and apparatus for Automated Auctions & other Point-of-Purchase (POP) applications based upon LAR-System technology.

### Part A

### A. Apparatus, Methods, and Systems Including Enabling Single Imager Devices to Perform LARcode “LOCATE”, “READ” and Other Functions

Herein disclosed are novel Apparatus and Methods for adapting various types of single imagers (including but not limited to the general and “conventional” types listed below) thereby enabling them to perform as LARcode-Readers. The resulting LARcode-Readers (also called “LAR-Readers” here-in) are capable of both LARcode LOCATE and LARcode READ functions as well as other tasks (See particularly PARTS C and D) in a variety of unique and commercially useful applications. Novel illumination devices, data-processing system configurations, and software, are also disclosed as are associated systems concepts employing one to many such imagers/Readers of the same or mixed types.

### A.01 Background

Custom production of specialized imaging devices specifically intended for service as LAR-Readers is certainly possible. Such custom devices, along with appropriate proprietary software, represent one way to provide the functionality needed in the applications and teachings taught herein. However, the custom device production approach obviously ignores the huge number of imagers with many useful features and functional flexibility already being mass-produced and already in use world-wide as well as new devices destined to appear in the future.

Without excluding custom devices, important economic and time-to-market advantages are likely if existing (or future) mass-produced still-frame and motion video cameras, cell-phones, smart-phones, machine-vision cameras, PC integrated imagers or other image-capable devices were to be adapted, “enhanced,” and converted into LAR-Readers suited to use in LUXELAR LARcode Systems. Methods and apparatus for such adaptation and/or conversion of most types of imagers-ranging from the economical and basic to the full-featured professional level—are therefore taught herein.

The general approach uses one of several versions of a hardware/software add-on package called a LARCA (LARCode Adapter). The LARCA version depends on which of two broad categories of conventional imagers, designated here as “TYPE 1” or “TYPE 2”, are involved. There are strong recent trends toward some overlap depending upon the details of the systems and applications in which they are used. The art disclosed herein is not fundamentally dependent on this categorization, which is merely for convenience of discussion.

TYPE 1 devices are typical multi-function Smartphones, Feature-phones, Cellphones, PDAs etc. with camera capabilities. TYPE 1 imagers (when serving as LAR-Readers or otherwise) generally move with and are under the control of the mobile user/owner. They feature bi-directional wireless connectivity, integrated displays, and versatile software capabilities. Tablet computers and Laptops with associated Webcams can also share such characteristics.

NOTE concerning Webcam-equipped devices: In addition to Tablet and laptops equipped with Webcams, another sub-category of TYPE 1 can be composed of one or more Webcams hardwired or wirelessly connected to a “desk-top” or other PC configuration intended to be stationary or semi-portable. The PC, in turn, can have a wide variety of hardware, LARcode-based System software and other applications software, as well as communications and/or other capabilities some which are in-built and others which can be provided by coupled custom accessories and/or versions of Power, Light and Control Modules (PLCMs) and Illumination Managers (IMs) as described in following portions of this disclosure. Configurations of this general type can be especially well-suited to creating relatively small systems using a few to a few dozen Webcams. Multiples of such systems can cooperatively cover much larger spaces.

TYPE 2 imaging devices can be owned/controlled by a mobile user, but do not, at the time of this writing, typically feature built-in constant-on, bi-directional, high-speed wireless connectivity via 3G or 4G etc. service providers. This capability can however be added via “plug-in” image storage memory cards/media that include wireless adapters. Type 2 devices usually do not run a wide range of applications that are unrelated to original images captured and/or used by the device. LAR-Readers based upon adaptations of TYPE 2 imagers are more likely to be used within LARcode-based systems installed in venues of various types, or movable by persons or mechanisms associated with the venue rather than used by “free-roaming” individuals unaffiliated with the venue. TYPE 2 imaging devices can include:

Consumer-level cameras such as the Casio Exilim EX-FC100, Sony NEX-5 and NEX-3 etc. and higher-level “prosumer” devices as well as DSLR and “multi-function professional color digital cameras” many of which can offer versatile still-frame capability, rapid capture of still-frame sequences, video image capture, panoramic frame-stitching, anti-shake, ROI selection, wide dynamic range, high sensitivity, a powered “Hot-shoe” and numerous other features which are (or can be) software-defined and exploited for present purposes. Hardware interface ports and compatible accessory devices designed for them can provide wireless connectivity and/or other additional hardware functionality, and can also accommodate new custom software/firmware implementing various methods disclosed herein.

Video Cameras, Camcorders, and advanced types of Imagers such as “Dual” Video and Still-frame cameras (so-called “All-In-One”) as well as video cameras with binocular 3D capabilities.

Machine-vision and special purpose cameras, color, IR, and monochrome, offering a wide-range of useful and special purpose capabilities such as very high frame speed, very high resolution, image intensification and multiple simultaneous ROI capabilities. Such cameras can also offer software-based on-board image analysis capabilities notably for surveillance, inspection, QC, and/or robotic guidance etc. Output is typically hardwire via Ethernet, Camera-link, GigE, various wireless adapters etc.

### A.02 About IR Sensitivity of Imagers:

Certain types of the above-listed devices are purposely designed to have low IR sensitivity so as to improve visible image contrast and lens performance. This is usually achieved by including a built-in IR Blocking filter in the optical path. The filter can or cannot be removable. If IR (or Deep Red light) is to be used to capture LOCATE data from RRs associated with a LARcode, this presents several strategic and technology options for using devices with suppressed IR sensitivity as LAR-Readers:

1. Use existing commercial visible light imaging devices that do not completely Block IR at wavelengths available from practical IR Illuminators of sufficiently high brightness.
2. Use commercial imaging devices from which the IR Blocking filter can be removed, allowing IR to pass and simply tolerating or computationally compensating for any losses in image contrast or color shift that can result. (NOTE: Data from Reference Color Blocks as discussed elsewhere herein can be used for this purpose)
3. If removable, replace the IR filter by a filter having a long low “toe” in its transmission spectrum extending into the Deep Red visible spectrum while otherwise strongly blocking most NIR (Near Infra Red) and longer wavelengths thereby preserving most of the image quality improvement achieved thereby. Deep Red (even quite intense and especially if short-duration) LOCATE flashes tend to be relatively non-disturbing to humans.

Any or all of these three options can be appropriately exploited as further detailed herein. Options (1) and (2) retain covert capability. Option (3) is not covert, but can offer relatively low informal detection probability depending upon the other lighting in the environment. Methods using these three Options are specifically described in Section A.10. A fourth Option, namely using primarily visible wavelengths for both LOCATE and READ functions can be exploited in a variety of novel and useful ways which are presented later in PART A as well as elsewhere in this disclosure.

A.03 Conversion of Type 1 Imagers (e.g. Smartphone) to LAR-Readers

FIGS. 2 and 3 schematically show features of an adapter and accessories for use with Type 1 devices, such as hand-held cellphones, PDAs, Smartphones, or similar mobile device functioning as a LARcod reader. In one form, mobile device 21 includes lens 22 and can be coupled to LARcode adapter (LARCA) 23 having an integrated power/light control module (PLCM). LARCA 23 can include a number of lamps 24 and a color filter set 25. In one form the number of lamps can be an array of n lamps, where n=3. In one form, an external mount 26 can be used to couple LARCA 23 to mobile device 21. Removable flash attenuator 27 can be coupled to LARCA 21, such as through lamp 24. In one form, a built in flash 28 can be included, such as coupled to mobile device 21. A filter 29 can be provided and associated with built in flash 28 for RR excitation, while an attenuator 30 can be provided and associated with built in flash 28 for RR intensity. An optional optical trigger 31 from flash 28 can be included along with a bi-directional data channel 32 that can couple mobile device 21 to LARCA 23. In one form, mobile device 21 and LARCA 23 can be coupled to other devices, such as LARcode processing systems and databases, 3^{rd} party systems, local venue systems and displays etc. through a communication channel 33, such as wireless networks such as G3, G4, Wi-Fi, Wi-MAX, Eye-Fi links, etc.

NOTE: Different groupings and/or sub-sets of the Apparatus and features shown in FIGS. 2-4 can create tailored systems intended for many different types of venues and novel purposes. The functional rationale for features and capabilities of the components shown in FIGS. 2-4 are presented/explained in subsequent Sections of this document in the context of systems, applications and uses of various types of LARcodes and/or other forms of codes.

A LARCA 23 can have a variety of roles and capabilities including imager control, bi-directional communication through the imager with other elements of a LARcode System, power supply/management and timing/control of Illuminators, processing of system-related or locally-acquired images etc. as needed to perform required or desirable LAR-Readers functions. See the Table below. The LARCA 23 shown In FIGS. 2-3 is (optionally) physically-integrated with an associated on-board Power, Light & Control Module (PLCM).

### Principal Data Processing/Communications/Control Capabilities and Functions

### TYPE 1 LAR-Reader Adapter+Power, Light & Control Module (LARCA+PLCM)

LARCAs for TYPE 1 Imagers can provide Data and Control Links (internally supported or via Smartphone) WI-FI or other wireless which can be employed simultaneously and/or used to provide redundancy) such as:

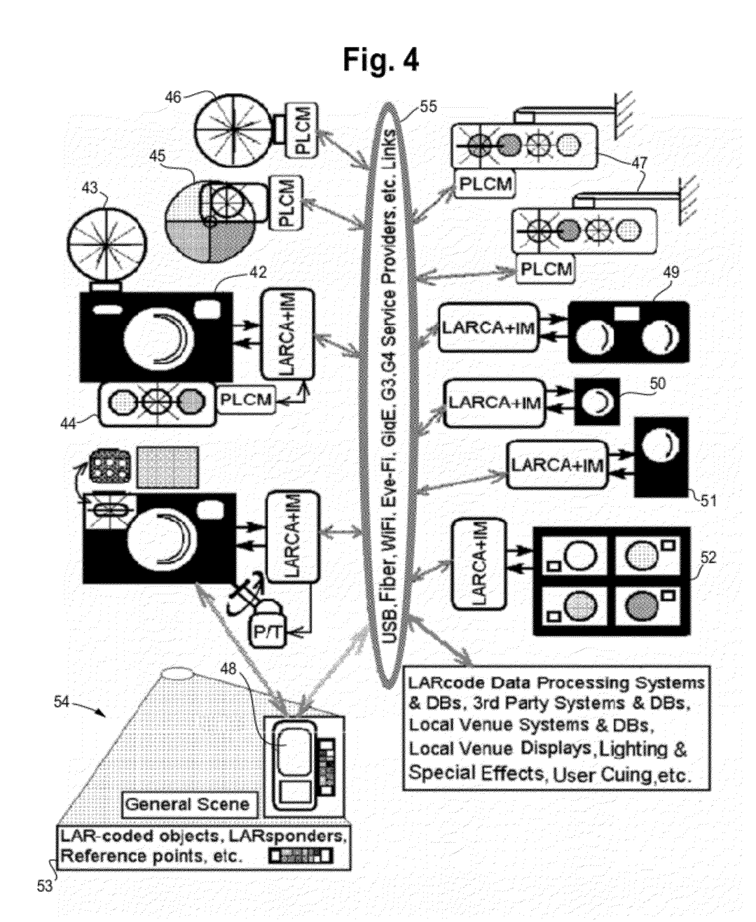

To/from other LARCAs and IMs (Illumination Managers—See FIG. 4)

To/from Local (attached) PLCM

To/from Outboard Scene PLCMs (which can be wired re power, networks etc.)

To/from display devices/other systems in venue, Differential GPS data sources, etc.

To/from Imagers and/or outboard Data processors for decoding, applications, and/or data-base access

To/from cooperating third party systems

LARCAs can support bidirectional data links to other Imagers and software and/or hardware-defined associated “members” of groups and/or networks of Imagers and associated systems, software and/or data files of such members.
LARCAs can access and/or execute local LARCA-Resident Apps, Data Processing and Data-Bases for autonomous performance of LOCATE/READ (decode etc.) and other functions, and can activate and/or cause responses of other associated Systems.
LARCAs can call, cooperate with, access and/or execute local LARCA-Resident Apps, Data Processing and DBs in cooperation with Imager-Resident Apps, Data Processing and Data-Bases) for performance of LOCATE/READ (decode etc.) and other functions, and can activate and/or cause responses of other associated Systems.
PLCMs can provide Accessory Power (batteries, ULTRA-capacitors, solar trickle chargers, etc.), backup & inboard power management for Imager and for LARCA, Local on-board Illumination Lights and Power Control, PLCM Flash charging & readiness reporting to Imager, LARCA and other systems, Maintenance requests, Status & service diagnostics reports re LARCA and Imager systems etc. Outboard PLCMs not mounted on Type 1 Imagers can be hard-wired for power & optionally also for some communication purposes.

Smart phones are multi-purpose and small. Weight and compactness in particular are important. Furthermore, Smartphones and similar mobile image-capture/display devices do not need to be always ready to perform the function of a LAR-Reader for their users. The LARCA+PLCM and other add-ons therefore can be designed to be readily “clip-on” and demountable as shown.

It is emphasized that all of the LARCA and Accessory elements shown in FIGS. 2-3 (and/or in FIG. 4) will not necessarily be needed to convert a particular type of Imager into a LAR-Reader suitable to a given system application. Just as an example, only Attenuator 30 could be required to enable some Smartphones with built-in Flash to capture single frames containing both LOCATE and code READ imagery. With appropriate system Application software, such single-frame data could, e.g., enable automated location & counting of multiple specified items among many others on a shelf and similar uses.

On the other hand, another type of Smartphone etc. may not have built-in Flash capability therefore flash capability is shown as a model-dependent option 28, along with its associated removable Accessories 29 and 30. If a Smartphone has no built-in Flash, an RF signal from the Smartphone can be used to trigger a high-power IR or Deep Red Flash from one of the lamps in the PLCM with an appropriate member of the Filter set 25 flipped into place.

One of the flash sources in a PLCM multiple light array can be equipped with an accessory attenuator 27 and/or a color visible filter (if a colored visible Flash is intended). The utility of a range of flash power levels and sequences of flashes from a PLCM equipped with multiple lamps (optionally with different color filters 25 will be detailed later in this disclosure. PLCM lighting can be triggered by an electrical (or fiber-optical) signal via link 31 from the Smartphone's own built-in flash unit.

If PLCM lights are to be used to illuminate a general scene for Color Block code Reading (as distinct from LARcode LOCATE RRs which can be excited independently, e.g. by the Smartphone's Flash), the LARCA and PLMC, as mounted, can include schematic feature 26 allowing them to be displaced substantially from the line of sight (“LOS”) of the Smartphone Imager. The displacement is shown as horizontal, but can be otherwise, e.g. vertical (up or down) or detached for greater convenience.

### A.04 Conversion of Type 2 Imagers to LAR-Readers

With reference to FIG. 4, there is shown some schematic features of adapters and accessories for type 2 imaging devices functioning as LARcode readers. Any of the Camera/Imager types (such as 3-D camera 49, smart camera 50, video camera 51, or CamCluster 52) on the right hand side of FIG. 4 can be equipped and/or accessorized in the same manner as shown for any Imagers on the left (such as dSLR, point and shoot, and similar cameras 41 and 42), i.e. with PLCMs and light sources 43, 44, that are imager-mounted or associated 45, 46, 47) with out-board lighting etc. For simplicity, some of these features are not shown. PLCM power and/or for lighting can be wired or from on-board batteries depending upon the installation and mission details. The P/L Pan and Tilt mechanism can be fixed, automated and/or adaptively system-controlled using adaptive methods detailed in the next Section. Images or groups of images thus obtained can be processed by known stitching software techniques. This processing capability can be enhanced/facilitated by using LAR-coded venue reference points.

Mobile device 48 can be a Type 1 imager OR a Cell-phone or other wireless networked device which can or cannot have any on-board imaging capability. It can have a LARcode physically associated with it which is readable by other LAR-Readers. Mobile device 48 can be within a general scene within a field of view of imagers 41 and 42 that can include LAR-coded objects, LARsponders, Reference points, etc. 53.

NOTE: Please see the introduction to PART C regarding LARsponders and in particular subsection 13 in the listing of Response Methods and Apparatus in part C.03 for an example and the general rationale for placing or otherwise associating a LARcode on the Smartphone 48 (or on other types of MID devices) as shown in FIG. 4.

The “CamCluster” imager 52 is a schematic representation of a LAR-Reader using multiple cameras of one or mixed types of imagers which are mounted together. Their field of views (“FOVs”) 54 can cover contiguous areas of a scene, particular areas, and/or can cover areas of a scene with different focal length lenses. CamCluster image capture by members of a cluster 52 can be simultaneous, interleaved, sequenced or otherwise varied within the cluster 52. Some or all members of a CamCluster 52 can be equipped with filters for reasons to be discussed subsequently. Versions of CamClusters 52 need not be arranged as shown. Their LOSs and/or FOVs can be oriented along arcs, cylinders, portions of spheres etc. CamClusters 52 can be associated with complementary arrays of PLCMs and light sources implementing the Locate and READ etc methods and other system functions described herein.

### Principal Data Processing/Communications/Control Capabilities and Functions TYPE 2 LAR-Reader Adapter+Illumination Manager and Power, Light, & Control Module (LARCA+IM and PLCMs)

LARCAs for TYPE 2 Imagers can provide Data and Control Links via any or all wireless and physical connections displayed in FIG. 4. Links can be employed individually, sequentially and/or simultaneously/redundantly to any/or all elements inclusive of those listed above as TYPE 1 Features, Capabilities and Functions and others in addition:

To/from other LARCAs and IMs (Illumination Managers (“IM”)—See FIG. 4)

To/from Local (attached) PLCM

To/from Outboard Scene PLCMs (which can be wired re power, networks etc.)

To/from display devices/other systems in venue, Differential GPS data sources, etc.

To/from Imagers and/or outboard Data processors/applications/decoding and DBs

To/from cooperating third party systems

To/from other Imagers and software and/or hardware-defined associated “members” which can include persons, groups, Imagers and/or networks of Imagers etc. and thence to Systems, software and/or data files of such members.

To/from LARcode Data Processing Systems and databases, third party systems and databases, local venue displays, lighting and special effects, user cuing, etc.

### Principal Data Processing/Communications/Control Capabilities and Functions TYPE 2 LAR-Reader Adapter+Illumination Manager and Power, Light, & Control Module (LARCA+IM and PLCMs) Continued

LARCAs can access and/or execute local LARCA-Resident Apps, Data Processing and Data-Bases for autonomous performance of LOCATE/READ (decode etc.) and other functions and can activate and/or cause responses of other associated Systems.
LARCAs can call, cooperate with, access and/or execute local LARCA-Resident Apps, Data Processing and Data-Bases in cooperation with Imager-Resident Apps, Data Processing and DBs) for performance of LOCATE/READ (decode etc.) and other functions and can activate and/or cause responses of other associated Systems.
IM (Illumination Managers) associated with LARCAs can be hard-wired or wirelessly connected to one or multiple PLCMs and can control multiple PLCMs and Illumination/lighting assemblies.
PLCMs can provide Accessory Power (batteries, solar, etc.), backup & inboard power management for Imagers and for LARCAs, Local Lights and Power Control thereof, PLCM Flash status charging & readiness-reporting to Imager, LARCA and other systems, Maintenance requests, Status & service diagnostics reports re LARCA and Imager systems etc. Outboard PLCMs (if not attached to movable Imagers—e.g. controlling venue-mounted lights) can be hard-wired for power and communication etc.
Light sources controlled by or associated with PLCMs can deliver different types of illumination to serve different purposes, For example, they can control multiple lamps 44 and 47, some or all of which are filtered and which can be energized singly or in various combinations to deliver lighting with different spectral characteristics. When excited by incoming sources at somewhat different locations, such as using multiple lamps 47 which can be e.g. alternated with sources closer to an imager LOS, RR returns from LARcodes can be distinguished from other lights or bright spots in the sensor FOV, e.g. specular reflections from highly polished surfaces etc. because of their deeper modulation depth. PLCMs can control high-brightness and/or fast-cycling flash units 43, 46. They can control optical and/or mechanical/optical devices associated with particular lamps which can alter spectral, polarization or other properties of the light 46. PLCMs and/or LARCAs can control (P/T) Pan & Tilt or other mounts for LAR-Readers including motor-driven positioning or robotic mounts.

### A.05 Certain Methods & General Capabilities of LAR-Readers

LARCA-equipped TYPE 1 or TYPE 2 Imaging devices can have novel and substantial image acquisition & image-processing & other data processing capabilities/methods available within the LARCA itself, in its associated imager devices, PLCMs, and/or via links to other data processors and data-bases.

LARCA equipped imagers and their associated systems/apparatus, software and data-bases can perform generic LOCATE and READ functions plus tracking of LARcodes within a scene using a variety of methods.

For example, they can detect and register (or reject as spurious) bright regions by, among others, one or more of the following: (a) using shape discrimination of reflections off artifact sources as compared to RRs that have correctly scaled size/shapes/spacing/neighboring color(s) in the same FOV, (b) by detecting changes in apparent reflection location, intensity, and/or reflected color with respect to other RRs when differently positioned or differently colored Illuminators are used, (c) by failure to detect and READ color-code blocks of sizes and within distances to be expected from the apparent size of the bright region (d) by systematically moving a threshold (OR a bracketed range of brightness levels) downward from a maximum found in the brightest contiguous (i.e. not isolated small-scale groups of noisy pixels) present in an image, noting the region's or regions' shapes and positions, determining if the shapes are geometrically indicative of an RR including having comparatively sharp boundaries compared to the size of the region, registering adjacent code areas if any, etc. for subsequent analysis, blocking said bright contiguous region plus an optional adaptively-sized fringe margin to black (or an equivalent operation), iteratively reducing the threshold or bracketed brightness range further to detect the second brightest areas [now the brightest] in the scene and iterating the process until multiple sharply bounded and acceptably configured regions are not detected, (e) by noting and rejecting bright regions present with PLCM lights switched off, (f) by detecting a lack of “correct” movement during cued activities involving asking “players” to do a specific maneuver or maneuvers “3 . . . 2 . . . 1 . . . now” that move true RRs, which spurious sources do not duplicate and hence are revealed/isolated, (g) by having users momentarily shield their LARsponders before “registration” or “re-registration”

They can manage data traffic delays/errors by invoking intra-venue and/or extra-venue alternative channels (wired or wireless or both). They can also execute ADAPTIVE system responses based upon a given LARcode's specific code content, spatial and or time-dependent behavior, visual environment, and/or the LARcode's spatial associations with other LARcodes.

### A.06 Methods and Techniques for Adaptive Exposure, Lighting Adjustment, and Noise Reduction

LOCATE flash intensities can be under PLCM or LARCA/IM system software control. Intensities from RRs can be intermittently and/or systematically attenuated or varied (e.g. ramped up from low levels) in a series of Imager frame exposures. The results so obtained can be analyzed with appropriate image-processing software to detect “bloom” and/or loss of details, sharp edges etc. caused by excessively high brightness LOCATE flashes or conversely by excessively low brightness of the LOCATE test flashes returned from specific LARcode RRs. Such test series can be inserted from time-to-time in the data stream at frequencies based upon history, code locations in a venue or other criteria.

Illumination used for LARcode READ functions (as in a Fill-Flash mode etc.) can be similarly adjusted. PLCMs can adaptively set intensities to optimum levels as a function of particular LARcode locations where particular RRs or Color Blocks etc. have shown marginally reliable readability. This condition can be identified, for example, by the presence of pixels with signal amplitudes marginally close to a defined minimum threshold. Excessive brightness can be determined, for example, by the presence of a group or groups of saturated pixels that are larger than a pre-determined minimum size relative to the overall code image. These capabilities can be especially effective for quasi-stationary or relatively slow-moving codes.

For fast, slow-moving or stationary LARcodes, software can also be adapted to dealing with/accounting-for changes in localized predicable or otherwise changing overall light levels caused by slowly moving shadows of structural features etc. Local time of day data can be an input to the system. Data from dedicated accessory sensors monitoring changes in ambient light due to cloud cover, sunlight through windows etc. can be exploited as well. For example, if bright sunlight is present, PLCMs can use powerful general scene multi-spectral color Illuminators in burst sequences. These can help facilitate accurate color READs of several types of LARcodes disclosed herein such as mosaic types or those using subtly different colors to accommodate large amounts of information.

More generally, image SNR (signal to noise ratio) levels in what a-priori should be uniform LOCATE or color regions of LARcode images (or uniform shapes or regions in any other type of code format) can be sub-sampled and used to adaptively adjust illumination levels and/or to adaptively control exposure parameters.

Code interpretation accuracy ratios can also be improved by real-time and/or post-processing stacking and averaging of data from multiple images of corresponding regions of a given code. An adaptable number of such multiple images (size-adjusted, warped etc. as necessary) overlaid or “summed” sub-sample by sub-sample or pixel by pixel can be used. The number of such averaged images can be software-controlled to meet defined minimal S/N acceptance thresholds or other criteria. Multi-frame sequences similar to those described above for adjusting illumination to get best RR images and code-areas data for color ID can be complemented or used independently to optimize imager focus, FOV size etc. with priorities assigned by data contained in the code itself or, e.g. apparent image size etc.

Adaptive selection of LARcode RR LOCATE regions in accordance with apparent relative sizes within a scene can be used & can define ROI regions for zoom, decode READs, and/or track priorities etc.

Spurious RR or specular reflection sources can be surveyed during times when no responses are being requested by LAR-Data Servers which can log their behavior, shapes, etc. and eliminate them if they do not move unpredictably (e.g. they move due to the sun's movement) over some defined time interval or using some other criterion etc.

In scenes in which LARcode RRs and/or code regions images appear, and dependent or independent of their relative sizes if so specified, the nature and information conveyed by such images can be used by LARCA/IM/PLCM and associated systems to execute other actions such as adjusting the LAR-Reader focal length for optimum reading, or designating a LARcode as an ROI of “special interest” and applying image stabilization, altered or particular illumination parameter sequences or other special treatments and/or priorities.

Specific adaptive capabilities can be conferred by system software based upon recognizing the content particular LARcode or by cues from previously captured data on LARcode LOCATE RR size, shape, etc. For example, it can be conferred via a previous valid code-READ of the LARcode obtained earlier when the LARcode was closer and/or was being tracked as moving faster or slower than defined relative or absolute velocity thresholds.

A LARcode can also carry situation-dependent and/or application-dependent priority instructions allowing it, but not other LARcodes in the same scene, to be conferred over-riding “special” treatment of it. Similarly, LARcodes with particular pre-defined code features can be granted preferential frequency or relative priority of attention (but not exclusivity) as compared to others in a scene.

LARCAs can initiate transferring commands to other devices and/or a LARCA's own associated PLCM to, for example, interleave specific sequences of Flash spectra during multi-frame image acquisition by particular Imagers when certain defined types of codes appear in the scene. They can alter frame capture rates and/or Illumination schemes via IM or PLCM commands depending upon criteria such as that LARcode's movement velocities, frequency of partial READ failures of certain code types, etc.

### A.07 Certain Capabilities of Light Sources, Associated PLCMs and Use of Scene Color Standards

Basic Lighting Capabilities

PLCMS and their associated light sources can deliver individual flashes, flash sequences for multiple image capture exposures, or can be “ON” for extended intervals of any duration if continuous or near-continuous reading and/or tracking of RR LARcodes is necessary and adequate power is supplied. They can emit visible white light or otherwise, including IR &/or UV. They can use colored (and/or polarizing) filters on lights to aid in RR identification via the distinguishing color or polarization of the retro-reflected light there-from as contrasted to environmentally-caused specular reflections or other light sources.

Additional light sources close to a LAR-Reader but in somewhat off-set locations with respect to the LAR-Reader's LOS can be turned “on” or “off” alternately, or in some other sequence including on-off periods of Illuminator sources whose purpose is to produce RR returns from LARcodes. per se. Regions that are bright with the latter sources off can be used to identify and ignore or mask unwanted other lights or bright spots in the LAR-Reader's FOV.

Multi-spectral Lighting Capabilities

As noted above, PLCMs can deliver white, colored, and/or multi-color sequences of light. Among others, a multi-color sequence capability opens novel ways of using visible spectrum color light sources. LAR-Readers based upon monochrome or color Cameras/Imagers (and with or without image intensifiers) can achieve enhanced capabilities for color determination, identification, and robustness in any type of color-code image via differential spectrally-dependent lighting and/or temporal modulation patterns in images of such codes.

The method can also be used with non-visible imagers/sensors (e.g. Night Vision Intensifiers-NVIs) together with non-visible illumination sources and coding materials whose reflectivity, luminescence, or phosphorescence is wavelength dependent in the IR or UV. LARcodes can use coding methods employing pigments or other substances having different IR brightness levels under IR illumination from sources which can have various spectral profiles. It is noteworthy that NVIs are also now available which create detailed false-color visible output imagery based upon IR scene details including LARcodes designed to be read under IR illumination. Outputs from these NVIs can be directly optically coupled to the various types of visible imagers employed in LAR-Readers discussed herein.

Regardless of the wavelengths involved, the method exploits the time-dependence of pixel-by-pixel flicker and relative amplitude modulation (color brightness OR gray-scale levels) to acutely distinguish different “color” entities used for coding within a series of image captures during multi-color color excitation driven by the appropriately filtered PLCM lighting sequences. Such collective data series enable use of a large color universe by being capable of detecting subtle color differences especially when there are steep changes in transmission at different wavelengths of the illumination light filters used.

The above methods and concepts offer significant advantages over determining the color of a Block, sub-Block, or mosaic using only the data in a traditionally-captured color image using a single unvarying illumination spectrum. Methods & LARcode apparatus exploiting these concepts is discussed in PART B.

Noise Reduction

Multiple data sets of the sort obtained by the methods disclosed herein also allow noise-reduction techniques to be applied by “stacking” (summing) corresponding pixel-by pixel signal levels as seen in images of a given LARcode. Different weights can be given to data from a given pixel in an image under different illumination spectra. Those pixels with the best S/N ratios (brightest) can be given some prescribed preference.

Scene Color Standards

Multiple color standards positioned in known locations within a scene, or within a LARcode itself, can be employed for matching and color ID if necessary and can be desirable especially in venues where the PLCM lighting must compete with bright ambient levels. They can have a capability to command dimming or ON-OFF control of sources of ambient light within their environment.

NOTE: It is not to be inferred that the general types of multi-spectral Apparatus and Methods briefly introduced above and further disclosed in various portions of this document are limited solely to the purposes discussed. They can be used more broadly for any situation, coding method, circumstance, purpose or system in which robust discrimination between subtly differing colors in any imaged scene is required and spectrally-filtered illumination sequences can be employed.

Note further that LARcodes will be described in later sections of this document in which color-CODE regions as well as LOCATE regions can also be retro-reflective.

### A.08 Use of Dual Imaging Devices as LAR-Readers

The emphasis in this document is on methods using single devices functioning as LAR-Readers. However, it is to be understood that any of the Illuminators, color identification techniques and novel types of LARcodes and LAR-System features etc. taught herein in the context of LAR-Reader concepts and methods employing a single device for both LOCATE and READ functions can also be advantageously applied to LAR-Readers using two cooperating but separate sensors. For example, one imager can be an IR sensitive camera or imaging array for the LOCATE function collaborating with a physically separate visible-light sensitive camera or imaging array. One can be a filtered or intensified device, the other a high frame rate imager or one capable of executing ROI options. These devices can share a single lens LOS &/or FOV via beam splitter optics or other functionally equivalent arrangements.

Alternatively, using data such as RR size, shape, color transitions or other identified features in images obtained by two approximately co-sighted but physically separate devices, LOCATE and color Block data can be brought into sufficiently precise correspondence pixel-by-pixel for LOCATE, COLOR decode, LAR-code tracking for uses described in this document. Image processing software known in the art for shape recognition, shape-warping, color boundary recognition etc can assist in this task. This task can also be facilitated by using images containing BOTH fixed Reference Markers in pre-determined locations in a venue combined with a LARcode's apparent size in an image to determine a relatively precise off-set correction for combining and aligning corresponding pixels in the IR and visible sensor images.

Similar and related approaches to the above can take advantages of the recent commercial availability of devices featuring two complete cameras, each with its own lens, contained in a single camera body. The FujiFilm FinePix Real 3D W1, a TYPE 2 Imager, is one example of such a device. Each 3× zoom lens is equivalent to a 35-105 mm lens on a 35 mm camera, and has its own 10 MP CCD sensor. These are coupled together with a new built-in image processor that Fujifilm calls the “RP” (for “Real Photo”). The FinePix Real 3D W1 can take 3D as well as traditional 2D images. In addition to the usual scene modes and exposure controls, Fujifilm has added specific features to take advantage of the two complete lens/sensor arrays in the camera. An available Dual Capture Shooting Mode allows simultaneous capture of two frames at different settings, one through each lens. Separate focal length, exposure, and color settings can be used for each. Hence, for example, under LAR-System control as a LAR-Reader, using such a 3D dual camera pair, different exposure modes can be used for the two photos—one for RR LOCATE data the other for Code READ data. The device could then switch to devote one camera to shooting a wide-angle image while, at the same time, the other might be zoomed-in to capture an ROI portion of the image.

A.09 LAR-Reader Using Color Camera and Attenuated and/or Filtered Flash

Methods and apparatus here disclosed enable a single as-built camera or other imager to function as a versatile LAR-Reader. The method uses either the built-in flash (as supplied with the imager and assumed mounted near the LOS of the camera lens) or another light source such as shown in FIGS. 2-6.

For reasons already explained, a built-in flash source's normal brightness, if not programmable by the device, can be attenuated (and optionally spectrally-filtered) by movable/removable elements, e.g. attenuator 30 and filter 29 respectively. These can be manually “press-on” mounted over the camera's built-in flash window. The purpose of the attenuation of the visible flash from the built-in Flash unit is to insure that returns from RR images in the scene are at non-blooming brightness levels. The unique spectrum of the flash-driven RR reflections (if a color filter is used) can be used to distinguish LARcode RR LOCATE signals from other (environmental) specular reflections and lighting. Not every captured frame must include RR LOCATE data, especially if LARcodes are quasi-stationary or moving slowly.

The low-brightness flash levels (which, in some embodiments can be made Adaptive via software or firmware as has been discussed above) make LARcode LOCATE RRs in any given frame easy to distinguish while avoiding blooming. With adequate general scene lighting or Flash fill-lighting from sources off-set from the imager LOS, the required LOCATE flash levels need not interfere with reliable reading of non-retro-reflecting LARcode color regions which are captured simultaneously. Software used for color-Reading can readily take full account of any slight shift in the overall ambient lighting incident on the LARcode due to effects of the RR LOCATE flash or scene fill light flashes. This is especially true when color reference standards are included on the LARcodes.

A camera's “exposure control” can typically be set for deliberate over-exposure of the general scene to compensate for the lower than “expected” scene brightness which would ordinarily have been delivered by an un-attenuated flash. This depends upon the circumstances and the other capabilities of the system that the Imager can be using such as outboard “slave” Flash sources.

Other options for acquiring both LARcode RR LOCATE (and tracking) as well as COLOR CODE READ data using built-in Flash-equipped Type 1 (or certain Type 2) Imagers include “Flip-In” Attenuators and/or filters that can be quickly manually positioned in or out of the flash illumination when desired. Stepping motors/actuators can also be used to perform these manipulations in some cases, allowing both LOCATE and COLOR READ data to be obtained at high acquisition rates.

These approaches have minimal impact on user-owned Type 1 Imagers and their convenience of use for general purposes.

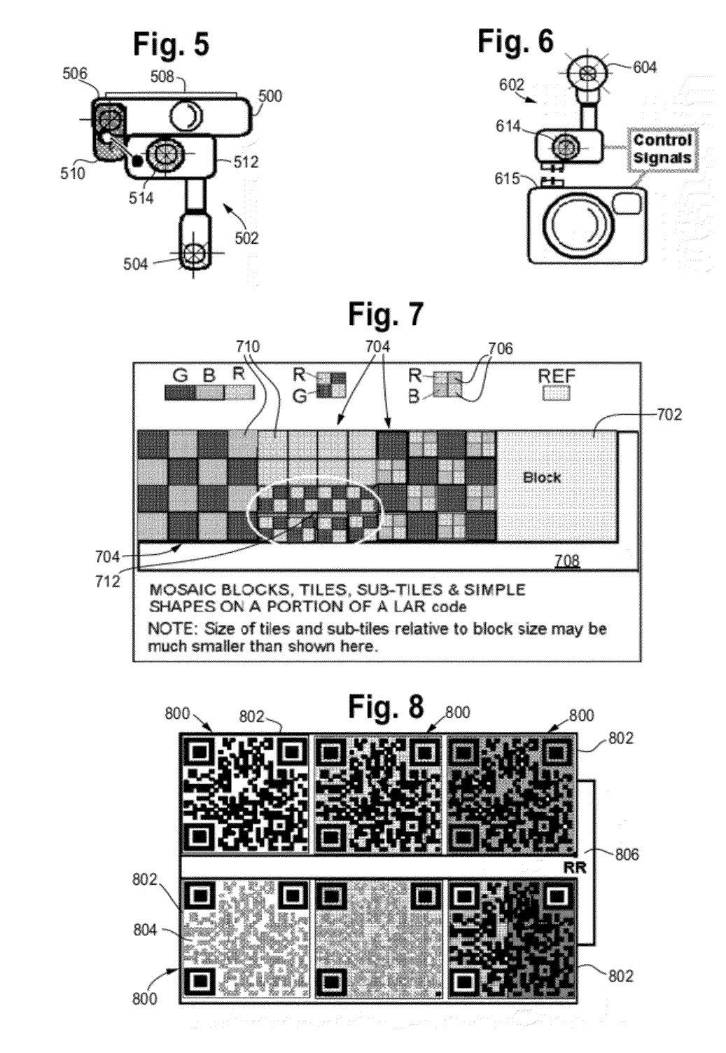

If an Imager has a “hot shoe” (typically a Type 2 as in FIGS. 4, 43, shifting the Flash origin away from the Imager LOS can be conveniently accomplished by a plug-in extender accessory plugged into the hot shoe and carrying the Flash (e.g. Xenon) unit. See, for instance, the example and further details shown in FIGS. 5-6.

If a camera or other imaging device (such as a cell-phone, smart-phone, machine vision camera, video camera etc.) does not have a built-in flash capability, a PLCM including a Flash unit, power-supply etc. can be removably attached to provide primary scene Illuminators and/or supplemental Flash source(s). Mounting features can allow one or more of its lights to be sufficiently laterally displaced and/or rotated away from the Imager's LOS to avoid significant retro-reflected returns from the RRs in the scene while other lights in the PLCM produce optimal and non-blooming RR data. See, for example, feature 26 in FIG. 3. For simplicity, various options such as an in-plane 90 degree clock-wise rotation around lamp 24 are not shown. The imager-mounted PLCM and/or other PLCMs in the venue can then supplement ambient scene lighting (e.g., in the manner of a “Fill-flash”) as necessary for LARcode READ functions without over-exposing RR regions.

Among other methods, direct signal access to the Imager's control software or via an “Application” which enables wireless (or even audio) timing signals from the imaging device to be conveyed to the PLCM can be used to time-synch and otherwise control PLCM flash operations and sequences. The PLCM can also be controlled and triggered manually, electrically, wirelessly, or by means of an optical sensor in the PLCM whereby it detects low brightness or heavily attenuated flashes and/or flash sequences from a camera's unmodified built-in flash source if one exists. The trigger light can be conveyed via an optical fiber or can activate a photo diode or similar sensor coupled to the PLCM.

Many uses of LAR-Readers do NOT require that they have the full panoply of capabilities being disclosed in this document. For example, FIG. 5 schematically illustrates a typical mobile camera phone 500 and FIG. 6 schematically illustrates a generic TYPE 2 camera 600. (The latter is equipped for some form of communications capability such as WI-FI etc. if low system latency is required).

Installing a simple, demountable, & potentially economical Accessory product 502, 602 (essentially a limited-function PLCM), as shown in FIGS. 5-6, converts the associated devices 500, 600 into effective LAR-Readers well-suited to acquiring basic LARcode images. The image data so acquired can then be passed upstream to where extraction of LOCATE, TRACK, READ and other information contained in the images takes place and where it can be used along with other data for executing system operational tasks.

The accessorized imagers shown in FIGS. 5-6 can be employed in applications where visible flash illumination can be used and where fully-covert or minimally-alerting image acquisition is NOT required. In certain applications, general scene lighting can also include purposefully distracting visible light flashes or other dynamic lighting effects/changes which can disguise image acquisition flashes by LAR-Readers thereby effectively making them “semi-covert”. If covert (or minimally detectable) operation is required, other methods such as described in the following Section A.10 can be enlisted.

Note that where appropriate to the application, frame acquisition sequences using attenuated visible flashes from a camera's built-in Flash source, such as blocked built-in flash 506, for LOCATE RR Excitation can be interspersed (e.g. once every 5+ frames etc. to allow for Flash re-charge time) within sequences of ambient illuminated general scene READ frames. The predictable time of appearance of bright (optionally color-filtered) RR regions in certain frames and not in others can aid in efficient image processing procedures for LARcode LOCATE purposes.

LARcode READ frames can be captured using any kind of illumination sources provided that such sources are off-set from the imager LOS. Such off-set sources can be pulsed or otherwise and depending on available ambient/environmental/effects lighting, can or cannot require activation of the “Scene Light” sources 504, 604 shown in FIGS. 5-6. This can be determined by the exposure control software in the camera itself which may, in turn, instruct out-board “Scene Light” power supplies.

While the simple accessory shown in FIGS. 5-6 has substantial utility, if a Type 1 device is outfitted with a detachable PLCM having “n” light sources (see 23 in FIGS. 2-3), various attenuation and multi-spectral illumination features become conveniently available (see 25, 26, 27 in FIGS. 2-3) which enable a wider range of useful capabilities as discussed elsewhere herein. This also applies to systems using one or more Webcams as described in Introductory Section A.01.

The type 1 imager of FIG. 5 can be a phone having a display 508 that can have a blocked built-in flash 506 and a flash sensor 510. Accessory product 502 can be coupled to the phone and can include a power and control unit 512, RR light 514 and scene light 504. Somewhat similarly, the type 1 imager of FIG. 6 can be a somewhat standard camera having a hot shoe 616. Accessory product 602 can be coupled to the camera using hot shoe 616. Accessory product 602 can include a scene light 604 and RR light 614. In one form, the camera and accessory product 602 are communicably coupled to each other to allow control signals to pass from one to the other.

A.10 Readers Using “IR Blocked” Color Imagers with “Covert” High Intensity NIR or Deep Red Illumination

In this method, frames intended to serve as LOCATE frames are illuminated using one or more of the types of light sources shown in FIGS. 2-6 which are positioned near the Imager's LOS. These sources are equipped with NIR or Deep-Red Pass Filters (see 25 in FIGS. 2-3) and capable of producing relatively high levels of IR or Deep Red output. This causes images of RRs associated with LARcodes to have significantly higher luminance levels than the other portions of such frames. The method can be used with cameras with or without built-in IR Blocking filters.

During exposure of an RR LOCATE frame, the camera can (if necessary) be pre-set to deliberately/automatically under-expose the rest of the visibly lighted scene making the NIR (or Deep Red) RR regions in the captured imagery more easily extractable. The NIR or Deep-Red excitation, at a pre-determined and sufficiently high power level (but not high enough to create excessive “blooming of RRs), can be synced with the color camera's shutter. It can be triggered on almost every frame in certain applications, alternately, periodically or only on-cue in others. Deep Red short duration flashes, even if intense, tend to non-disturbing to the non-dark-adapted human eye, nevertheless, they can brightly reveal any RRs in an otherwise under-exposed image. Whenever an NIR or Deep-Red LOCATE Flash is NOT triggered, visible spectrum color READ frames can be captured with normal exposure settings (no Flash) using ambient light or other available non-alerting lighting. This can be controlled manually or by using Imager software/firmware features or custom software Apps.

While the details (such as obscuring but not deactivating the built-in flash) can vary, Type 1 Imagers equipped with a PLCM 23 also can provide NIR or Deep Red functionality using one light source 24 or several with appropriate filters.

Video sequences and/or single or multiple frame interleaved sets of both types of frames (LOCATE and READ) can be acquired using Imagers featuring suitable capabilities.

NIR or Deep Red flashes energized by an auxiliary power supply in a PLCM can offer additional LOCATE capture options. For example, the PLCM can deliver sufficient energy to capture a rapid series of NIR or Deep Red flash exposures at rates faster than a usually slower rate limited by a camera's internal power supply's re-charge time. Fast sequences of scene-frames using ambient lighting (with the camera set for No Flash) can be acquired together with a series of synchronous inter-leaved high intensity NIR or Deep Red LOCATE flashes. Here again, visible LOCATE flashes can also be used in non-covert or purposely disguised implementations. NIR/Deep Red frames and “normal exposure” frames can be buffered to be available sequentially or simultaneously during down-stream image processing. Single pairs or other combinations of such images can be used for implementing several other concepts and systems some of which are set forth later in this document. Applications include but are not limited to LARcode-implemented activities in semi-darkened theaters, bars, restaurants etc. or in outdoor evening entertainment events as well as novel methods of security monitoring,

About NIR or Deep Red Readable and/or Covert Codes:

Deep Red or NIR Illumination can also be used for LARcode READ as well as LOCATE functions, and also with codes other than LARcodes provided the codes are comprised of patterns and/or shapes discernible under IR or Deep Red illumination.

Substantially covert codes which have low probability of being detected, even with flashlight inspection of a venue, can be composed of visually black patterns, regions, shapes or strips, etc. which are opaque to NIR and which overlie a Retro-Reflective backing in combination with other regions that are visually black but which transmit NIR. The combined areas therefore appear black under normal visible lighting.

If a code is designed for Deep Red Reading, its presence can be slightly compromised in richly reddish ambient. On the other hand, subtle INDIRECT red illumination (e.g. low level light scattered off a venue ceiling) can limit dark-adaptation of occupants and actually reduce detection probability. To further cloak the existence of such codes, the entire combined “black” code area can screened with Deep Red or IR transparent colored inks and/or pigments to create overlying or partial coverage made up of visibly colored dots, patterns, texts etc. which serve as camouflage or distracting forms. Codes of this type can be used, for example, as targets which are unknowingly occulted by intruders traversing sensitive areas thus causing some type of system response.

Rather than Deep Red or NIR, somewhat longer wavelength (SWIR) illumination, working with fully-covert “black” LARcodes (optionally including over-lying visible camouflage) can used along with, for example, InGaAS sensor-based imagers carrying out operationally-sensitive LOCATE, READ and TRACK functions.

A.11 Monochrome Camera with Multi-Spectrum Illuminators

Monochrome cameras (optionally including high-sensitivity and/or very high resolution types, optically-coupled Imager Intensifiers, ICCD and EMCCD sensor arrays or similar or equivalent features) here are used with PLCMs with one or preferably several light sources. Each Scene/READ Illuminator lamp can be equipped with a different Gel filter or equivalent and each can emit light with a distinctive spectral distribution. See 23, 25, 44, 47 and 45 in FIGS. 2-4, the last listed being representative of a single lamp Illuminator using filters that are changed by mechanical means such as rotary steppers.

With the recent availability of Red, Green, & Blue LEDs, a triplet group of these can be configured as one Illuminator & various combinations of ON timing & drive currents of the different LEDs can be used.

Illuminators for LARcode READ and general scene illumination can be substantially offset from the camera LOS to avoid excitation of LARcode LOCATE RR's and also to avoid alerting to the camera's location. (Others can be closely mounted to the camera's LOS as discussed below.) Members of the group of Scene/READ Illuminators can deliver “Off-On-Off” time-dependent lighting sequences of different spectra to the color-printed code regions of a LARcode and/or can produce spectrally varied returns from RRs if present

The different Gel transmission spectra produce distinctive gray-scale levels in the monochrome imager's output depending upon the combined effect of the spectral characteristics of each filtered Illuminator light when “ON”, the colors on the LARcode and the wavelength dependent response of the Monochrome imager (and Intensifier, if used). This provides multiple sets of luminance (gray-scale level) intensity patterns from a given LARcode which are time-dependent and in sync with the different scene Illuminator On-Off sequences. As a result, multiple image data sets can be acquired which are uniquely dependent on the colors present in the LARcode and also in any sub-patterns if present. Subtle color differences in LARcode code regions can thereby be detected and quantified. The availability of such multiple data sets also allows data noise to be reduced using known signal-processing techniques.

In the present case, and in the other methods described herein, separate LOCATE RR Illuminators emitting IR or visible light can be positioned adjacent to the Camera LOS. These LOCATE Illuminators can be “constant-on” or distinctively time-modulated in various interleaved fashions (Frame to Frame) with respect to the Scene/READ Illuminator sequences. LOCATE images so obtained can be shape-analyzed etc. to distinguish LARcode RR's from specular reflections or other environmental light sources.

In venues with bright ambient lighting, high intensity flash lamp sources can be used to drive color-filtered Scene/READ Illuminators. In some instances, the source of ambient light can be fitted with a polarizer to reduce its effective intensity as seen by an imager equipped for the opposite polarization. Alternatively, in many applications, the ambient lighting can be temporarily or momentarily dimmed while the system gathers LARcode data and/or LARsponder data. See PART 3 re LARsponders.

In some applications and venues, Scene/READ light sources can include one or more polarized pairs (used alternately or in some other sequence). Both members of a light source pair use the same type of color filter while the Imager is equipped to pass one OR the other type of polarization, but not both. Ratios of brightness levels and/or using normalized differences and other analytical procedures with pairs of images as reported from each Camera pixel for each the two polarizations can enable discrimination against the masking influence of bright un-polarized ambient light sources.

Polarized areas of codes, whether on LARcode LOCATE RRs or READ areas (or many other types of codes) can be caused to “flicker” under illumination by sequences of polarized light sources for tracking, ROI isolation and other processes. This technique can be useful in venues where potentially competing illumination levels from ambient (un-polarized) light sources can be controlled.

A.12 Filtered Monochrome Camera with Multi-Spectrum Illuminators

As in section A.1.11 above using multi-spectral illumination sequences, but wherein an added Color Filter (or sequence of filters with different transmission spectra) on the Monochrome Camera Lens (or on an image Intensifier coupled to it) is used to acquire additional distinguishing sequences of frames showing gray-scale variations in monochrome images of multi-color LARcodes.

A.13 Filter-Equipped Monochrome Camera with Visible Light Spectrum Illuminators

As in section A.1.12, but wherein broad visible (so-called “white light”) spectrum illumination is used.

A.14 Color Camera with Multi-Spectrum Illuminators

As in section A.1.11, but where-in a Color Camera together with MULTI-COLOR illumination sequences is used to READ color LARcodes. Some of the light sources can be displaced from the camera's LOS while others can be close to it and thus can excite RRs which can themselves optionally be colored or partially colored as discussed further in PART B. The color camera's wavelength-dependent output response is the result of a combination of the color of a given LARcode Block (or RR) and the incident filter-modified transmission Illuminator spectrum weighted by the sensor's color response versus wavelength profiles (typically 3 RGB channels) rather than by a monochrome camera's single spectral sensitivity profile.

A.15 RRLARcodes Used with Monochrome Camera

This method is similar to that described in sections A.11, A.12, and A.13, except that visible white light OR multi-color spectrum Illuminators can be positioned to be (effectively) close laterally to a Monochrome LAR-Reader's LOS so the READER efficiently receives both LOCATE AND Code data light from RR regions of a LARcode. This type of LARcode is here termed an “RRLARcode”. Regions of an RRLARcode can include uniform code regions and/or patterns comprised of colored RRs and/or broad spectrum RRs with transparent color overlays thereon. This type of LARcode can also reduce the effects of ambient light in situations where multi-spectral LARcode methods and apparatus are used. PLEASE SEE VARIOUS SECTIONS OF PART B, notably B.08.

A.16 As in section A.15, but wherein the Camera can be a Color Imager.
A.17 As in any of the above sections A.08 through A.16, wherein an imager is a line-scan device.
A.18 As in any of the above sections A.08 through A.17, wherein an Illuminator is a line-scan device such as a laser or multiple lasers outputting different wavelengths.
A.19 As in section A.18, wherein an Illuminator for use with LARcodes can be a projection device (such as a projection TVs, arrays of spotlights, or similar devices which output lighting that can illuminate areas within a scene (in which LARcodes can be present) with time-variable and/or region-variable brightness and/or color spectra. In addition to projection of images from video or other imagery sources, such projected lighting can be fixed or adaptively-controlled as discussed earlier in this document and/or can be responsive to the code content or spatial behavior of Codes within the scene being illuminated.
Concerning “Annoyance” from LARcode-Related Lights:

LAR-Readers and associated or special system-related/controlled Illuminators can be placed near general environmental light sources in positions such as on ceilings, walls, lamp-posts, etc. The primary FOV of a user of a LARcode system often need not include such system-related light source positions.

A LAR-Reader's FOV can include LARcodes which are excited by Illuminators that are relatively near the READER. Meanwhile, LARcodes manipulated by users themselves can generally be oriented or otherwise configured or positioned/“posed” by them so as to be within the FOV and Readable by a LAR-Reader while the user's instantaneous LOS/FOV during such use need not include the Illuminators. For example, LARcode Illuminators shining more or less downward from above and near Readers similarly oriented can be used with LARcodes facing more-or-less upward as they are held or manipulated by users using a horizontal or somewhat downward LOS.

Commonly-used lighting sources, such as those used for providing ambient lighting in a venue and/or for special-effects lighting unrelated to LARcodes can be very unobtrusively supplemented by the special intermittent, pulsed, or otherwise-controlled LAR-System Illuminator lights. These can be specifically devoted to use by the systems disclosed herein or can have multiple or additional purposes. For surveillance or security purposes, they may, for example, be designed to appear unremarkable or “ordinary” such as being a part of an assembly or a row of flashing “marquee” lights. LAR-Readers can be built into or adjacent to these sources but sufficiently distant so that the non-system lights do not interfere with LARcode RR LOCATE functions.

### Part B

B. LARcode Apparatus and Methods Using Tiled Mosaic Blocks, Patterned Blocks, Nested Codes, Compound or Coupled Codes, and Other Features

Disclosed are novel LARcode apparatus forms, features, and methods of use that expand the types of physical apparatus which can comprise LARcodes per se and/or use LARcodes as components of novel devices and systems with new capabilities and applications. The disclosed art can be used in a given LARcode or in combination with other types of LARcodes and/or other types of codes known in the general art and they can include one or more features facilitating use of LAR-Reader apparatus, accessories, methods and/or capabilities as disclosed in PART A.

### B.01 Preliminary Remarks on Color Reference Blocks, “White Balance” Targets & Locational References

The issued patents referenced in the Introductory Remarks Section of this document describe various and particular features of LARcodes and certain modes of use. The simple form of LARcode illustrated in the Introduction as an example, is comprised of an assemblage of 10 encoding “Blocks”, each Block being freely available for coding in a specific color selected from a pre-determined limited set of colors, in this case RGBCYM.

Throughout this Disclosure, it is to be understood that while Blocks (or other elements or features) can typically be freely available for encoding purposes, several such elements, Blocks, or other forms can be reserved as pre-determined fixed locations which are always assigned a known color, if desired for particular applications or situations, These can serve as Reference Standards used to aid color identification of other elements on the code which are created/printed by the same methods and pigments/inks etc. used to create the reference regions. If white and/or gray is added to the available color palette, these ‘colors” can be used in any location(s) both as code elements AND also as References for “white balance” correction as in traditional television practice.

Furthermore, in certain applications and venues, it can be satisfactory to place Reference colors or white balance targets intended for use with LARcodes in one or several known locations within the venue. Such Reference targets can be completely separate from the LARcodes themselves. They can be simplified codes (e.g. RRs plus one, two or three colors) which are READ intermittently, or as required by system performance, to support reliable decoding. This, in turn, can make otherwise reserved locations on other LARcodes available for other purposes including data coding.

Locational Reference targets can also ID precisely known pre-measured physical entities within a venue whose images may, in turn, be used as local reference points by a LAR-System enabling it to provide very high precision location data of LARcodes imaged within the venue.

### B.02 Blocks, Mosaic Blocks and Tiled Patterned Blocks

Blocks on a LARcode can be simple, often uniform “regions” or “elements” on a code which are uniquely identified by color or other optical properties using a LAR-Reader. However, here disclosed are various more complex types which have certain particular and desirable capabilities or features. Among these are Blocks composed of Tiles of two or more colors present within a Block in various population proportions and which are quasi-uniformly (e.g. in checker-board or similar fashion) positioned within the Block. When treated as a whole, the mixed color tile population represents a Block of mixed color defined by the relative proportion of tiles of the different colors present. Other Blocks can contain Sub-Blocks and/or patterns and shapes created, mosaic fashion, by tiles OR by other methods.

### B.03 Tiled Multi-Color Mosaic (MCM) Encoding Blocks

FIG. 7 shows a device having a LARcode that includes RR material 708 and various blocks 702, mosaic blocks, sub-blocks 712, tiles 710, sub-tiles 706 and simple shapes. This technique uses geometrically/optically-mixed combinations of Reference Colors rather than printer/process-mixed colors to create encoding Blocks representing colors other than a Reference color. Small sub-block tiles 706 of two or more primary colors which are also present as Reference Blocks can be used to create such encoding Blocks. Non-primary mixed colorants can also be used but can yield less robust results if they are not included as a Reference on the LARcode or elsewhere in the scene under closely similar illumination.

LARcodes can be made/printed by various processes. In many instances using “office-type” printers, RGB or CMY colors are mixed to achieve colors other than the primaries and the mixing ratios can vary from one printer or process to another. Therefore, while RGB Reference Blocks on LARcodes can serve well to insure proper identification of any R, G, B Encoding Blocks, identification can be less reliable, e.g. in the case of mixed colorants such as a Cyan created by using Red mixed with Blue. Depending upon how the processes are set-up by the operator, a given printing process for cyan can use 60% of its red primary & 40% blue, while another can use 50% red & 50% blue etc. (Similar remarks can be made about CMYK-based processes, and Reference Blocks using selected CMY can be used in the same manner.) If necessary for a particular type of color code, these issues can be minimized by the following method:

Use only primary colors as represented in the color Reference Blocks on the LARcode as “tiles” to create MCM Blocks as two color or multi-color mosaic-type “checker-board” or other patterns of tiles. This avoids problematic non-primary colors mixed according to different practices. The primaries, as tiles, can be mixed in various population proportions. This substantially enlarges the menu of color combinations/color “shades” that can be used in a single Encoding Block and identified reliably by a LAR-Reader. See FIG. 7.

The tiles, if small enough, can be blurred together because they are below the resolution capabilities of the imager used. This creates/simulates the effect of a uniform mixed colorant composed solely of the Reference primaries on the same LARcode. Mosaic Blocks can also be statistically or otherwise evenly sampled by LAR-Reader software used for determining the ID of simulated mixed colors.

Shown in FIG. 7 is a portion of a LARcode in which the first Block uses a mosaic of colors (e.g. Green) and B (e.g. Blue) to synthesize a color that is 50% G and 50% B (hence cyan) when interpreted as a uniform Block in white light. The individual tiles and sub-tiles shown in the first three Blocks can be much smaller and more numerous than shown. Furthermore, they need not be all of the same size. A set of uniformly colored Reference Blocks is omitted from the drawing, but the fourth Block IS uniformly colored and could be identified as a Reference Block of color X if it is in a location so assigned by the system software. Note that if the sub-Block in the lower half of the second Block is illuminated by an appropriately filtered spectrum of red light, the Color R sub-tiles will be bright and the Color G sub-tiles will be very dim. When then illuminated with green light, the relative brightness will invert. This will be discussed further below.

### B.04 Multi-Color Mosaic (MCM) Sub-Block Pattern Encoding

The second Block 704 of FIG. 7 contains two sub-Blocks 712 by way of example. The lower R+G sub-Block 712 is distinguishable by both color and shape. MCM Sub-Block patterns can be interleaved or divide their occupancy of a shared Block in a great multiplicity of ways and can differ with respect to the fraction of the total area of a given Block occupied by one sub-region spectral type vs other(s). Tiles 710 in Blocks or sub-Blocks can be arranged in distinctive patterns including but not limited to forms which have immediate complex interpretive meaning to humans e.g. “pictures” and/or symbols.

Obviously, such patterns, if too distant or for other reasons, can be too heavily blurred to be READ directly by a given LAR-Reader which might be optimized, e.g. for reading uniform Code Blocks like the right-hand Block above or for treating a checkered tiled Block as on the left as a synthesized uniform color. Employing multi-color Illuminator technologies as disclosed herein, which vary spectra and or other optical properties in controlled time sequences, can provide additional data enabling details in images of sub-Block types, shapes and patterning to be distinguished because of their differing time-dependent color details. This creates rich sets of coding possibilities.

### B.05 Larcodes Containing Color Blocks of Nested Codes (“LARcodeNESTs”)

LARcodes, by design, possess unique features which can facilitate LOCATE and READ operations in visually complex scenes (possibly containing many and/or distant LARcodes). LARcodes can be read at long stand-off distances without requiring precisely detailed imagery. In contrast, Bar-codes, QR codes etc. typically require comparatively high resolution data obtained by close-up scanning or long focal length optics. One solution used in the art is to make such QR or Bar-codes physically large, e.g. on buildings, billboards, hence readable at long stand-off distances, but this has disadvantages, esthetically and otherwise, especially when several codes are present. GPS-supported selective message activation also can be problematic as to sufficiently precise location accuracy (in crowded display windows) etc. and perhaps even basic availability in certain situations and geographic areas.

Disclosed in FIG. 8 are LARcodeNESTs 800 which include RR 806 and one or more (such as the six depicted) LARcode Color Encoding Blocks 802 within which are “nested” BAR-codes, QR codes 806, or other binary (Black/White) types of code containing substantial amounts of data. The NESTs 800 are easily located and isolated in an image (e.g. using LOCATE RR's 806 in the LARcode). Color-encoded data Blocks 802 in the LARcode convey “Top-Level”, “headlined”, amended, updated etc. information relevant to the detailed data to be found in the QR codes, BARcodes, etc. which are nested in the Blocks 802. The LARcode itself need not convey the detailed content in the nested codes nor in “Compound” codes to be described in the next section.

LARcode—color portions of the LARcodeNest 800 can use any of the Block 802 encoding methods herein described (including sub-Blocks or mosaics etc.) although more typically these can be simple uniform color areas. Color Block sizes can differ to accommodate different sizes of the detailed content codes nested within them. An example of a LARcodeNest 800 using QR codes 804 is shown in FIG. 8.

The various shaded and black patterns above represent different colors. Six background color Blocks 802 are shown in this example, with six QR codes 804—printed in colors different from their backgrounds superimposed on them. QR codes 804 can also be printed in black. Reference Color Blocks can be used in addition, but are not shown in the drawing. The entire suite of QR (or other codes) including all the LARcode components can be retro-reflective as discussed previously or, as shown, can use separate RRs 806 of appropriate shapes and sizes of which the RR “T” shape 806 in the Figure is merely symbolic.

The LARcode functions in LOCATE mode and, in this example, also offers the six color background Blocks. An encoding scheme using a choice of one uniform background color per Block (selected from a color palette of RGBCMY colors only) provides an available code universe of ˜47,000 if the QR code areas are all printed in, e.g. black. If two “outboard” uniform color blocks with or without nested QR codes are added, the available coding population is ˜1.7 million. As shown (again merely symbolically) in the lower right Block 802 in FIG. 8, the coding population can also be expanded using more than one background color in an individual Block and that background can feature more than one shape. Taken together, these and similar options provide an adequately large coding universe for conveying the “high-level” information.

Top-Level information from the LARcode can describe the much more detailed information available if the LARcode, with its Nested code content, were to be more closely approached or selected for more detailed reading by, e.g. using a zoom lens with image stabilization to bring up its nested QR content (or any other nested code types such as BARcodes, Semacodes, etc.) up to readable size.

In any of the concepts disclosed here, the Top-Level Data can include a List of the Titles (or some other characterizing information) concerning the Nested Detail-Level Data. Such lists or similar techniques (e.g. icons) can give a user of a LAR-Reader an ability to choose by number, voice recognition, screen-touch or otherwise, which particular Top-Level data categories the user wishes to access.

Top-Level data can also cause a suitably-equipped LAR-Reader to automatically react with tracking, zoom, or other capabilities to capture and process the detailed data (which can be either open or encrypted information) when or if such Detail-Level Data are present in nested codes.

Other types of codes such as HCCB High Capacity Color BARcodes etc. can also be used, but the LARcode COLOR BLOCK coding would then preferably be done in suitably-sized borders around the HCCB areas rather than inside the detailed code area itself. This method can also obviously be used with QR or other black/white codes if desired.

LARcodes featuring LARcodeNESTs offer a “Come closer-learn more” experience. This has both practical and psychological implications. Their Top-Level data, readable at a distance and even if posed sub-optimally for reading, can invite a user to walk down the aisle, divert to a display, cross a room, come down the street to a store window etc. It alerts that helpful detailed information on specific topics can be obtained “over there”. Getting that detail-level information does not necessarily require real-time wireless connectivity because the Nest data codes can be readable using software residing in the LAR-Reader device itself. This can be useful in areas where coverage or access is limited or under-developed.

Given real-time connectivity, such as provided by a TYPE 1 LAR-Reader, data in nested LARcodes can automatically access local proprietary or remote Servers and/or other system data-bases to offer topics/features beyond those provided by the LARcode and/or its Nest. Top-Level data in the LARcode (decoded by a TYPE 1 LAR-Reader or equivalent) can be used to auto-access/activate updates and links provided within the nested detailed QR etc content codes. Furthermore, given connectivity/access via a LAR-Reader to data processors, applications, and other organized information about the specific user (e.g. sales or search history etc.) in data-bases, the Top Level LARcode itself can be tailored to select or substitute, add more detail, make announcements of time-dependent offers in the venue (down to the number of minutes allowed before expiration) and/or embed other special time-dependent personalized information, “here, now, and just for you” etc. directly within the more general detailed code level (e.g. in the content of one specific QR code in the nest). Thus I read about a 15 minute long burger deal while you read about fish sandwiches—from same Nest—so to speak.)

Information from a User's interaction with a particular LARcode and NEST in a venue can also be used to modify the data that will be read-out from of other LARcodes and NESTs in the same venue or in other places visited subsequently by the user of the LAR-Reader.

Very simple visible Symbols such as Arrows or a light etc. can indicate to potential users that a LARcodeNEST is down the block, and that they can retrieve information from it from a distance before approaching it to find more information, by reading the Top-Level LARcode. For example, a sign might indicate that “a LARcodeNEST is OVER HERE so check-out what it is all about from ‘over there’ (e.g. across the street) by reading the Top-Level LARcode before you bother to come on over”.

B.06 Compound Codes: Conventional Barcodes, QR Codes Etc. Proximal to Larcodes

FIG. 9 illustrates a group of standard QR codes 904 coupled with a LARcode 906 to form a Compound Code 900, the LARcode portion of which can be Readily LOCATED, READ (and tracked in motion, if necessary) at long READER stand-off distances.

The LARcode 906, in this instance, again conveys only selected or custom-coded “Top-Level” information about the more detailed or other content available in the associated QR codes, BARcodes, HCCB codes, etc. Compared to a LARcode of similar size, these are readable only in closer proximity or via zoom/telephoto and/or high resolution imagers/optics perhaps using precision image stabilization. The last-named function can also be efficiently enabled using the optional RR's 908 on the QR code groups as guides. While six QR codes 904 are shown, obviously any number can be used. The capabilities, features and concepts disclosed herein pertaining to LARcodeNESTs are equally applicable to the concept of Compound Codes. LARcod 900 can include RR's 910.

### B.07 Coupled Codes, Locked Codes and Keys

Here disclosed are concepts using two or more codes, at least one of which can be termed and functions as a LARcode “Key” 1006 while the other (or others) can be LARcodes, LARcodeNESTs 1000, Compound Codes as defined above or other suitable types of Codes which can be “unlocked” in the presence of the Key in the same image or in otherwise obtained images associated with the Key.

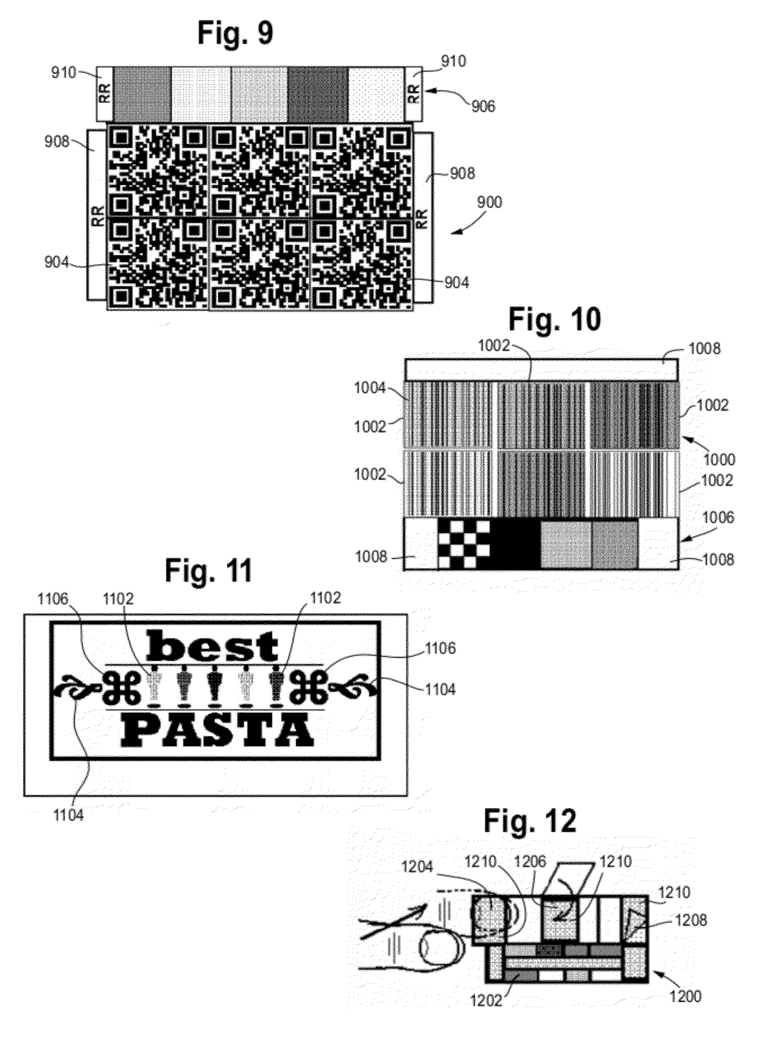

FIG. 10 shows a LARcodeNEST 1000 of six Color Encoding Blocks 1002. Each of these, in this case, contains a BARcode 1004 (which can be any other type of optically-readable code such as another LARcode). The BARcode Blocks can or need not themselves be color-coded For instance, another approach could employ a second LARcode (not shown) which carries in ITS code the identity of the Nest and/or other “TOP-Level” data about the Nest content but which does NOT serve as a Key. The NEST in FIG. 10 is “coupled” to a separately supplied and/or a conditionally-provided LARcode “KEY” 1006 (shown here below the BARcodes). An acceptable image of the Key 1006 is needed to gain desired full access, functionality or other results dependent upon valid readings of the images of the codes which are coupled to the KEY. The number and types of codes in a given assembly need not be a fixed parameter.

When a KEY image is in close physical proximity (or in some other pre-defined required “correct” spatial or temporal—stationary or motional relationship) with respect to other code(s) to which it is a proper key AND the Color Block data on the Key and the NEST, when READ together, satisfy pre-determined criteria, then the Keyholder can be granted access to part or all of the encoded information in the NEST e.g. BOTH the basic Color Blocks of the NEST and/or in the BARcodes or QR codes etc. within those Color Blocks. Such access can also convey other defined privileges to the user or can enable many other types of actions such as participation in voting, prize drawings, registering opinions etc.

The information that is unlocked to the user can be directly encoded within the NEST in plain or encrypted form. Additionally, the NEST can contain look-up information which is used to access the unlocked information from a central data base. These methods of encoding information into the NEST can allow more data than might otherwise fit in the NEST, and can prevent intruders from attempting to manually decode the NEST.

A Key can be provided upon fulfilling a particular condition or conditions: i.e. by purchasing, by being given as a premium, being won, being judged security-qualified, etc. A Key can be easily changed, re-issued, deemed expired or replaced at any time the System operator chooses or requires.

Where security or similar matters are an issue, a LARcode Key can associated with other means of ID, e.g. on a Pass or credit card. Its use can also require the presence of a pre-determined RFID code tag to permit opening of the data within a locked code or additional ID such as voiced or keyed pass-words, mid-air gestures in view of an imaging device capable of tracking LARcode motions or other ways of tracking & identifying body movements with precision, signature entry, biometric verification, face recognition etc.

### B.08 Larcodes Using Retro-Reflectors in Both Locate and Code Regions (RRLARcodes)

This Method and Apparatus uses LARcodes wherein the LOCATE regions AND some or all of the Code Region color areas are both Retro-Reflective 1008. Such RRLARcodes 1008 can be fabricated using transparent inks that are printed or otherwise laid down on receptive transparent films or coatings behind which are materials with retro-reflecting properties. They can also be fabricated using screen printing methods to transfer retro-reflective paints or pigments onto non-retro-reflective substrates.

Since retro-reflective sheet materials (e.g. as used to highlight warning signs at night etc) are readily available, another method for constructing RRLARcodes 1008 can use patterns of colored transparent inks printed on sheets of transparent plastic etc which are made receptive to the inks, cut to LARcode size and shape and then adhered to a retro-reflective substrate to complete the RRLARcode 1008. Printing can be via ink-jet or other techniques. This and other methods can also be implemented using recently demonstrated nano-gratings as the reflectors.

The several printing and screen methods just described are among various processes that can also be used to produce sub-PATTERNS and mosaic-like areas within a single Code area or Block. These patterns can, within themselves, be multi-colored for reasons explained in Section B.02 etc. above. Also, while mentioned here in the context of RRLARcode production, these are applicable to fabricating LARcodes on other types of substrates including paper, cloth, opaque plastics, glass etc and also, by adherence or other means, on objects that are not inherently retro-reflective. Furthermore, retro-reflective BARcode, QRcodes or other coding overlays/patterns whether monochrome (B/W) or color, can be produced by these methods and used as variously taught herein.

### B.09 Composite RRs in Locate or Read Elements

In any method or Apparatus disclosed herein as using passive retro reflectors in LARcode elements (also LARsponder as in Part C) another method can use strips, squares, or other shapes of different mono-colored transparent Gels (available in a VERY wide range of transmission spectra contours) which are assembled side by side to produce the functional RRLARcode (or in some cases over-lapped) and then overlaid, in total, on a retro-reflective backing.

RRLARcodes in which some or all regions are retro-reflective can (but need not) use separate LOCATE regions distinct from code regions.

The comparatively bright returned light from filtered retro-reflective color codes or otherwise-patterned RR regions enables all-region retro-reflective RRLARcodes to be used in bright ambient lighting conditions. In moderately lit, dim, or dark venues, the Illuminator light levels can be correspondingly lower. Related matters are further discussed in the following Section.

Novel types of RR Regions can also be comprised of more than one type (e.g. two) of RR sub-structures, each with several different basic optical parameters—such as incoming light acceptance angle of the incoming beam axis versus resultant return-beam intensity or color content or both (two mixed different refractive index and color of micro-spheres embedded in the same transparent binder matrix). Similarly, substructures in a given RR can be in the form of strips or “checkerboards” etc. with differing range or pose dependent optical parameters. This provides a basis for RR pose-angle determinations and/or range information derived from LAR-Readers (with known off-sets between their Illuminators and their LOSs) using methods based upon, e.g. observed intensities/color ratios from the different types of RR materials.

B.10 Larcodes in Dim, Dark, and/or Theatrical Venues

Materials are known in the art (phosphors) which can be induced to emit visible fluorescence and/or phosphorescent light under UV excitation. These materials can be used to fabricate LARcode Color Blocks which can be located and READ by conventional or high-sensitivity visible light imagers/cameras via emissions stimulated by UV excitation flashes. The wavelengths of such stimulated emissions are often sharply defined. Depending upon the materials used, the stimulated phosphorescence can be in different spectral regions. This facilitates novel methods of use of multi-color LARcodes especially in venues where the ambient lighting is normally of comparatively low-brightness (e.g., theaters, movie-houses, bars, etc.) or in other venues where ambient light levels can be dimmed momentarily, for an interval or for lengthy periods. The ultra-violet excitation can be extended in time or delivered in flash sequences and at levels/durations safe for humans. The UV can originate from UV light sources that need not be positioned close to an Imager's LOS since retro-reflection is not involved. Excitation sources can be close to LARcodes of this type. It can be delivered (e.g. by “searchlight” beams) from distant sources. The excitation illumination can be delivered from behind occupants in the venue and/or from above thereby largely avoiding audience sight-lines.

Distinctive multi-spectral or mono-spectral UV-excited phosphorescent Blocks, sub-Blocks and patterns, such as mosaic-like tiling, can be used as LARcodes.

In ways parallel to the above, fluorescent and/or phosphorescent substances are known in the art which use Infra Red or visible sources rather than UV for Excitation.

LARcodes employing photo-luminescent elements with phosphorescent decay times of the order of seconds or more can use normal levels of ambient visible light to initially “charge” such elements. The venue light levels can then be briefly lowered for LOCATE AND CODE reading.

During low lighting, momentary or otherwise, LARcode sensors using imagers with appropriately high light sensitivity and/or sequential multi-spectral selectivity can both LOCATE and READ excited fluorescent and/or phosphorescent LARcodes without depending upon RR's.

If RR's are designed into (or are otherwise operationally associated with) LARcodes employing some form of phosphorescence, lighting sources positioned close to a high sensitivity LARsensor LOS can be used to locate LARcodes via continuous or intermittent retro-reflection of IR sources. Brief visible retro-reflected LOCATE flashes of very modest intensity can be used, during or after which the ambient level can be dimmed to allow LAR code sensors to READ evanescent fluorescent/phosphorescence from the pre-located excited code regions.

In addition to, or in combination with the above methods and apparatus, high-sensitivity monochrome or color visible light imagers and the various multi-spectral methods described in PART A can be used in dim venues. Low-brightness multi-spectral visible light Illuminators working with (“all-over” retro-reflecting RRLARcodes as in B.08) can be employed to good effect in this regard.

### B.11 A General Note Regarding Light Levels

In any of the apparatus and methods discussed in this disclosure, it is to be understood that the use of terms like “ambient” and “low-level” do not necessarily imply a particular range of illumination energy per unit area in the scene or being received by a LAR-Reader. (Twilight can be low-light in one situation but very bright compared to moonless nights or other situations in which LARcodes must function.)

The techniques, methods, cameras/imager equipment, Illuminators and combinations thereof for LOCATE and/or READ functions have, for convenience, generally been described in this disclosure in the context of “typical” environments and imaging devices. However, recent developments have greatly increased the effective available ISO speeds of Digital SLR imagers such as the recently announced Nikon D3 camera which can be operated as a color imager at a sensitivity of up to ISO 102,400 compared to typically-used ISO's for currently popular digital imaging devices in the range of ˜100 to ˜1000. In addition, intensified high-sensitivity devices such as EMCCD or ICCD (Electron Multiplied CCD or Intensified CCD) imagers are available which have great visible, IR, and/or UV sensitivity. They can have monochrome or multi-spectral capabilities. As disclosed elsewhere herein, read-out of color data by a monochrome imager can be accomplished by using differential and/or ratio brightness behavior as produced under known sequences of low-brightness (especially if spectrally-filtered RRs are used in code elements) illumination having different color spectral properties.

Such high sensitivity imaging devices can be used to implement many of the teachings herein at much lower than “typical” levels of ambient light, Illuminator power, RR LOCATE light levels, fluorescent/phosphorescent emission brightness etc. In particular, they can operate with LARcodes at levels near or below the visibility threshold of the normal (or even dark-adapted) human eye. They can be readily intermixed and used alternatively or in combination with “traditional” visible and/or IR imagers/cameras to achieve desired effects and LAR-System operational goals.

### B.12 LARcodes COMBINED WITH RFID TAGS

As in any of PART B, but including a passive or active RFID chip “in” or physically associated with a LARcode, LARcodeNEST etc. enabling an RFID System monitoring a venue to communicate data to a cooperating LARcode facilitated System regarding the PRESENCE and types of LARcodes within the venue even if they are optically occulted and/or are located in approaches or proximal spaces which are not equipped with LAR-Readers or such Readers are not activated. Such data can allow the LARcode system to account for or classify a Code as (1) being LOCATED, READ, and/or TRACKED satisfactorily; or (2) being missed or subject to complete or partial occultation as presently viewed by all or particular LAR-Readers; or (3) being a candidate for assignment of other or reserve Readers and/or commanding Readers with adjustable LOS's and/or FOVs to assist in acquiring available LOCATE/READ data from the subject LARcode.

Since an RFID-tagged LARcode (passive or active) can signal to a monitoring LAR-System about its departing/approaching movement hence potential or current “presence” somewhere in a given or relevant proximal space, this method can be used to pre-activate/prioritize/direct a System using LAR-Readers to take certain actions relevant to that LARcode (even if not currently visible). These actions may, for example, include implementing direct optical search for the RFID tagged LARcode or LARcodeNEST etc. redirection of a Reader LOS and altering its FOV. Particular applications involving other venue equipment, commencement of alerting and response activities etc. can also be triggered.

In the context of the above, note that, for example, an owner of a TYPE 1 Imager can have an RFID tag affixed to it (and optionally, a LARcode—please see U.S. Pat. No. 7,161,581 referenced above). If desired, or as already registered in the system, the owner's Imager can be alerted to opt-in or can be auto-admitted to that system via the RFID code Reader(s). GPS, if available in the venue and if the imager is on-line, can also be similarly used but may not provide very precise location data or Imager LOS & FOV information.

### B.13 Certain Basic, Additional, & Expanded Features of LARcode Apparatus & Methods

For purposes of this Disclosure, and in addition to combinations disclosed in any particular context elsewhere herein, a LARcode apparatus, features and/or methods of use can include one or more of the following:

B.13.1. “Locate” RR elements plus one or more passive code elements which can be comprised of one or more visible-light colored Blocks/regions, multi-color mosaics, patterns, shapes/sizes of various widths or lengths.

B.13.1A. As in B.13.1, wherein a given RR region or regions(s) can be comprised of two or more interleaved strips or other patterns of retro-reflective material having different angular brightness dependencies with respect to incident and/or viewing angle—for example, one useful for closer distances and wider incident angles etc. and the other for brighter returns at long distances and narrow angles.

B.13.1B. As in B.13.1, or B.13.1A, wherein one or more of the Blocks, regions etc. is comprised of elements distinguished by their spectral characteristics at wavelengths other than those of visible light.

B.13.2. As in B.13.1, 1A, or 1B, wherein some or all of the elements are essentially 2 dimensional, or planar.

B.13.3. As in B.13.1, 1A, or 1B, wherein some or any of the elements are 3 dimensional entities (e.g., spheres, disks, open or closed cylinders, skeleton, partially closed or closed polyhedrons, the last-named including STELLATED and CONVEX Classes or other complex shapes or portions thereof).

B.13.3A. As in B.13.3, wherein the 3 dimensional entity or a portion or portions thereof are inflatable (such a Mylar balloon or other inflatable structure).

B.13.4. As in B.13.1, 1A, 1B, 2, 3, or 3A, with one or more LOCATE RRs having colored overlay regions such as colored filters, gels or other structures or types of printed or assembled transparent ink patterns having spectrally-selective properties.

NOTE: In any of the methods/apparatus herein disclosed, the arrival or presence of a particular color of RR light in images captured by a LAR-Reader may be used to “Awaken” the LAR-System to full attention and trigger for example, the display or announcement of “Welcome” messages, instructions, etc.

B.13.5. As in B.13.4, wherein one, some, or ALL of a LARcode's CODE elements can be retro-reflective and can have the appearance of uniform Blocks/regions, multi-color mosaics, patterns, shapes/sizes of various widths or lengths comprised of spectrally-selective RR structures in combination with overlays such as Gels or comprised of other components with functionally equivalent optical properties which can include retro-reflective inks/pigments, or colored coatings/dyes on a retro-reflective base structure.

B.13.6. As in B.13.5, wherein one or more LOCATE or CODE elements can be actively illuminated by a light source(s) energized by a power source which is physically part of the LARcode, which power source can be free-running or on/off timed-controlled/modulated by an associated PLCM and/or wherein light from said light source(s) can be directly visible, can be inherently colored, and/or can back-light a spectrally-selective filter.

B.13.6A. As in B.13.6, wherein the light source can be flexible and/or distort-able by external forces applied thereto

B.13.7. As in B.13.6 or 6A, but wherein an active light-source or sources associated with a LARcode can be varied, controlled and/or responsive to commands delivered directly from exogenous sources of data including but not limited to data such as venue time, temperature, light-levels, on-board accelerometers, audio, touch sensors, GPS receivers etc.

B.13.8. As in B.13.6, 6A, or 7, wherein said active light-source(s) can be RF or optically-cued or otherwise controlled as described elsewhere herein.

B.13.9. As in B.13.6, 6A, 7, or 8, wherein the active light source(s) are comprised of one or more LED sources or other light sources emitting UV, NIR or SWIR.

B.13.10. As in B.13.6, 6A or 7, wherein the light emitting devices can be comprised of one or more panel-type (flat or another shape as in 3 above) arrays of emitters capable of displaying patterns of light dynamically under exogenous control or UNDER control of the System employing the LARcode.

B.13.11. As in B13.10, wherein one or more actively powered light sources is comprised of a back-lit array(s) of pixels whose transmitted color distribution can be controlled exogenously or by the System employing the LARcode.

B.13.11A. As in B13.11 through B.13.6 wherein the power source is used to activate and modulate variable electrochromic elements rather than produce light energy directly.

B.13.11B. As in B.13.11A, wherein the active light source excites fluorescent emissions from LOCATE and/or CODE regions.

B.13.12. Transparent, transparently-colored, partially-colored, or colored regions which may, when viewed along a particular LOS overlap or obscure or partially overlap or obscure one or more other regions and/or when rotationally re-oriented at other angles with respect to an Imager's LOS can overlap or partially obscure other regions which can be opaquely colored, transparently or colored RRs or code regions so arranged such that at least one or more regions as viewed by an imager having such LOS is presented with colors indicating a specific angle of rotation in 3D space of the LARcode with respect to that imager's or another imager's LOS

B.13.13. RR LOCATE regions or code Blocks can be specially colored or exhibit particular multi-spectral regions which DESIGNATE a special property or priority such that, e.g. if the code data itself was not be successfully read upon first location and attempt, it should be assigned and revisited by the system at high priority, frequency, zoom level etc. In any of the apparatus and/or methods being disclosed, one or more regions of a LARcode can include gratings, nano-gratings or other structures causing diffraction or wavelength effects on incident illumination, the resultant reflected/diffracted or retro-reflected/diffracted or otherwise altered light can be caused to angularly separate by wavelength or intensity and said light can be detected and/or imaged by one or more additional LAR-Readers whose Lines of Sight are displaced from a particular LAR-Reader's LOS while sharing at least a portion of that Reader's FOV. In addition or alternatively, one or more illumination sources in locations laterally displaced from the LAR-Reader can be used to excite diffracted light which can be detected and/or imaged at the first-named Reader's position. The above properties and methods can be used to facilitate creation of LARcodes etc. which are difficult to counterfeit and/or whose validity can be readily verified by the system or by inspection.

B.13.14. One or more RR LOCATE regions associated with a LARcode (or other code type) can also serve a CLASSIFIER function based upon their RR color(s) or shape(s)—e.g. notifying the system that a particular code type is of a certain Class which should be read, ignored, or routed to one or more applications etc. In addition to RR LOCATE elements, other CODE elements, whether passively reflective, retro-reflective, or actively illuminated and in any format compatible with the LAR-System serving a given venue can also function as Classifiers.

B.13.15. Standardized data locations (e.g. location of 2-3 Reference Blocks with respect to each other and/or LOCATE RR regions) in stand-alone LARcodes or in Top-Level codes in Nests can instruct an Imager to automatically invoke one or more IMAGER software functions/options aimed at improvement of full data READ results. Such options can include (but are not limited to) various types of adaptive choices/adjustments based upon sizes, shapes, colors, image quality of LOCATE regions which, in turn, activate serial auto-zoom, exposure bracketing, priority ROI definitions, or/and tracking speed functions etc.

B.13.16. LARcodes containing special or timed offers, “insider” contest information etc. can be tightly integrated with other imagery such as Logos, Ad copy, product-label typography and/or design elements so as to be colorful and artistically/esthetically attractive while delivering desired functionality. The presence of codes can be very unobtrusive and subtle, if desired. This is in contrast to BARcodes and similar standardized formats. Not all labels need carry the same (or any) LARcode, thus inviting close attention.

A very simple example of a code within an “artistic” graphic is shown in FIG. 11. The shaded figures 1102 are examples of color code elements. The “wing-ding” pairs 1104 and 1106 are LOCATE elements. Backgrounds can be colored also. LARcodes comprised of small detailed and/or sub-tiled areas can be used when labels can be closely approached to within e.g. a few feet in a store or viewed with zoom optics. Other LARcodes associated with the label code can be added. Small areas of RR color(s) or other regions can instruct LAR-Readers and the System employing them as to what encoding protocol/application is to be used etc.

Please see other parts of this document for additional disclosures of LARcode apparatus and methods which can be adapted for “appearance” and aesthetic design purposes. In particular, note that LARcodes which include aesthetic elements can be used not only to provide information to a user of a LAR-Reader but also can be “aesthetically-enhanced” components of LARsponders (as detailed in PART C) which are manipulated by a user to provide information from the user.

NOTE: Many of the disclosed apparatus, methods and/or capabilities disclosed in PART A and/or PART B, as well as those disclosed in subsequent parts of this document, provide novel advantages when employed with data coding formats which DO NOT use color-dependent block data coding methods etc. Such coding methods include monochrome BARcodes, monochrome QR codes, Semacodes, Data Matrix codes and the like. HCCB color code formats can also be advantageously employed and/or combined with the novel methods, apparatus, and features being disclosed herein.

### Part C

### LARsponders—Novel Interactive and Participative Response Apparatus and Methods

### C.01 Introduction

The Methods and Apparatus disclosed thus far in this document have related primarily (but not exclusively) to the acquisition by LAR-Readers of fixed information represented by pre-defined and fixed data-coding features of LARcodes (or other code formats). The LAR-Readers also are able to capture data regarding the locations and time/space trajectory behavior (i.e., they also provide data for tracking the 3D or 2D locations) of such LARcodes.

PART C of this document discloses novel art pertaining to “LARsponder™” Methods and Apparatus. LARsponder technology can take a wide variety of forms. LARsponders can, in part, employ concepts related to LARcode ID and tracking technology per se, but they add unique and useful capabilities reaching far beyond those of fixed content LAR-codes as described in PART B.

Importantly, LARsponders, in general, DO NOT REQUIRE that users possess or employ any particular communication device, e.g. cell-phone, smart-phone, iPad, Blackberry, etc., nor be skilled with any specific “Application” package or use any particular service provider. Among other exploitable advantages, this permits users/audiences in the same venue to be very heterogeneous with respect to their “digital age” skills. LARsponders enable masses of LARsponder users/owners to fully participate in venue “action” simply by manipulating their own personal LARsponders. Individually, or en mass, audiences using LARsponders can range from “no gadgets for me” technophobes to elaborately equipped sophisticates. On the other hand, LARsponders can be used in conjunction with LARcodes to expand the menu of response mechanisms available in a given venue in which LAR-Readers are operating. For example, this can involve as simple a matter as physically placing a LARcode or some type of LARsponder ON a cell-phone, iPad etc. device as shown in PART A, FIG. A2 (2-8).

Use of such mobile and networked communications devices in environments in which LARsponders can also be employed is further discussed elsewhere in this document.

LARsponders can be zero-power devices, simple enough to be distributed to users as “give-aways” and/or disposables. Supported by their companion technologies, as detailed in other sections of this document, they enable two-way, real-time, feature-rich, interactive communication between individual users and complex systems and open a wide range of novel commercially significant applications.

Many types of LARsponders can be manufactured at near zero cost. They often can be merely printed on paper, cardboard, or plastic sheeting etc. They can be used globally in any venue in which LARcode Reader Systems are either temporarily or permanently installed. Suitable venues can range from locales with highly developed and accessible general communications networks to under-developed countries/territories with almost none at all.

In a given interactive venue, a few individuals or many tens of thousands can simultaneously participate in rapidly-paced activity using LARsponders in real-time without encountering traffic delays or long latency in system response.

LARsponder functions can be implemented using LARcodes or combinations of elements comprising parts of any types of LARcodes or entities associated with such LARcodes (or using other code forms or defined data sources such as BARcodes etc) as described earlier in this document.

LARsponder “action” and responses in a given venue can be imaged by one or multiple LAR-Readers. The LARcode Readers are supported by apparatus, methods and systems as described in PART A and elsewhere in this document. Responses/actions of individuals, groups, and/or massed crowds using LARsponders become immediately available in the form of qualitative and/or quantitative data representing choices, preferences, opinions etc. Correct and timely LARsponder responses can require physical/temporal manipulations quite outside the capabilities of general purpose keypad-entry methods, touch screens, or proprietary game controllers etc. A wide range of inexpensive LARsponders can be customized to deliver varied mental, observational and physical challenges.

Some of these challenges can involve users/participants in massive numbers all competing within a single venue and all responding simultaneously (on cue) on sub-second time scales. Such essentially “real-time” data can be used for entertainment, opinion polling, games, incentive and interactive advertising, massive focus group type studies and the like.

Various types of “special” or privileged challenges, helpful hints etc. can be timely delivered to persons in the venue via their Cellphones, Smartphones, tablet PCs etc. by downloading from the network. These devices can use pre-loaded “apps” and/or specialized websites displayed in standard web-browsers for the purpose of using such information optimally. Actual responses, however, can still require/involve use of a LARsponder.

Data collected via LARsponders can be used to control subsequent result-adaptive and/or pre-determined sequences and/or iteration of follow-up cues, challenges which yield additional data and/or allow non-deterministic (i.e. unpredictable outcomes) to occur.

If desired, in-venue LARsponder data can be melded with (or compete with) other data amenable to being collected from out-of-venue sources, e.g. from persons remotely listening to, viewing, or otherwise following in-venue events. Such out-of-venue data can be communicated to and collected by the System using known methods such as the Internet, WI-FI, cell-phone texting etc. Additionally, these last-named channels can also be used for certain forms of data amenable to collection from sources inside the venue but who do not belong to any LARsponder-user cohort.

LARsponder manipulations can be independently initiated/timed by a user, or can be cued in response to external events, stimuli, audio/visual or other prompts, situations, challenges or conditions.

Human users can be individuals, groups, and/or crowds of participants each equipped with one or more LARsponders of various types.

LARsponders can also be manipulated and/or activated by non-human “users” such as animals or by devices which are controlled or driven by external mechanical or environmental inputs. In this class of applications, they can optically-read by LARcode Readers and can function as transducers.

Response actions/mechanisms used in LARsponders can be reversible or irreversible (i.e. destructive as in tearing, scraping-off etc.) depending upon the objectives and the rules imposed on the use of a given type of LARsponder for a particular activity.

LARcodes with appropriately selected properties or sets of properties (as described in Part B) and/or in combination with other objects, codes, or even other LARsponders can function as LARsponders. Furthermore and in addition to providing various and multiple response capabilities, LARsponders can, if desired, incorporate and require timely presentation of a variety of novel “Validation” and “Qualification” features as will be described later in this document.

### C.02 Simple Example of a LARsponder

Even a rather simple LARcode 1200, as exemplified in FIG. 12, can function as a LARsponder component employing several response mechanisms. For example, 1202, a generic LARcode which might ID a relevant event, contest, group, product etc and/or the application software to be used by a venue System for processing the LARsponder's input data. The LARcode component shown is rudimentary but could equally well have employed many other features of LARcodes as described in PART B.

In this instance, the LARsponder employs both obscuration and disclosure response mechanisms. Feature 1204 illustrates a response recognizable by obscuring an RR 1210 which can or cannot be of a particular color depending on the data interpretation software in use. Feature 1206 uses folding to disclose or obscure another coding element (again optionally an RR 1210 or merely a pigmented region). Feature 1208 shows a “peel-able” or stick-on covering over another coding element.

Given the “reference-axis” design of LARcode 1202, further capabilities of this example (together with appropriate software) could include conveying choices/responses by orientation (e.g. horizontal or vertical, and/or by gesturing motions, e.g. on-cue up-down as in “yes” nods or side-to-side as in “no”.

### C.03 LARsponder Response Methods and Apparatus

The following sections provide both broader descriptions of LARsponder apparatus and methods as well as some examples of specific or illustrative embodiments.

### LARsponder Response Mechanisms:

NOTE: Most of the Response methods and apparatus types described can also be used in a required prior step meeting pre-defined criteria which, if successful, validates or qualifies the user and/or activates a LARsponder or LARcode as a acceptable source of subsequent Responses. See also Section C.6 below entitled “Activation, Validation and Affiliation of LARsponders/LARcodes.”

1. Response by Feature Obscuration or Designation

On cue or otherwise, elements of LARsponders/LARcodes can be partially or totally physically obscured at appropriate times (or for appropriate intervals) to signal specific responses. Obscuration/occultation of elements such as RR and/or code areas can be caused by the user per se (e.g. covering by finger, moving behind an obscuring external object, manual rotation/movement of elements out of view) or by user manipulation/actuation of auxiliary mechanical features (e.g. sliding parts, hinging, folding or rotating parts, peel-off or adherent members, folding over, “dog-earing” different corners of a paper document, closing shutters etc. by user). The obscuration mechanism can also comprise the act of “blocking” a LARcode Reader's view of an entity or entities that are/were “associated” with a LARsponder itself by having been present and identified by the venue System in a image previously captured by a LARcode Reader.

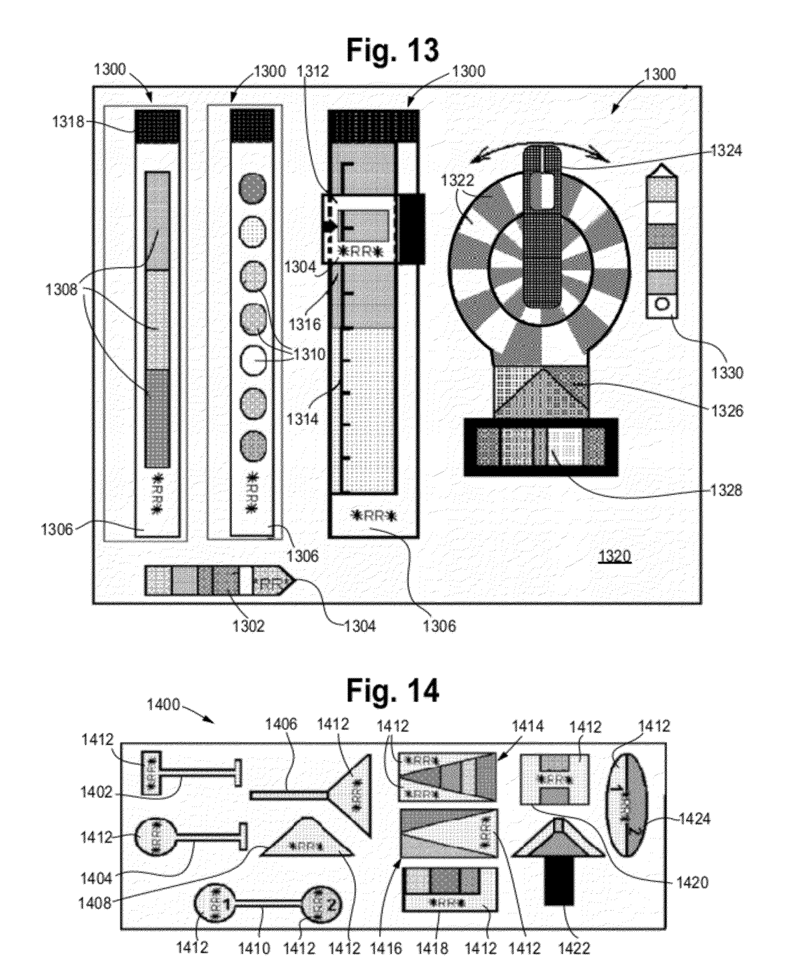

In the case of element Designation, methods such as positioning or affixing a furnished adherent (“Post-it Note” style) selector mask, frame or symbolic shape such as an arrow can be used. See FIG. 13 at 1302 for one example. A finger or cylinder etc (a pointer, a pencil, etc.) can also be used. These designators or others with equivalent utility can, themselves, be equipped with 2-D or 3-D LARcodes of various types as discussed elsewhere in this document and/or other elements including but not limited to 2-D or 3-D RR regions. Designators can also be used to occult an underlying region of a LARsponder (such as a uniform RR region) thereby assisting LARcode Readers in determining more precisely what point in a LARsponder image is being designated.

FIG. 13 displays a few examples of LARsponders 1300, located within a given area 1320, using obscuration and/or designation. These examples also are representative of LARsponders 1300 capable of communicating quantitative opinions or choices etc. The various types of shadings in above and elsewhere throughout this Disclosure are meant to represent different colors in the spectrum and can or cannot also be retro-reflective. Areas marked 1304 are retro-reflective, and can also be colored retro-reflective or “white” retro-reflective across most of the light spectrum or otherwise.

1306 items exemplify linear forms of LARsponder components. 1308 designates regions which can be totally or centrally obscured to indicate a semi-qualitative response—e.g. upper, middle or lowest preference, two sections together partially obscured etc. Interpretation of patterns of obscuration can be more complex using accessory objects to perform occultation of the block or blocks. 1318 can be an accessory attachment, a LARcode ID mounting site, a non-interfering place to grasp the LARsponder etc. 1310 are isolated “choice” spots (here 7) signaled as chosen by being blocked by, e.g. a finger. 1312 is a slider, or otherwise movable member, that can be set precisely to indicate a quantitative response that is measurable and/or accurate to a few percent using a reference scale 1314 along with optional colored and/or RR blocks 1316 which can (but need not) refer to different categories of responses.

Note that these general forms of LARsponders 1300 also can be used as multi-function mechanisms for communicating other or additional or simultaneously combined responses via variable “orientation” as discussed further below.

1322, 1324, 1326, 1328, and 1330 relate to another example form of LARsponder in which a reference scale enables precise quantitative “analog value” responses. For simplicity, scale-wheel 1322 is shown without its perimeter scale graduations and without details of its numbered and/or optional multi-color or RR blocks. 1324 is a pinned rotatable member with features that allow its angular location with respect to 1322 to be precisely determined using LARcode Reader images. 1326 is an orientation reference and 1328 is a LARcode that can be used for various purposes, such as user ID, event ID, product-line ID etc. 1330 is another type of angular indicator. It is not fastened to the main LARsponder disk. It can be coded. It is easily centered using, e.g. a guide aperture, and can be positioned on a LARsponder disk by a user with good angular accuracy. Multiple 1330 type indicators can be used with a given LARsponder disk, if desired.

Indicators similar in purpose to 1330 as well as a simple “general purpose” designator such as 1302 in FIG. 13, can be used with many forms of LARsponders. The indicator 1302 can be adhered to some point along 1308, 1310, 1314, or on perimeter 1302 to portray a quantitative response. For convenience of packaging and/or use, their backings can be coated with “peel-able” and/or re-positionable adhesives.

2. Response by Feature Disclosure

This is the inverse of Feature Obscuration, whereby a previously hidden or not visible LARsponder element or elements (or an associated entity) becomes visible to one or more LARcode Readers as a result of, but not limited to, actions such as slide-out removal of covers, covers being opened to view by rotation, unfurling, folding over or unfolding, by tear-out, scrape-off of an over-coat layer etc.

Change of gross position of the LARsponder and/or changes in a given LARcode Reader's LOS or FOV can also be used as a “response by disclosure” mechanism. In either disclosure or the above obscuration methods, partial effects via masking or unmasking can be employed which rely on specifically defined changes of shape (e.g. square to triangle) or other parameters such as colors, patterns etc. of elements of LARcodes/LARsponders.

3. Response by Orientation

3a. Response by Approximate Orientation

Static or dynamic “Solid body” 2-axis or 3-axis “pose” changes or choices (orientation, rotation, tilt etc.) of LARsponders are initiated by users upon cue or in anticipation of impending “response harvesting”.

One class of LARsponders can include a component, a LARcode, and/or any additional assemblage of elements whose orientation with respect to some pre-defined internal reference element on the LARsponder can, upon a cue to “respond”, be set by the user and detected by LARcode Readers.

LARsponders using orientation to signal responses can include specific “zero angle” design elements or reference features that are deliberately obvious to the LARsponder user. In other cases, user knowledge of the zero-angle reference direction on their LARsponder can be required to be discovered or “earned” in some fashion by the user. A LARsponder's orientation (or change in orientation) as set by the user must typically be with respect to some specific orthogonal set of coordinates known to the user and detectable by LARcode Readers. One suitable orthogonal reference system can be with respect to the user's personal coordinates (e.g. “up”, “down”, “my left”, “my right”, “toward me” or “away from me” etc.).

Another class of orientations can be with reference to a set of orthogonal axes with a major or principal axis being along an LOS aligned toward a distinctive landmark or toward an activity area such as a user selected place, person or other entity on a playing field or toward a large screen data display etc. In the two last-named instances, the principal axis of the coordinate system can become an “aiming” direction toward some moving target reference, graphic symbol, or object in the venue or on a dynamic display. The LARsponder user then sets (or attempts to set) orientations pointing at either zero or non-zero angles with respect to that (non-global and potentially variable) reference direction to indicate predictions, choices, wagers, or to “fire” imaginary paint-balls, etc.

For certain responses or types of participative activities, LARsponder users can be informed that the major axis of the orthogonal coordinate system to be used is aligned along their LOS toward a specific LARcode Reader. The LARcode Reader can be prominently marked, can be unique in the venue, and/or can be ground-mobile, in aerial survey fly-over platforms etc. Matters related to these types of uses of LARsponders are further discussed elsewhere in this disclosure.

FIG. 14 shows an area 1400 containing a few examples from among many types of two-dimensional design elements that can serve as references that are clearly discernible to users of LARsponders as well as to LARcode Readers and usefully included in LARsponder designs.

NOTE: The preceding discussion assumes a LARcode READER is available whose line of sight (LOS) is not too obliquely orientated to the plane of the two-dimensional (“flat”) example reference elements shown in FIG. 13. These types of orientation elements also can be serviceable even if somewhat curved in three dimensions, e.g. hemi-cylindrical. In this context, it should be kept in mind that: 1) Multiple LARcode Readers with different Lines of Sight can be operating simultaneously in a given venue; 2) multiple copies of the LARcodes and other functional features can be used in various places on 3D objects serving as LARsponders; 3) users can be motivated and/or encouraged to align the plane of 2-D LARsponders to be approximately orthogonal to the LOS of some specific LARcode Reader.

Design elements and LARsponder/LARcodes with three-dimensional components and other features are also further discussed later in this document.

Element examples 1402, 1404, and 1406 facilitate determination of a principle reference axis, axis length and orientation direction data. 1408 provides approximate axis direction data, 1410 features multiple color RR 1412 features useful for defining these parameters, differentiating groups etc. of LARcodes and LARsponders by their RR LOCATE region color combinations and is also adaptable to use with comparatively poorly focused imagery since the centers of Regions 1 and 2 can be rather precisely located using known image-processing techniques despite severe (but circularly symmetrical) blurring. Elements 1414 and 1416 are universally intuitive orientation indicators (even for young children) which can incorporate LARcodes 1416 which can be colored and/or RRs as well. Element 1418 is a compact design maximizing color block space while also providing orientation and direction of read information. Element 1420 defines “up” by which color, the upper or lower block is higher in a LARcode READER image. 1422 is equipped with a e.g. a peel-able and or re-useable “tail” that can be affixed to another entity for defining its orientation, enabling its use as a LARsponder or component thereof. 1424 is an example of an “all RR” sticker or design element with both shape and color used to define a principle reference axis.

NOTE: Many elements or forms of LARcodes/LARsponders suited to use as orientation response reference elements, can inherently also be suited to signaling responses via Designation as discussed earlier. In particular, see 1406, 1408, 1414, 1416, 1418, and 1422.

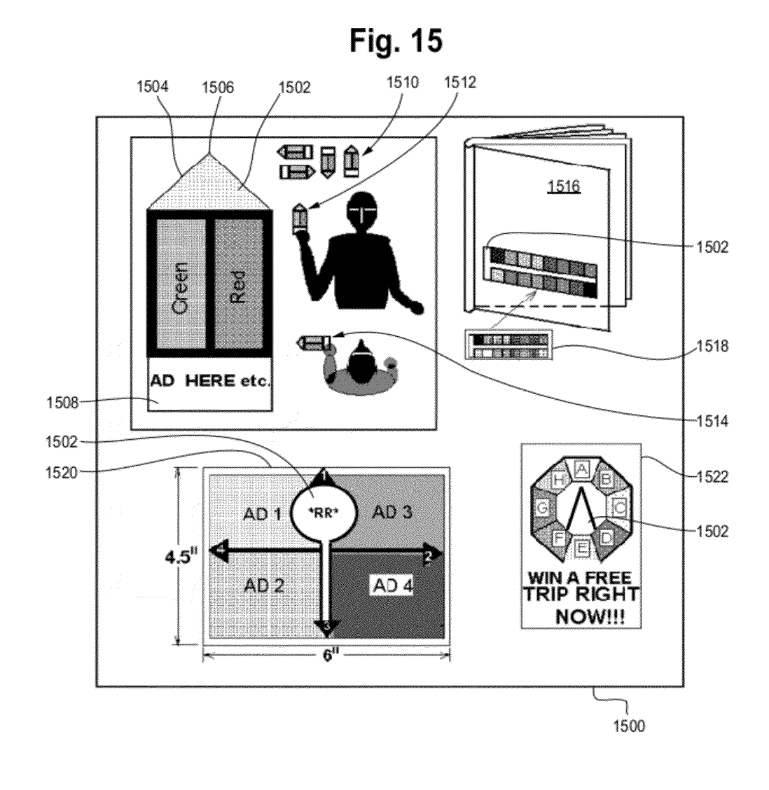

FIG. 15 illustrates some examples of LARsponders in an area 1500 which can be fabricated as simple 2 dimensional printed cards. Reference Elements such as to some of those in FIG. 14 can be employed. Both the graphics and the RR regions 1502 can be printed or screened or can be separately die-cut from sheets etc. and supplied as stickers to be adhered by the user.

Element 1504 is a LARsponder using an obvious reference axis 1506, two color code area C and C′ with space 1508 for other copy such as an Ad or for a LARcode that shows the LARsponder user/owner is a member of some particular group. Four very simple low precision orientations, as in 1510 are facilitated.

If instructed that LARcode Readers (serving for example as vote counters) are more or less in front of them, each user responds (when cued) by showing his/her choice as in 1512 (up, down, left, right). If instructed that Readers are generally “observing” votes from above, users respond by choosing as exemplified in 1514, “my left” (and my forward, my back, my right).

NOTE: Personally-centered orientation reference coordinates are especially well-suited to LARsponders associated with clothing, personal accessories, or other body-mounted locations. Novel types of salable consumer products based upon this fact are possible and proprietary descriptions of certain such products will be found in Appendices to this Disclosure.

As with previous other Drawings and Figures in this Disclosure, the various types of shadings in FIG. 15 are meant to represent different colors typically in the visible spectrum. Areas marked *RR* and/or 1502 are retro-reflective and can be colored retro-reflective or “white” retro-reflective across most of the full visible spectrum.

The Color regions (e.g. C and C′) comprising part of the distinctive pair shown as Green and Red (G/R) can, of course, be varied (R/B, M/Y, C/R, etc.) and assigned various meanings such as indicating that the LARsponder's user/owner belongs to a particular group, or that the LARsponder is valid only for a particular day and time, event etc. Many of the color and patterning methods disclosed in PART B can be similarly employed in these areas.

Many types of 2D LARsponder designs, including those shown in these examples (with the exception of example 1516) can be double-sided and can accommodate choices picked from among two sets of possibilities.

1516 and 1518 show a LARcode H which can encode for event data, user group member data or prize numbers etc. It can be affixed to an Event Program or other item. If the Program is held up and presented on cue in vertical orientation, it communicates a “yes” vote, horizontal orientation communicates a “no vote, etc.

1520 offers four orientation choices, is the size of a postcard so it can be mailed or tipped in to a magazine etc., easily read by LARcode Readers and has space for Ads or areas that can obscured. It, like many other LARsponder designs, can be double-sided offering e.g. use in two different events or more options in one. To avoid confusion, one side or both can be supplied with e.g. peel-able overlay covers.

1522 is an eight choice LARsponder which can be used in orientation (or obscuration) mode with more choices than the other examples shown in FIG. 15. It accommodates choices signaled by orientations differing in angle by 45 degrees and by which color pairs lie on opposite diagonal, vertical and horizontal axes. These color pairs can be reflective or (not shown) retro-reflective. The multiple data sets thus available can improve read accuracy and/or in some circumstances can be used in to indicate dual choices signaled by obscuring a particular color (A through H) using a finger while also orienting the LARsponder at a chosen angle.

In principle, LARsponders of this general type can provide a large number of choices: in this case, 8 possible orientations times 8 possible choices of obscured color allow 64 possible response choices. A simpler version of 1522 obviously could offer e.g. four orientations and fewer, say two or four, color areas sized for convenient obscuration.

NOTE: Another useful method of indicating choice in many types of LARsponder designs, for example as above re 1522, is to make an RR an independent item or element made of magnetic sheeting (or backed with one or more small adhered magnets) and arrange the LARsponder to also have some appropriately positioned ferrous content so the RR element can be stably adhered to it in any desired orientation. This magnetic positioning method, as well as the alternative of adhesive-backed and/or peelable elements can be used with many other forms and elements of LARsponders, designators, etc. disclosed herein.

Successful use of large response universes presumably implies a certain level of skill, especially if time constraints are imposed. Precisely this characteristic can be used in types of system applications in which users can be competing with each other on the basis of speed and/or accuracy of choices etc. It is also to be noted that, in certain applications, and with many of the apparatus designs discussed herein, users could be required to (or permitted/invited to) manipulate TWO LARsponders of the same of different types, one in each hand, and simultaneously or in sequence.

3b. Response by Precision Pointing/Aiming

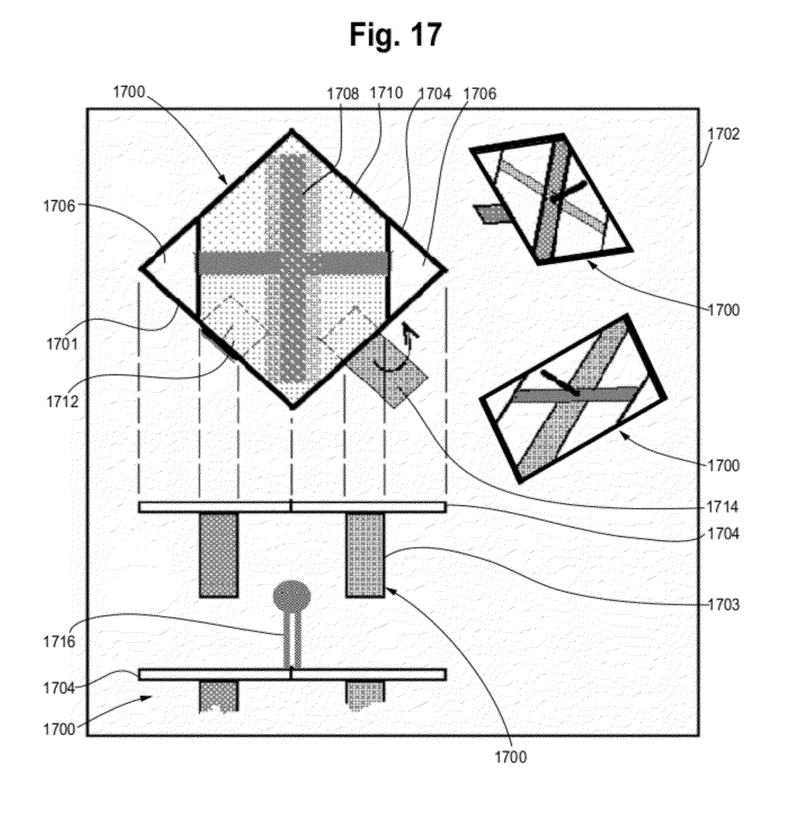

One broad class of precision LARsponders can be as simple as solid-core rod-like “pointing sticks” of appropriate lengths and diameters for their intended purpose determined by considerations of the LARcode Reader capabilities (imager resolution, FOVs, etc) with which they are designed to be used. They can be of various types of cross-sections, circular, square, rectangular, polygonal, faceted and otherwise. They can be multi-colored and/or retro-reflective in certain regions etc. and comprise or bear LARcodes. They can be accessorized with other structures/features/accessories intended to aid LARcode Readers and associated system software in precisely determining a user's intended pointing direction or “pose” in 3-D space (or adjustments or variations thereof). See FIG. 17 for certain specific examples of such accessory features, e.g. stellated items).

An ability to communicate personal responses via defining or moving/adjusting a pointing direction is useful for designating, selecting, voting for persons, physical objects, products, specific locations, and other in-motion or static entities in a 3-D venue space. It also facilitates one-way interactions with 2-D static “targets” such billboards, signs, posters. etc. as well as offering methods for dynamic, real-time, two-way communication with electronic data system via digital displays and/or video screens in LARcode Reader-equipped venues.

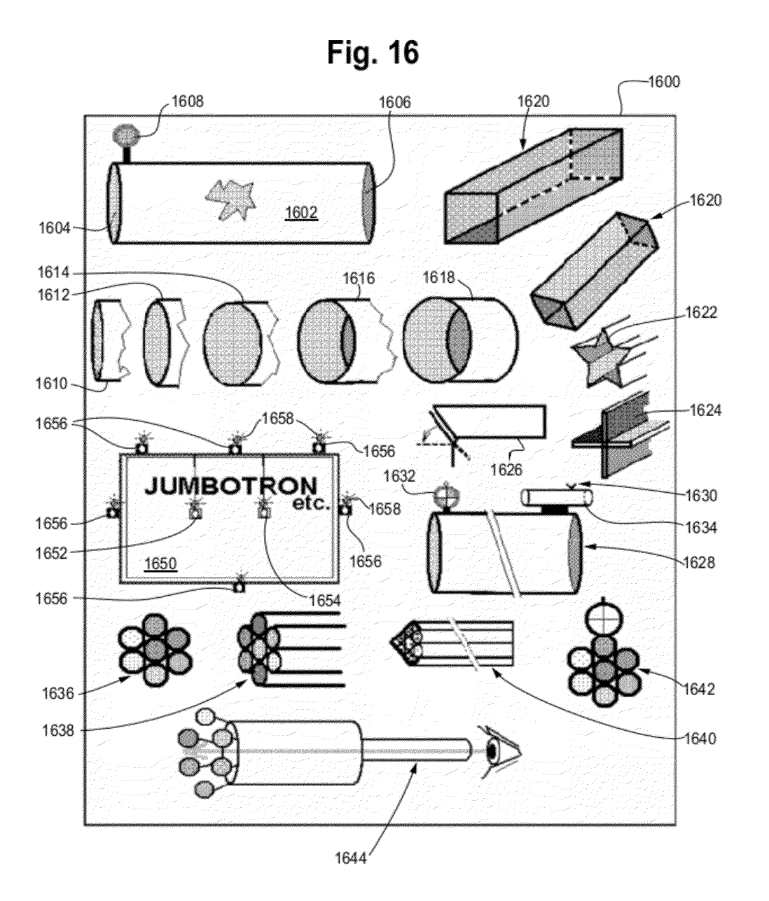

FIG. 16 portrays certain principles and several examples of LARsponder apparatus, located in an area 1600, that reach beyond simple solid rod-like designs. Depending upon operational objectives, for example, when “Jumbotron” or Diamond Vision large-screen video displays are to be used interactively, the suite of LARcode Readers deployed in a given venue can be augmented with additional LARcode Readers whose Lines-of-Sight (LOS) originate from locations proximal to targets or displays and whose Fields of View (FOV) include the users and their reporting LARsponders. This will be discussed further in Section 3c below.

FIG. 16 displays of several types of LARsponders intended for high precision tasks. The first example is based on a cylindrical tube 1602, in this case of circular cross-section. The exterior of the tube can also be of some distinctive color or colors and can carry 2-D LARcodes (not shown). Although the examples here described use components with unvarying cross-sections (e.g. circular, square etc.) as a function of length along the component, this is not intended as a necessary attribute. These angular sensitivity and other attributes of these types of LARsponders can be tailored by employing components of greater area at their entrance ends than at their distal ends, featuring step-function changes or other variations in cross-section along their central axes and/or mixtures of cross-sectional shape/size in sub-elements in a single LARsponder assembly and various other ways that will be evident to those skilled in the relevant arts.

The tube can be internally lined 1604 with some particular color, e.g. Red. The lining can preferably be retro-reflective (RR) material. Although the lining color as shown is uniform, the liner or portions of it—e.g. sections near the open end—can, in some embodiments, be patterned in bands, stripes, mosaics etc.

The tubular structure shields the internal RR from ambient venue lighting to a significant degree. The distal end of the tube 1606 in this example is closed, although in other embodiments it can be partially open or penetrated by structures or devices (passive or active) to facilitate precise aiming. The plane of the entrance end of the tube need not be orthogonal to the tube central axis.

The interior surface of closure 1606 is also a retro-reflector but preferably of a color distinctly different from that of the cylindrical liner. It also can be patterned.

Element 1608 represents a visual aiming aid for the user. It can also be one of the many types of three dimensional orientation-indicating LOCATE and/or encoding elements including but not limited to multi-colored, retro-reflective polyhedrons (FIG. 17) as described later.

The sequence of views of the front portion of the LARsponders 1610-1618 shows how the shape of the interior liner red RR region and of the green closure RR region (and also their ratios—which can serve as an additional and potentially robust pointing indicator) will vary with LARsponder pointing angle as seen along the LOS of one particular LARcode Reader when excited (e.g. flashed) by that Reader's associated light source(s).

These parameters, combined with images of the LARsponder's exterior features (such as 1602's appearance, LARcodes thereon, and 1608 type objects) coupled with additional data sets from other imagers, along with system knowledge defining a “target's” actual location in the 3-D venue space assist the LARcode Reader and associated data processing System in rapidly and accurately assessing and acting upon that specific LARsponder's precise pointing direction/location with respect to that specific target. Data can be collected from participating LARsponders upon an announced “alerting cue” or “count-down” or more frequently during a defined interval of “action” within the venue.

Elements 1620, 1622, and 1624 illustrate that tube cross-sections other than circular can be used in this general class of LARsponders. 1620 and 1622, for example, offer additional RR and/or color-coding options on each of their interior and exterior faces and can be used in a 5-D mode which adds rotation angle around their longitudinal axis to their available response repertoires while largely shielding interior codes areas from ambient light. Example 1624, with all faces available for coding in distinctive ways, also offers 5-D capabilities as well but its coding surfaces are more exposed to uncontrolled ambient light. 1620, 1622, and 1624 can be easily packaged in flattened form for distribution or mailing etc.

1626 is a schematic representation of a blocking member which can obscure aiming information provided by the LARsponder until uncovered or triggered by the user. Inverse actions which reveal an element to signify triggering a “shot” or enabling insertion of markings etc. on targeted images can also be used. Other possible trigger mechanisms include, but are not limited to such actions as causing momentary gross collapse or distortion of a LARsponder structure (or sub-structures), for example, tubular component(s) with flexible-walls.

1628 is a LARsponder that exemplifies auxiliary aiming aids that can range from traditional open “V” indices 1630 and/or cross-hairs 1632 to telescopic/optical sights 1634. In some venues and/or applications, co-aligned active LED/laser devices can be used.

Items 1636 through 1642 depict LARsponders in the form of bundles of cylindrical members which each can have any or all of the structural and/or optical properties described for single tubes. 1636 is a head-on axial view of a bundle using round cylinders. (Hex, square, rectangular cross-sections etc. can also be used and the size of individual bundle element can vary from individual element to element.) For a given overall size, bundles have a narrower range of on-target acceptance angles and can display patterns of interior RR wall colors of distal-end RRs providing additional distinctive coding options and data for the LARcode system software including, for example, rotational angle. And the visible exterior walls of the bundle can also differ in color and/or patterns. Item 1638 shows a bundle with an angular cut entrance which widens the range of view angles over which the interior wall color patterns and RRs can be seen by a given LARcode Reader. The shape of the entrance end of the bundle need not be planar. It can be also be pyramidal as in 1640 and/or other shapes with the result that individual cylinders in a given bundle can present different variations of appearance and dimensions at different angles with respect to a given LOS, a property providing additional flexibility of use.

1642 portrays a LARsponder with accessory sighting aides which can have larger acceptance angles than the individual cylinders of the LARsponder itself. 1644 is a precision-aimed LARsponder using “LARcode elements in one example of code elements in form of arrangements of individual spheres some or all of which may have retro-reflective surfaces and/or may be of different colors representing a LARcode.

These general types of “telescopic sight” LARsponders can, of course, have interior optics or can merely be collimator tubes. The LARcode shown is one whose aspect/appearance varies sensitively with angle with respect to a given LAR-Reader LOS while also being minimally susceptible to complete occultation of all code elements. This example can also be used in higher degrees of freedom applications, e.g. angle of rotation around the device's long-axis of symmetry by including code elements(s) and/or markers accessible to LAR-Readers.

3c-1. Response by Precision Pointing/Aiming with Electronic Feedback

In certain applications, most notably those in which imagery of interest can be portrayed on shared electronic displays, users or groups/teams of users can be provided electronic feedback on their response locations relative to those targets or other imagery. This can be done for competitive purposes or otherwise. Such feedback can be accomplished via color-coded cursors and by/through other behaviors of graphics or other indices shown on the displays.

In this context, precision LARsponders such as those exemplified here can serve as “controllers” in computer games and the like. Trajectories of “aim points” and motions etc, whether controlled by individuals or collectively by groups or competing teams in the venue, can be smoothed and averaged by software to eliminate “erratic” appearance and/or small-scale position “jitter” due the unsteady aiming and/or other small-scale variations/motions along paths intended by individual LARsponders. Software processing can also be used as the basis of new forms of responses somewhat analogous to swarm, flock and fish-schooling behavior wherein responses (direction of motion, velocities, selection points etc.) inputted by individuals belonging different groups or groups are aggregated to define graphical outputs or results to achieve defined goals. Please see also Sub-sections 3c-2, 5, 7, and 8 below in this regard.

Item 1650 depicts a Jumbotron, Diamond Vision, or other large mass audience direct-view or projection digital screen. Perimeter-mounted LARcode Readers 1656 are shown. There can be a substantial number of these and they can be aimed along diverging lines of sight to cover user locations in the venue. These perimeter-mounted units are supplemented, where necessary, by an array of miniature LARcode Reader source “heads” exemplified by 1652 and 1654. The latter are positioned in front of the display (either near its surface or at distance in front of it). Light weight and measuring less than a few square inches, these can, for example, be suspended by thin guy-wires which also can carry data and power etc. They can be easily retracted for servicing etc. Their lines-of-sight look outward toward audience areas. Flash Illuminators 1658 in the LARcode Reader heads are positioned to efficiently excite retro-reflections from LARsponder RRs including those, for example, on interior surfaces and on distal closures of tubular LARsponders.

At viewing distances used for mass-audience displays such as Jumbotrons, the Reader heads will be unobtrusive if not essentially invisible. To facilitate precise and FAST Reader performance, one video field (e.g. ˜ 1/60 second or less) of a Jumbotron display can be “blanked” in the unlikely event that multi-color light originating from the display surface itself and which is coaxial with a Reader's direct LOS to a high precision LARsponder complicates or extends the time required for data analysis. Note that in smaller venues, only auxiliary Readers mounted on perimeters of venue displays should typically be required.

It can be remarked that the above concepts, methods, and apparatus which enable high precision aiming, pointing etc. are also usable in other response modes such as gesturing, association, etc.

3c-2. Response by Precision JOY-STICK methods with Electronic Feedback

FIG. 17 illustrates one version of LARsponder 1700, with several located in area 1702, offering similar functionality to that of a conventional ‘Joy-Stick”, in this instance also including two control buttons. Many other versions are possible. The principles incorporated in this example can be readily combined with or substituted by other LARcode and LARsponder concepts disclosed throughout this document.

Element 1704 can be a flat card with 2 diametrically opposite grasping points 1706 held between index fingers and thumbs of both hands. The 1708 regions, for example, can be monochrome or colored RR Locate regions. 1710 can be color-codes. Additional LARcodes, designator codes, validation codes, etc. can be displayed/adhered on the cards. 1712 can be a “signaling tab” (RR, colored, etc.) which is normally held by a hinge member in an obscured location relative to LAR-Reader sight-lines. While grasping the corners 1706, a user's middle finger can conveniently and momentarily “flick” or hold a tab such as 1714 into view by LAR-Readers thus communicating a “click” etc to the LAR-System. The 1712 tab, if exposed, can serve a different function or modify the meaning of the 1714 signal. 1716 schematically suggests one of many ways and 3D structures, also disclosed herein, that can be included in Joy-Stick type Responders to enhance LAR-System “read accuracy or for other purposes. 1701 is a top view and 1703 is a side view of 1700.

Note that the concepts disclosed above (in 3c-1) with regard to novel methods using software processing to handle new forms of group inputs representing swarm, flock, “mob” and fish-schooling response behavior are also applicable to dealing with Joy-Stick” inputs from teams or crowds.

Merely as one example, the well-known single player video game of steering competing racecars can be converted into a multiple player games. Furthermore, crowd/team (“Mob Play”) control of steering/driving of race-cars (on a Jumbotron venue or in a sports-bar or theater etc.) can use averaging and other real-time data smoothing processes etc. Joy-Stick LARsponders can signal several variables at once, steering, braking, accelerator using various basic techniques such as described above since a “tab-out” signals need not simple “clicks” and/or additional tabs, finger-mounted codes etc can be employed.

Joy-Stick control of direction of motion, steering precision, velocities, selection points etc. inputs by many individuals belonging a group can be “real-time” aggregated (e.g. dynamically-weighted centroids of command “clouds” determined etc.) to define a given graphical control output as desired by an entire group as they try to achieve a defined goal. Furthermore, the above aggregation types of processing or others can have dynamic capabilities and can apply adaptive criteria, e.g. users within a group who are shown to be “better” as the challenges, games etc. proceed can become more influential (i.e. they can become “stars” who can be later recognized/rewarded, selected for head-to-head ‘battle” etc.) as compared to poorer players in the same winning group, crowd or mob. Please also see Paragraph 8 below.

4. Response by Distortion/Deformation

LARsponders and/or associated apparatus e.g. LARcodes can include elements which can be twisted, transposed, bent, stretched, bulged, pinched, inflated, collapsed, turned inside/reverse-side out, or otherwise physically distorted to communicate a response to a LARcode Reader.

5. Response by Motion and/or Gestures

Single or multiple gestures performed with a LARsponder, including but not limited to specifically shaped trajectories or vectored “waving” patterns in space (e.g. waving up and down VS side to side). Motions can denote or indicate a desired result such as a change of 3D position of the LARsponder with respect to a defined reference point or by pointing (e.g. “over this way more”) etc. Responses can be singular, in short series, continuing, repeated until cued otherwise, or performed against fixed time-limits.

6. Response by Assembly or Dis-Assembly

LARsponders can consist of several distinct sub-assemblies which can be conjoined, assembled, or disassembled to indicate different types of responses. The sub-assemblies can include their own unique RR and code regions enabling their own independent response capabilities (or none) while apart and other or different response capabilities when assembled with one or more companions. See also the Response mechanisms described in following paragraph wherein the art disclosed therein can, as an option, be implemented using elements or entities which, themselves, constitute (or had constituted) sub-assemblies of a given type of LARsponder.

7. Response by Association, External Object Designation, or Approach Distance

A LARsponder can signal a specific or particular type of response by being manipulated and/or positioned by its user to be in a pre-defined spatial association or relationship to or with another element or entity in a venue. The “other” element or entity can be another LARcode or portion thereof or another reference entity or object as, for example, illustrated in FIG. 13. The other element or elements can be comprised of multiple objects. They can also be images on a display or displays within view of the user. “Association” can mean touching, over-laying in an image obtained by an imager, approaching or being placed closer than a prescribed margin, being pointed toward or oriented with respect to another entity or entities in 3D space as viewed by a LARcode Reader. Association or orienting can also mean (but is not limited to) the act of indicating or establishing some specific vector direction or distance with respect to an entity (as described, for example, in FIG. C2) or groups of entities or references within the venue as viewed by the LARsponder user directly or as seen in images on a display or displays within view of the user. Associations of any type can be formed or instigated on cue, can be of some defined minimum duration or spacing, and can be periodic, adjustable, repetitive, or one-time opportunities.

8. Response and Control by Collaborative Groups (“Mob Play”)

Groups of users, each user equipped with a LARsponder, can function as “teams” as described above (in 3c-1 and 3c-2) and in other parts of this Disclosure can be used to gather data expressing collective judgments or group opinions using methods and apparatus other than Joy-Stick style emulation. LARsponders of many kinds described herein can communicate a best choice among “n” choices, amounts, preferred motion, e.g. “go more to the left VS right etc., a direction, vector orientation, rotation etc. Such data can be “collectivized” by appropriate criteria and used to compete collectively for prizes, premiums, winning bids, price discounts etc. and/or playing collective video or computer games etc. In addition to traditional “order of finish” e.g. in the example of a video Auto race mentioned in Paragraph 3C-2, spatial or timing coherence/precision within the user teams such as group accuracy of choices or quantitative timing speed, precision against external cues. Best group match to an “expert” answer (e.g. “the population of Toledo is xxxxx”, or to video, audio, music, live cheerleader cues hints etc., can be scored and used to handicap, set odds and rankings, decide winners etc. in many types of events and under many types of stimuli. These can include Mob Play versions of well-known and successful game shows such as “Jeopardy” and “Wheel of Fortune”.

9. Response by Change of Optical Properties

Response mechanisms can use various types of changes of optical properties of LARsponder regions visible to a LARcode Reader. Rather than obscuration, as described above, these mechanisms can, for example, alter the spectrum reflected from a single color element or sub-element by means of movable transparent or semi-transparent colored overlay filter masks or vice-versa, Polarizing and/or optical gratings, transparent retro-reflector layers, cylindrical or other lens arrays, temperature-sensitive liquid crystal filters etc. can be similarly employed.

LARsponders can use pressure variations on a fluid-filled reservoir bulb connected to one or more transparent chambers, arrays of channels, or tubes etc. which are positioned to obscure or partially obscure a LARcode element or elements when fluid is forced into the chamber or chambers. The user can signal off-on (binary) or analog proportional data depending on the detailed design. A clamp or similar component can be used to hold the loaded fluid in place until data are read out by LARcode Readers. The obscuring fluid can then be re-set to “clear” by any suitable mechanism such as compression of the occulting chambers or, preferably, compressing an “Erase” bulb which forces the fluid back into the original reservoir.

10. Response using ACTIVE LARcodes

Section B.13.6 of PART B briefly discusses Active LARcodes which employ on-board powered light or color modulated sources to convey data. Here it is noted that these can specifically include but nor limited to LEDs, multicolor LED assemblies, OLEDS, OLED arrays, electrochromic elements, and/or back-lit transmission color LCDs. These can be used in LARcodes, and/or can be in part or in all elements of ACTIVE LARsponders. They enable response methods via any types of modulation of the light signals being emitted or reflected by the LARsponder from one or more of its component elements. Modulation types can include simple on-off, digital or analog data encoding etc. The LARsponder user control interface can be of any convenient type known in the Art. Data communicated by the LARsponder via active and/or actively controlled light sources can be in addition to other data conveyed by reflected RR or other reflected light visible to LARcode Readers.

11. Response via LARsponders linked to Smartphone or Mobile Internet Devices (MIDs)

A LARsponder user's Smartphone or other device can possess orientation-sensing (e.g. with respect to the earth's magnetic field dip angle or magnetic North) and can be capable of angular display thereof. It can have capabilities for precise directional motion measurement e.g. using 3D MEMs accelerometers, GPS, enhanced GPS etc. In such instances, these assets can provide additional data or complimentary channels of response. Various types of LARsponders and/or LARcodes can be mounted directly on Smartphones or MIDs or otherwise associated with them in non-interfering ways such that LARcode Readers can access them. (See, for example, PART A, item 48 of FIG. 4). The referenced Figure shows a LARcode which can confer acceptability (event-specific or otherwise) to an MID or other networked device as a data source. Various forms of LARsponders can be similarly associated and used to validate such data sources.

12. Response without LARsponders using Smartphones or Mobile Internet Devices

Sub-groups or individuals within or outside of a venue who are without LARsponders but who are equipped with Smartphones, tablet PCs and/or other MIDs can be allowed to participate via appropriate Application software installed in the device. Pre-qualification, device registration (event specific or otherwise), or other evidence such as transmission of a validated LARcode authorization sticker number etc. can be required to participate in the “action”. Such qualification and subsequent participation can also be based on transmitting, relaying or annotating etc. images captured by the phone or other MID, or by responses by voice, by keyboard entry, by display-touch or the like. Images can be of a portion of transmitted video coverage of venue activities, or of an AD running during such coverage. Images can be of in-venue or other data added by third parties, and/or of local commercial displays, signage, or views of certain types of LARsponders validly belonging to others. The venue LAR-System can allow “extra-venue” participants to ‘team” with in-venue participants. Extra-venue participants may experience significant system delays, but can be granted “head-starts” or re-ordering of response times. Conversely, they can be assigned lower priorities and/or they can be offered differing “award opportunities” such as smaller or larger prizes etc. as compared to in-venue users of validated LARsponders.

13. Remote Response Via Privately-Owned LARcode Readers

Users of privately-owned LARcode Readers can arrange to use their private devices to input LARsponder data via WIFI, 3G or 4G etc. network systems to interact with distant venues employing LARcode Readers and Systems. Such Readers can be either Type I or Type II but more typically will be Type I. (See PART A of this document). Venue-defined registration and authorization etc. can be required along with downloading of enabling Application software or use of specialized websites via standard web-browser applications. Such off-venue authorization can be for one-event, season long etc. The Application download or specialized website can be tuned to working with one particular LARsponder type used in the venue or can accommodate a number of configurations. The requisite LARsponders for a given event or events can be made available to prospective users by purchase or as premiums or prizes, as retail outlet “give-aways”, as newspaper inserts or direct mail pieces and/or by any other promotional channel.

The user-owned LARcode Reader can display cues and other data originating from the venue system. It can directly view a local LARsponder in the user's possession as it is being manipulated according to activities occurring in the venue and which are transmitted from it to off-site displays (e.g. video feeds etc.) available to the private LARsponder user. Note that this method allows for many types of remote interactions which can be varied by features of inexpensive or free LARsponders and are not hardware or provider-bound to one particular type of ISP, cellular phone service, imager type, Smartphone model, etc.

14. Remote Response via Accessorized Webcams as LARcode Readers

Off-venue users having Webcam-equipped PCs or other computers with accessory PLCM and IM functionality as mentioned in PART A can participate/compete (using suitable installed software applications or using specialized websites via standard web-browsers) in in-venue events. Participation can be via one or more validated LARsponders pre-supplied and registered by various means as described elsewhere herein. These LARsponders are viewed and manipulated by the user's Webcam(s).

Qualified off-venue LARsponders can offer all or only subsets of the response capabilities required by the “action” within the venue itself. Note that these capabilities can be uniquely customized to different audience segments, to the event or product promotion, to the large-screen ad being featured on the home as well as on the venue screens etc.

15. Enhanced Response via Previously Collected Images and Codes

LARsponder users can employ camera-equipped smartphones, PCs and/or other computers, digital cameras or similar devices with wireless communications capabilities to capture certain images or portions of images prior to the user making use of a LARsponder. The subjects captured in the image or images can be of (or portions of) physical objects, print graphics such as magazine/newspaper/catalog etc. advertisements etc., electronic images in any form including but not limited to video programming, internet Ads, electronic or simple printed billboards/signage etc. The captured images can be images of any form of visible graphical data-code such as bar-codes and or other standard formats as well as LARcodes. Specific subjects of interest in the images (and their relative “value”} can be selected and defined in accordance with pre-defined criteria. e.g. a “Scavenger-hunt” style set of assignments. This can incentivize a user to take closer note of existing ads, products etc. An in-venue or remote participant's collection of such images can be submitted to a LAR-System supporting a given in-venue event or other happening to gain some competitive or reward advantage re participation in the event or activity.

### C.04 Examples of 3-Dimensional LARsponders and LARcode Components

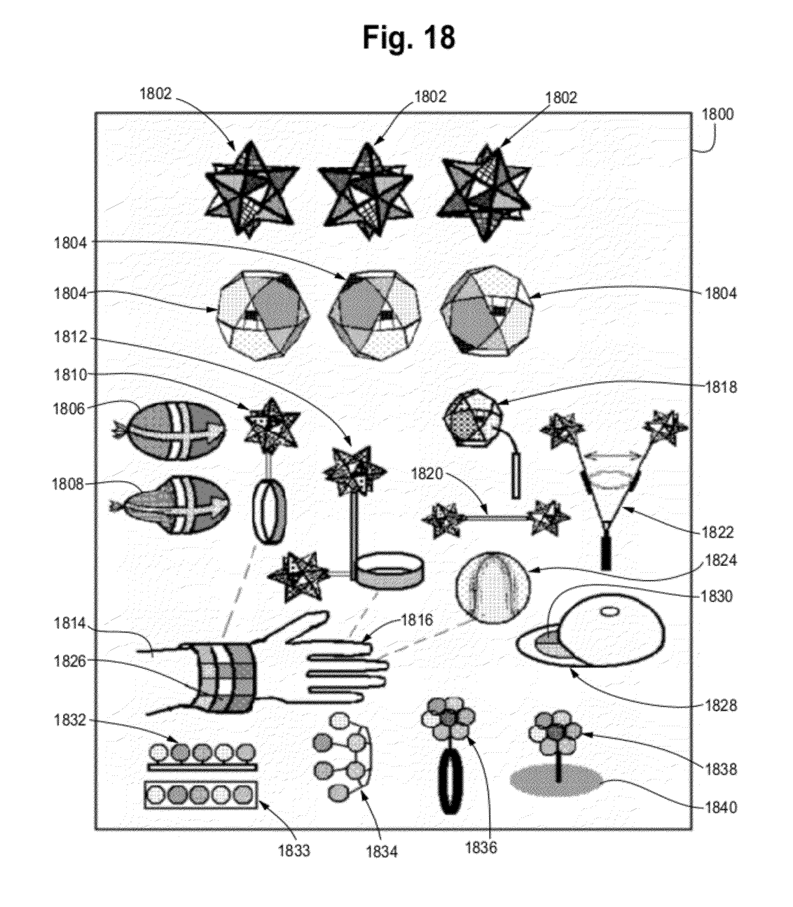

While many of the LARsponder/LARcode examples presented above use primarily “flat” forms and components, it is not intended that any of the concepts, methods and/or apparatus being disclosed are constrained or limited in this regard. FIG. 18 presents a few out of a plethora of other 3-D forms/components which can be used to advantage across a wide spectrum of LARcode/LARsponder applications. These are merely particular examples of LARsponder/LARcode elements (e.g., spheres, disks, open or closed cylinders, skeleton open, partially closed or closed polyhedrons etc.) some of which have already been described more broadly in PART B.13.3 of this disclosure.

The two types of 3-D polyhedra 1802 (a stellated dodecahedron) and 1804 (an icosidodecahedron) shown in FIG. 18 represent merely two members of huge groups and classes of geometrically-defined entities, useful as coding and/or LOCATE components. Members of these classes of forms, which often are complexly faceted, can be color-coded to create LARcodes and/or LARsponders. Some or all facets and/or surfaces can be both colored and retro-reflective. In images obtained by a given LARcode Reader with a particular LOS, facet region shapes and colors of a given type of polyhedron will vary substantially with orientation as suggested by 3-D polyhedras 1802 and 1804 that are located in area 1800. In particular, stellated forms can show very pronounced color, facet appearance, and/or partial occultation of facets produced by only small “solid body” rotational changes around one or more of its internal axes and/or with respect to a given LARcode Reader's LOS. Of the many other possible forms, the Hexahemioctacron can be noted as being representative of “spike-covered” entities. Each “spike” of such a 3-D body, for example, can function as, e.g., a tubular open or close-end sub-structural element as mentioned with regard to FIG. 16.

The size of any 3-D LARsponder or LARcode element can, of course, range widely depending upon the application ranging from small fractions of an inch to several feet and beyond. A given form of 3-D element need not be employed only as a whole. It can be sliced, split, sectioned, segmented etc. For example, an icosidodecahedron 1804 can be split along an equator plane and conveniently mounted as a faceted hemisphere on a flat area of a LARsponder which also can carry planar code and/or RR regions.

Other topologically distinct classes also have useful properties such as LARcodes/LARsponders based upon color-coded and RR regions in such forms of trefoils or multiple interlocking non-coplanar rings etc. These forms facilitate precise determination of 6-D orientation/position data based upon their symmetries and imaged ratios of major dimensions (i.e. ring diameter) to minor “strand” diameter.

The remaining items in FIG. 18 are intended to show a few other aspects and uses of 3-D LARsponder design elements. 1806 and 1808 are representative of un-faceted forms in general and also of forms amenable to being flexible, inflatable, and deformable. Items 1810 and 1812 portray 3-D LARsponder components mountable singly or on multiples on limbs, e.g. 1814, fingers 1816, or on accessory devices such as exercise appliances, etc. Items 1818, 1820 and 1822 are examples of hand-held 6 degree of freedom LARsponders with 1822 also illustrating a seventh degree of freedom (variable separation between two components) which can be used for analog control/data input or for “clicking/selecting”.

Item 1824 represents a LARsponder in the form of a “ball”, e.g. a baseball, with differently color-coded (and optionally retro-reflective) re-entrant regions and RR regions along its cover seams. The ball can be padded and soft and can be internally weighted to a degree limited by appropriate safety considerations in home, playground, and/or school gymnasiums. In use, the ball can be held and its pitch/release merely simulated and tracked for spin, velocity, plane of motion etc. with computer calculated idealized release timing. Alternatively, it actually can be released toward a passive “trapping” structure and its point of crossing a strike zone or its closest approach to some other type of target calculated including a theoretical scaled effect of any spin actually imparted by the user etc. Other versions of simulated baseball pitching could allow actual release and recovery. Larger LARsponders of this class can be used to simulate bowling, football passing etc. including spin imparted upon release.

Item 1826 is a generalized illustration of a LARcode/LARsponder exemplifying the use of multiple copies of a single code (in this case angularly displaced from each other) with the intent of enabling one or several LARcode Readers on different Lines of Sight to combine their image data so as to achieve a reliable code “read” despite momentary or partial occultation of some of the multiple codes. Note that 3-D LARsponder element(s), such as stellated dodecahedron found on 1810, can also be worn on appendage 1824, and can also be part of duplicate/multiple codes on LARsponder 1826.

Item 1828 is a typical “baseball cap” to which LARcode elements have been added thereby converting it into a LARsponder. In this example, the Cap is shown with an approximately planar (2-D) LARcode 1830 on its visor and might be used as illustrated with respect to item 1514 in FIG. 15 (it invites responding by being worn on the user's head with its visor “jauntily” pointing forward, back, left, or right.) Adding more coded elements to the cap's outer surface and/or interior enables numerous forms of 3D LARsponder functionality. LARsponder 1830, although based as it is on a “baseball cap”, is meant to be representative of the novel and much more general concept of converting almost any 2-D or 3-D “article of commerce” into a LARsponder.

LARsponders 1832 through 1838 portray code designs such as combinations/assemblages of colored and/or retro-reflective 3D shapes such as spheres as already mentioned with respect to 1650 of FIG. 16. These are examples of relatively “self-occultation” resistant assemblies in that at least portions of each code and/or locate element can be seen by LAR-Readers using different lines of sight to view the codes even over a relatively wide range of LARsponder or LARcode spatial orientations. 1832 and 1833 show the code as it appears to two imagers one viewing from above and the other from the side view. An increased degree of “self-occultation” resistance can also be achieved using thin minimally obstructing support “pins” as in 1834. This general type of LARcode structure can, in turn, be mounted on a thin rod etc to move it away from any other component of the LARsponder with which it is associated. 1836 illustrates this in the form of a finger-mounted LARsponder using close-packed color and/or RR spheres (white or colored) as coding elements. 1838 illustrates such an assembly off-set mounted of a pad 1840 which can be adhesive-backed or otherwise affixed to body parts, objects, structures or other item of interest to create LARsponders enabling LAR-Readers to provide data to a LAR-System regarding the LARsponder's identity, location, and movement in 3D space as well as its orientation with respect to its own “internal” coordinate axes. This is in contrast to, for example, data provided by typical motion capture technology.

### C.05 LARsponders Based Upon Articles of Commerce

Suitable “Articles of Commerce” objects or portions thereof as herein defined are intended to include any type or item of clothing or any accessories such as the cap 1828 and/or hats, shoes, gloves, purses, pins, jewelry, scarves, finger rings, hand-held banners, souvenirs, fan-loyalty and “novelty” items, signs, eyeglasses, masks, sports equipment, athletic shoes, helmets, gloves, clothes, sweatshirts, jackets, accessories, memorabilia, and similar accoutrements as well as other property such as Event Programs, books etc.

LARsponders or portions thereof can be based upon objects, positioned on objects or tethered thereto. They can include LARcode components positioned on containing, enveloping, bag-like, or wrapped elements or containers such as bottles, beverage cartons, Tetra-Paks and others.

LARcodes and other elements as previously described can also be affixed to or associated with “non-passive” communication devices cellphones, smartphones, eBooks, iPods, mobile/portable computers, portable radios, and similar devices (whether actively network-connected or not) enabling them to function as LARsponders with enhanced capabilities such as GPS, built-in compasses etc. These combined entities can be manipulated as LARsponders as in Section C.3 and/or for other purposes such as indicating inclusion in a group comprised of geographically closely co-located members.

Personal items such as credentials, ID cards, badges etc. can be adapted to serve as LARsponders. Note that data relevant to the validity of these types of items can become readable and verifiable at substantial distances when the item bears or is modified by the addition of suitable LARcode elements.

Illustrative examples of some of the above concepts are provided below in the context of methods and apparatus related to activation, validation, and/or affiliation of LARsponders.

C.06 Activation, validation and affiliation of LARsponders/LARcodes

Most of the Response apparatus, modes of use and manipulation described in this document can also be used as preliminary or initial activation procedures. Activation or validation, after being accomplished, can be “permanent” or “perishable” and/or can be withdrawn if further performance requirements or other conditions are not met.

Appropriate requirements can be built into LARcode System software causing it to openly accept and evaluate initial-response activation attempts by a LARsponder user such as gesture sequences captured in a series of frames by a LARcode Readers or responses via a series of “sign-in” choices performed in some designated manner etc.

Other forms of activation or validation can use physical emplacement or positioning of “activators” with respect to other entities whose images can be captured by LARcode Readers.

Activation or validation procedures can be designed as team-joining actions, can be built around product purchases, can cause a LAR-System to provide information or take other actions, and/or include incentives such as enhanced prize-award chances etc. several versions of which will be described further below.

LARsponders can be constructed to be operating or decorative parts of objects. They can be configured so that they are not deemed (by LARcode Readers and supporting Data Systems and software) to be “Activated” or “Valid” (or are interpreted by the System in some alternative way) unless certain conditions are met. One such a condition can involve affixing an additional component (or several) in pre-defined or quantifiable “designator” in a “coupled” relationship (e.g. within a required relative distance and/or in an approximate pose etc.) with respect to another specific or reference element of the LARsponder. Such Reference elements can be products, product labels, or other graphic or object components(s) or other entities with which LARcodes or components thereof can be associated.

“Additional components” can be 2-D or 3-D items and supplied in separately-packaged or purchased form. Designators can also take the form, for example, of “peel-able” adherent label-like entities which carry one or more RR Locate regions. Designators, as well as Reference elements, can display corporate logos, labels, or other graphics and can carry additional color codes and/or color retro-reflective regions.

Establishing a LARsponder's “Affiliation” closely resembles validating and/or activating methods and procedures except that it is an option which LARsponder users can choose to invoke to “join” other users as team-members or groups with some pre-defined interest or characteristic in common. Affiliation is not necessarily mandatory to qualify a LARsponder as usable.

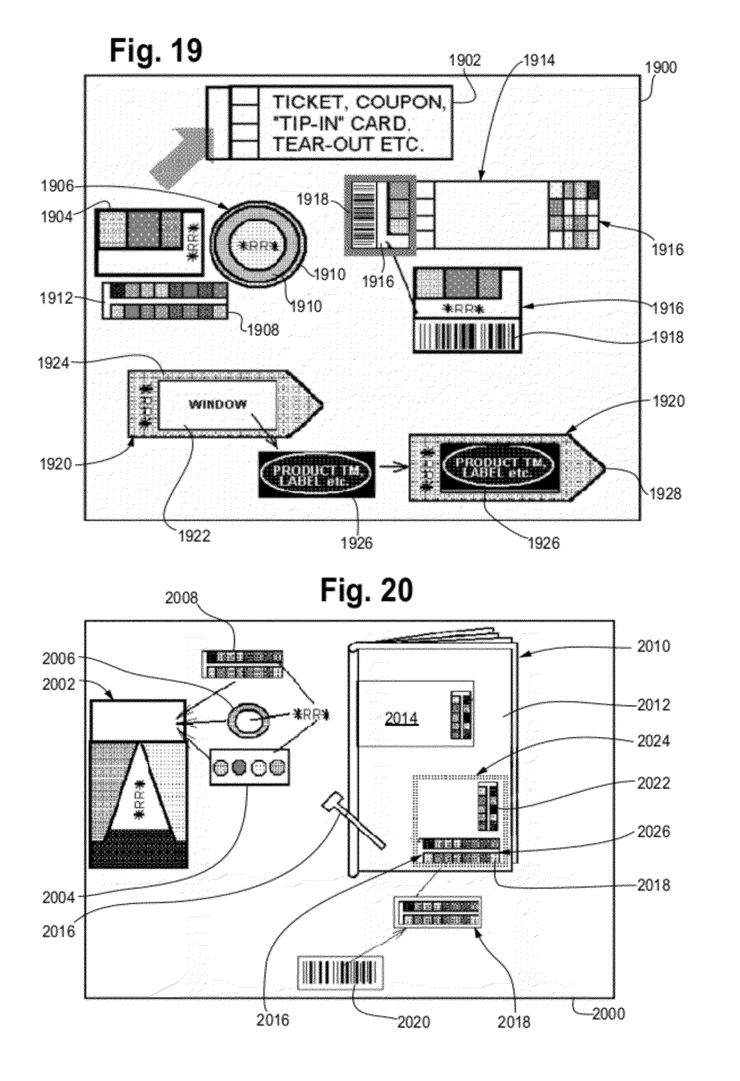

FIG. 19 presents a few examples of Activation of LARsponders in the form of various 2-D entities such as Event tickets or other paper items located in area 1900. 1902 is an Event admission ticket or a coupon, “tip-in” card, tear-out, etc. A sticker (1904, 1906 and 1908 are a few examples) obtained by purchase, hand-out, or otherwise, is adhered to the ticker by its user thereby converting the ticket into a LARsponder. The disk-like sticker 1906 can merely enable LARcode Readers to perform a LOCATE function and such gestures as “waving” or, if not displayed, then “no comment”. The color-coded rings 1910 can identify a particular event or dictate the software the LARcode System should use when “reading” this type of LARcode. The other two examples 1904 and 1908 enable orientation responses in addition to those enables by the disk-type, and a much-expanded universe of codes.

The “T” RR version 1912 in 1908 is merely one example of an available data space which is large enough to portray pre-printed volunteered, opt-in data about the user while capturing each response and location of each specific individual responder even in a large venue. The ticket 1914 can contain LARcode data upon which personal challenges can be based to insure that a user is precisely who he/she purports to be such as: “Wave your LARsponder vertically when your birthday month comes up on the Jumbotron count-down screen.” The LARcode 1916 with BARcode 1918 adhered on the Ticket 1914 might have been purchased for some “high-stakes” competition or drawing and can also be read to detect counterfeits and/or verify validity/credit-worthiness of a user at the entrance into the venue. RFID tags in a LARcode (e.g in a sticker, such as card 1916 including a magnetic stripe and/or other features such as RFID) along with appropriate detectors can also be similarly employed for verification purposes and counterfeit detection. 1920 is a simple Designator or Activator in the form of some specific color or patterned RR component 1924 which enables simple “LOCATE and read” function software. The “window” 1922 can also direct a LARcode Reader to assess some aspect of the colors or other features/elements 1926 framed by the window 1922 or located near the tip 1928 of the RR arrow 1920.

FIG. 20 depicts an area 2000 containing a number of LARcodes and illustrates Activation or Validation of a simple 2-D “Four choice” LARsponder 2002 by manually applying one (or more) LARcode or other elements 2004, 2006 and 2008 which can, for example, be supplied to or acquired by a user.

Item 2010 is a generic representation of a document such as an event program, brochure, magazine, catalog, book, or the like. The Cover or some page 2012 or a “tip-in card” 2014 can carry a pre-printed LARcode 2022 or codes. These codes can or cannot be complete (in the sense of being only the non-retro-reflective graphics portion of the LARcode) depending upon the preferences of the provider of the document. A code without RR elements 2018 can be activated by user placement of a separate user applied adhesive-backed RR sticker, such as 2016. Activation/validation stickers can be of any form and/or type discussed herein and can be handed out, awarded, purchased, or mailed etc. to the prospective user. LARcodes such as 2018 can also be separately and similarly supplied to a prospective user and can be fully assembled or require some user assembly such as placing RR element sticker 2016 on LARcode sticker 2018 and then affixing the whole to document 2010. As one example of protection against counterfeiting or unauthorized use, a BAR code 2020 etc can be scanned (for example, when Sticker 2018 is purchased) which IDs legitimate purchase/possession of the sticker etc. and also can register the LARcode/LARsponder to which it is properly applicable. Additionally, optional “peel-offs” overlays, “scratch-offs”, etc. can be used to reveal or verify the code.

Note that the addition of a fully-assembled LARcode 2026 (positioned as shown) and interpreted as coupled to pre-printed Code 2022 (forming coupled LARcodes 2024) by the System software designated by code content (which can or cannot also be a complete LARcode) becomes a validated/activated orientation-type LARsponder. The LARsponder thus completed can also be validated and granted additional response capabilities such as selecting among various other graphics or Ads (which can be merely traditionally printed on the page. Such added response mechanisms can include (but are not limited to) obscuration and/or the methods discussed with reference to FIG. 17 etc.

FIG. 21 shows a few suggestive examples of 3-D articles of commerce (located within area 2100) such as can be used by audiences in event venues such as sports arenas and stadiums, music festivals and concerts, political rallies, block parties etc.

Item 2102 is a group of 3 RR adherent strips of different colors. The number of strips, their shapes and/or colors is merely illustrative and many types/patterns either RR or otherwise as disclosed herein can be used.

Items 2104 show beer bottles converted by its purchaser to a three choice LARsponder by affixing an RR strip 2106 supplied with the bottle to it. The “posed” orientation responses are: 45 degree tilt left, vertical, and a 45 degree tilt right with the RR strip approximately facing some LARcode Reader LOS as shown. These can be posed upon a cue from venue audio or, as shown, on venue visual displays—“19 seconds”. If the bottle in nearly empty or closed, more choices can be handled including right horizontal etc.

In addition to collecting mass anonymous opinions of venue attendees, LARcode Readers of these types of LARsponders can record specific user locations within a venue. Video cameras can zoom in on randomly selected “winners” from among those who chose the correct, most popular, most accurate “next play” predictive response etc. Actual awards can be presented by ushers or roaming (in this example, beer) vendors.

Other methods and apparatus for converting bottles into LARsponders are shown in 2108, 2110, 2112, 2114, and 2116. Respectively, 2108 illustrates LARcode and RR components as adherent or elastic bands, 2110 shows code components having larger data capacity, 2112 and 2114 show coupled “tag-type” personalized components that can be re-usable from event to event, 2116 portrays LARsponders with substantial data capacity and 6-degree-of-freedom response capability.

A Note about Spatially Repetitive Codes

LARsponders and/or their associated code elements can appear on a given object in multiple repeated locations. If, for example, a rotation or orientation with respect to a given LAR-Reader's LOS presents only partial data to a given LAR-Reader, other partial views of data and/or multiple images of the same LARsponder can be captured by other LAR-Readers. These can enable the LAR-Data Server system to make a correct determination of the LARsponder's ID and its user's intended response.

Bottles have been used above merely as representative of drink container-type articles of commerce. Many venues such as stadiums only permit paper-cups or other disposables. Items 2118 through 2122 illustrate use of paper-cup folded paper handles with LARcodes (2119, 2121, 2123) allowing degree of handle rotation about a vertical axis to be interpreted as designating choices along with various auxiliary data.

Items 2124 through 2132 show the previously explained examples and concepts applied to paper-cups with LARcode components. 2124 is a cup assembled into a LARsponder with a RR LARcode 2130 adhered by the user and pre-printed with RRs 2130 and/or assembled with RRs by the user. 2126 can be pre-printed without RRs for an event or product to which a user can add an assembled LARcode 2130 or, e.g., an RR product logo 2132 valid for a special survey etc. 2128 is intended to emphasize that these concepts apply to non-circular cross-section drink containers (juice cartons, Tetra-Paks etc.) which can be equipped with code components to enabling them to convey an expanded variety of orientation and pointing responses because of their “facets”, vertices etc.

In all of the above, it is to be understood that use of the specific articles of commerce chosen as examples is not intended to imply as any restriction on the types of basic or elaborate articles of commerce which can be similarly converted to LARsponders.

(NOTE: The above “activation etc.” examples using containers of “consumables” (or similar concepts with other types of articles of commerce) illustrate possible marketing tactics such as incorporating incentives to purchase “another” prior to an impending response-cue or during a count-down to a prize offering. Another form of this type of incentive can be based upon “aging” or invalidating the earlier types of RRs etc. needed to form active LARsponders as time passes.

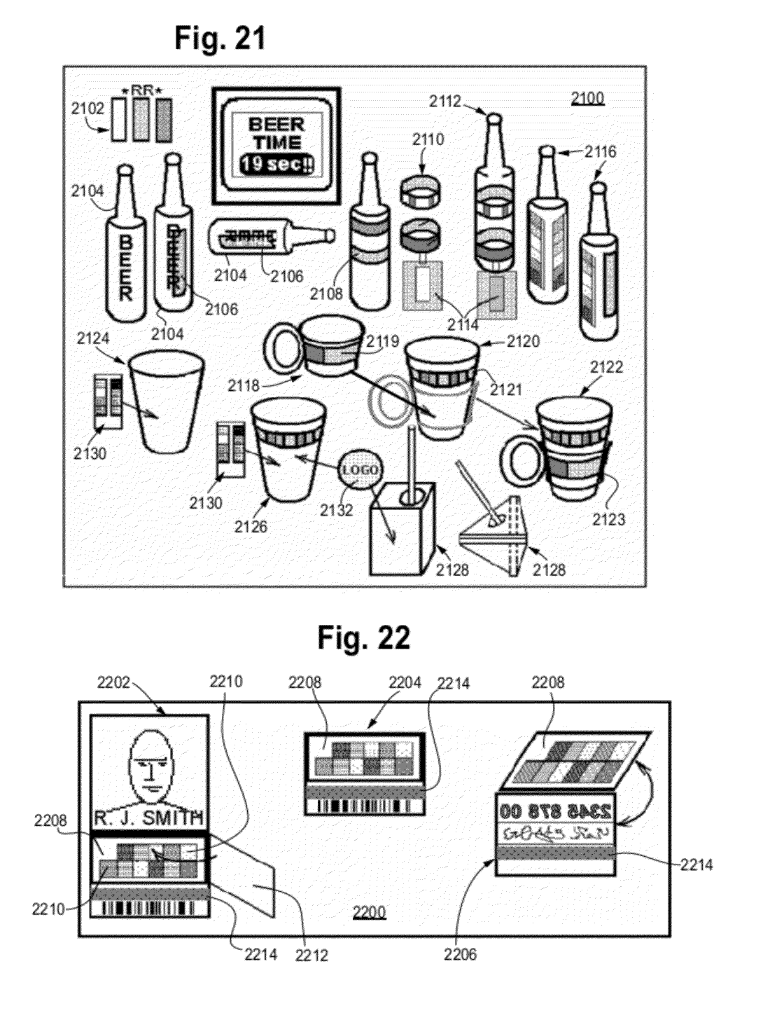

FIG. 22 illustrates examples of how activation, validation and/or associative LARsponder methods and apparatus, located in an area 2200, also lend themselves to applications involving user ID for purposes such as conducting financial transactions, purchase commitments etc. Credentials 2202, 2204, and 2206, such as badges or credit cards with physically associated/coupled LARcodes and/or LARcodeNESTS can be used, for example, in “reveal” response mode. They can also support additional or supplemental response requirements/challenges such as (but not limited to) validation by using gesture sequences and/or signatures “signed” in mid-air etc. Gesture-requirements can be altered frequently (e.g. in military operations) and only authorized users informed of the “gesture of the day” etc. Please see also Section C.13.

FIG. 22 illustrates a few examples of LARsponders in combination with more traditional types of ID, specifically 2202 is an access badge, 2204 is a wallet credential with “click” capability by orientation sequence etc. (such as by sliding it out of an obscuring envelope, etc.) and 2206 is a Credit Card, ID, Pass, etc. whose coupled LARcode (or LARcodeNEST) can be verified as genuine prior to use in a given venue by a magnetic card reader coordinating with a LARcode Reader's data. RR frames 2208 can be provided on any of credentials 2202, 2204, and 2206. Access badge 2202 can include a number of defined-location occulation blocks(s) 2210 to indicate a “click” when something, such as foldable flap 2212, is opened from the closed position. Opening flap 2212 can also be used to allow a “read” of occulation blocks 2210. LARsponder, such as in the form of Credit card 2206, can be pre-verified by magnetic strip 2214 located on the credential.

The general types of LARsponders shown and similar ones can also allow pre-validated verification/confirmation and/or acceptance of bids, purchases, bets etc. without requiring prior or follow-up close physical approach to some type of pay-clerk or system interface as is usually necessary when using cash or charge-card payments based upon magnetic-stripe BARcode “slot” scanning or conventional RFID “near-proximity” chip reader technology. (See also Section D.05.4 ACTIVE ACKNOWLEDGEMENT OF LARsponder INPUT.)

### C.07 LARsponders As Tools for Focus Group or Mass Opinion/Product Testing

Since many of the types and methods already disclosed can be used to communicate individual preferences as selected from among multiple choices and/or estimated qualitative or quantitative responses from small groups or from mass audiences, it is evident that LARsponders in general can offer substantial utility for opinion collection and surveys.

In this section, a particular category of LARsponder Apparatus which can utilize various types of packaging components to conduct product and/or taste-testing in venues ranging from stadiums to food markets or other Point-of Purchase localities equipped (permanently or temporarily) with LARcode Readers. This type of LARsponder can feature one or more “sampler” compartments (e.g. plastic envelope/panels or channels etc). These can overlie LARsponder/LARcode RRs or color Blocks. A given compartment can be associated with a proximal first LARcode which can be read by a LARcode Reader. Each compartment can be pre-filled with a sample of a liquid or semi-liquid product—e.g. a lotion, or contain an edible sample of some sort such as granular material, a tablet, a cookie etc. Several sampler compartments can be grouped in a single structure.

When a sample is extracted from a compartment (identified, for example, by its location with respect to its proximal LARcode or by other spatial reference), and tasted (or otherwise evaluated), the process of extraction can reveal a second LARcode element or other discernible evidence establishing that the user opened that particular LARsponder sample compartment. This change in a feature visible in subsequently-obtained LARcode Reader images is one method of activating/allowing the participant in the survey or test to communicate an opinion or rating. The participant's specific “rating” of that sample can be communicated by, for instance, obscuring a color area or in other ways afforded by response features built into the primary LARsponder “sampler” structure or by using a companion LARsponder with appropriate capabilities supplied to members of opinion/taste-test panelists.

The timing and location for valid tests of a given type of sample can be “start-stop controlled” by cues to the user/users. Participants can be incentivized to participate by offers of prizes, discounts etc. Note that the exact location (e.g. stadium seat number) of a given user can be captured by the LARcode System if desired.

In certain types of venues, such as food markets, the sampling/survey LARsponders can be passed out separately to potential users or can be removably attached to an allied or co-marketed product being purchased by users.

### C.08 LARsponders in Multiple Simultaneous Venue Activities

Different simultaneous programming/challenges on different screens or in different places in the same venue can be enabled and accommodated by LARsponders. LARsponders can specify a specific screen within a venue or the type of challenge the user wishes to confront.

For example, occultation of a specific code Block or while using a LARsponder with its LARcode held vertically can pick a different screen and/or challenge than one held horizontally. There are numerous other possible techniques which can be used to similar purpose. Without implying any limitations with regard to such possibilities, a few examples are sketched below:

1) Deliberately occulting one or several code Blocks on the user's LARsponder Responder to elect to choose challenges in quadrant “A” (rather than others in quadrants B,C, or D) on a giant screen or

2) To be eligible to vote for the best next play from among those listed in yellow on the perimeter digital signage, hold any validated “Sam's Best Beer” paper-cup up high with its yellow stripe facing toward one of the portable flag-marked LARcode Reader carriers now on the sidelines nearest you or

3) To win $YYY in the next XX seconds, identify the singer now playing on one (or MORE of) such sources as web-radio Channel QQQ, video channel VVV, Smartphone app “GG” or on YouTube, Face-Book, or other social networking site etc. etc., then, use your “tip-in” LARsponder card to correctly choose and communicate one of the towns (as labeled A thru G shown somewhere in the Sam Beer Ads on Pages 7 or 8 in your Event Program) which is his/her birthplace.

LARsponders (which can or may not be “perishable” (for example, “useable only until 5 PM EST”) can be “opted-in” by various procedures to access special features. These can include (but are not limited to) audio entry or key-entry of short codes or imaging the actual LARsponder/LARsponder using a user's network-connected Smartphone, Cell-phone, Net-Book, Tablet computer, etc. and then transmitting the image to the local LARcode support system or elsewhere. GPS also can confirm and register presence (potentially to high spatial precision if enhanced GPS is used) in a venue. Performing an opt-in and/or other particular LARsponder responses can be used to trigger delivery of, e.g., a text (plus Ads, marketing materials etc. from the local support system from another source). Incentives to obtain the delivered materials can be various, free offers etc. They can also assist the user in correctly meeting subsequent challenges as presented by the venue displays etc. Such incentive-driven and similar procedures can also provide valuable demographic data for subsequent targeted uses.

### C.09 Methods of Audience Segmentation/Group-Forming Etc.—a Few Examples

Using LARcodes with an adequate universe of possible codes, each LARsponder used in a venue can obviously be individually ID'd (although its user can remain anonymous). LARsponder users can individually opt-into groups as/if they wish.

Multiple organized spectator TEAMS (made up of persons known to each other or seated nearby or GROUPS (female “fans” anywhere in the venue who are from St Louis) and wishing to play by coordinating their responses during a venue event can be defined by various criteria and registered with the LARcode Reader System. Event team formation my also be coordinated using any type of Social Networking Application for Smartphones etc. with the necessary data defining the team thus formed can then provided to the LAR-Data System via mobile network(s).

Teams can be defined by Physical Blocks of seats, e.g. Section D, rows 1-12 or determined by all players within less than X distance from a particular venue Reference Marker which is visually labeled for the benefit of users, (e.g. “BLUE 27” etc.) and also precision-located/recorded in the LARcode Reader data-base).

One block of seats can be playing against a different challenge than another block of seats. LARcodes can be provided that are TEAM-loyal or GROUP loyal or both.

By simple proximity, geometric criteria (i.e., same row of seats, same “box”, same area of the lawn at a concert, etc.) or other data available to the LAR-Data System about particular LARsponders and their specific users, the LAR-Data System can propose an “opt-in” or “association” with another or multiple other LARsponders for “scoring”, reward sharing, or other purposes. Such proposals can be posted on video signage or audio announcements, cell phone messages etc. Acceptance or rejection of such associations can be communicated using e.g., LARsponder gesture responses by the respective LARsponders involved or can be transmitted to users via their Smartphones etc.

Note that any LAR-Data System serving the principal venue where an event is taking place can also be connected to and serve other “outlying” venues where video coverage of the event is being presented. If outlying venues are also equipped with LARcode Readers, their occupants can use their own LARsponders (with or without associated communications devices) to also participate “Live” in LARsponder-based activities occurring in the main event site.

### C.10 Remarks on LARsponder/LARcode Manufacturing Methods, Costs and “Participative ASSEMBLY”

Almost any physical object, mechanism, structure, component part, living thing or anatomical appendage thereof, any article of commerce, any product of the graphic or decorative arts can carry LARcode data and if appropriately designed and constructed can serve as a basis for a LARsponder which can offer novel and useful functionality.

Versions of LARcodes and LARsponders can be essentially 2-D flat entities or, as previously described, can be or include 3-D elements of simple or quite complex forms. Depending upon their detailed design features, especially the latter can be manufactured using very wide spectrum of methods as discussed previously in PART B, Section B.08.

It is impossible to exhaustively limit or pre-determine all LARcode and/or LARsponder production methods. The present remarks seek only to briefly describe the spirit and intent of a few unique concepts/procedures largely relevant but not limited to LARcode or LARsponder components fabricated from planar or sheet-like materials. Candidate materials include paper, cardboard, laminates, polymer sheet, matted, perforated, textured, or woven fabrics, leather, leather-like and other synthetic materials, metals, glass or any others which can be rendered“receptive” by treatment or coating. Procedures can include any of those known in the graphics arts and the various processes and arts employed in the container and packaging industries.

Color-coded or other visually-patterned LARcode regions or components which need not be retro-reflective or possess special optical properties can be created by any appropriate graphics arts method. These include markers and plotters, stamping, ink-jet or laser printing, etch-and-fill or large scale graphic-arts production methods as used for newspapers, Ad-inserts, magazines, etc. Because these classes of components involve no special materials or technologies they can be expected to be quite inexpensive to produce.

Label and container printing methods as practiced on metal cans or foils (including embossed, diffractive, reflective, partially-coated or under-coated sheet material etc. and the application of transparent colored inks) can also be employed at somewhat increased cost.

Screen-printing methods for higher performance RR regions can use pigments in combination with sub-millimeter retro-reflective bodies, e.g. transparent spherical beads, micro-corner cubes, or under-lays/over-lays with reflective embossing. as exemplified by products offered by 3M Corporation and others.

Simple retro-reflective RR LOCATE regions on LARcodes can be produced by applying shapes which have been pre-cut from various stock colors of adhesive-backed RR tapes and sheets. Some types of more complex, e.g. multi-color and/or “mosaic” RR regions can be made by assembling transparent films carrying color patterns printed in transparent inks over a base of commercial “white” (optionally adhesive) RR sheet or tape. Certain types of RRs can entail pre-fabrication of custom-made base sheets/tapes comprised of RR materials with more than one type of RR sub-structure each with different optical parameters (as disclosed in B.08).

Sheets of material coated/impregnated with special fluorescent or phosphorescent substances which can be used as LOCATE regions on LARcodes (as discussed elsewhere herein) can be handled in a similar way.

Automated production of complete fully assembled individual LARcodes and/or LARsponders which include such “special” regions can require some task-specific custom-designed adaptation of production machinery or process. This implies a cost burden, which especially for short-runs, can be minimized or avoided as described below.

Participative or Individual User Hand-Assembly

“Needs Some Assembly” concepts and Kit versions of LARcodes and/or LARsponders can be used to avoid cost impacts on various standard graphic arts printing and assembly technologies by separate handling of some of the less common processes or substances which can be required in certain types of LARcode or LARsponder production. Use of screen-printing or other special or low-speed production techniques for applying RR pigments on paper, fabrics, glass, plastics, metals or other surfaces to create RR LOCATE areas can be avoided as described in the following examples.

Retro-reflective or other commercially atypical components can be mass-produced be existing methods as coated bulk sheets or rolls with, e.g. peel-off adhesive backings. These can be pre-perforated for tear-off separation or die-cut to proper shape and size ready for affixing to LARcodes or LARsponder. The two or more types of components LOCATE and CODE regions (the latter conventionally printed) of the LARcode can be optionally packaged in “Kit” form and then hand-assembled by the intended final user/owner (or by a “retail” kit vendor etc.) into a functional LARcode for use in a LAR-System-equipped venue.

(NOTE: Obviously, this general type of assembly can also be done by automated labeling machinery or similar methods if/when justified by production run quantities VS cost considerations.)

Aside from Kits with all parts needed by a user to assemble/render a LARcode complete and “ready to go”, needed RR etc. components can be supplied as separate “tip-ins” in, e.g. Event Programs in which the color regions of LARcodes have been pre-printed as graphics on Covers or in Advertisements etc. This converts the graphic into a LARsponder. Kits can also be distributed as premiums inserts or free hand-outs etc. “Prize” RRs for subsequently activating some type of “special” LARsponder or LARcode can be awarded based upon demonstrated skill or luck.

Regardless of how obtained, an individual desiring to use a LARcode or LARsponder manually positions the RRs appropriately on the graphic code component to complete its assembly thereby making it ready for use.

Please also refer to the Figures which illustrate some additional variations and versions of the above concepts.

Involvement and Incentives via Participative Assembly

The methods just described (as well as others disclosed herein) dealing with assembly of active LARsponders or LARcodes which require adjacency or presence of two or more components for full-functionality present effective opportunities to further and directly involve/incentivize LARsponder users most notably for marketing and sales purposes and/or opinion collection.

A user can, for example, obtain one of the two components as a free “hand-out” containing a set of RRs of particular design and/or shape intended to be added to a printed graphic in the Event program. The graphic can carry only the color blocks of a LARcode. The user then completes that LARcode or LARsponder, but must also acquire another LARcode, RR, “Kit,” or other components via a product purchase or some other action such as a contribution to an in-venue charity drive. To qualify for some type of LAR-System enabled activity—e.g., an up-coming contest or enhanced prize drawing etc. to be held in the venue, the user merely assembles/positions the original and added components.

Using a sports venue as an example, the products purchased for qualification and accompanied by components for the second Kit (e.g., bottle-collars, RR strips, stickers etc.) can range widely: cups of beverages, team caps, head bands, megaphones, banners, team pictures, “logo'd” playing cards, etc.

### C.11 Precise Entry of Number Strings, Alphanumerics, or Other Rich Symbol Sets Using LARsponders

Accurately communicating specific multi-digit numbers or an ordered multiplicity of selections from other rich symbol sets—e.g. alphabets, technical symbols etc. to a LAR-System can be a useful function of LARsponders. Passive and active LARsponder apparatus and methods for doing this are described in this Section. Uses of commercial and entertainment importance include ways by which guesses of the total attendance at a baseball game can be quickly and precisely entered by one, a few, or a massive crowd of individuals competing for “closest guess” awards. Mass participation in lottery-style awards for picking the winning random number string out of millions (or even billions) is also possible as are many other applications.

### C.11.1 Capture of Multiple Symbols in Single LARsponder “Read”

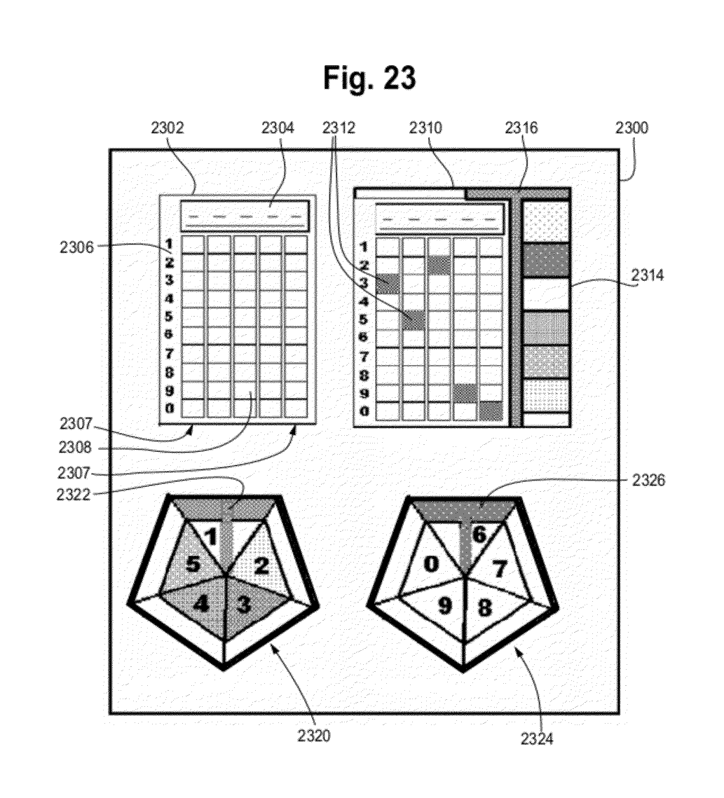

In FIG. 23, items 2302 thru 2316 located in area 2300, illustrates one example of a class of LARsponder formats for entering precise sequences of symbols. These “matrix array” type designs allow a LAR-Reader to acquire a lengthy symbol sequence (e.g. a five digit decimal number (hence 99,999 possibilities) in a single “capture and read” operation. As shown, 2302 is a flat rectangular card carrying a matrix-like array of rectangles 2308 although other matrix forms can also be suitable.

Area 2304 is merely for convenience, where a user can write his/her chosen number/symbol sequence for reference. In this illustrative layout, the desired sequence to be communicated by the LARsponder is designated by “marking” five areas in the matrix 2308. The matrix is 10 rows 2306 (1 through 9+0) high in the vertical “Y” direction and five columns 2307 wide in the horizontal “X” direction. The desired five-digit number is indicated by “entering” five X-Y locations 2312 as shown in “marked” Card 2310. In this instance, the number chosen for entry is 35,290. Note that a LARsponder with X=10 can specify one in 10 billion numbers. Card 2310 in this illustrative example also has a LARcode 2314 with a reference RR 2316 associated with it. This code can ID the event, the user, and/or convey special privileges, etc. which have been obtained by procedures such as described elsewhere herein.

There are many ways to mark/choose individual matrix areas so they can be discerned and their precise distribution of the LARsponder captured by LAR-Readers. These include “scratch-off” or peel-off of opaque coatings covering the matrix to reveal individual underlying RR areas (which can be colored) or the inverse process of positioning stickers to cover selected areas in the matrix. These can be adhesive RR “dots” supplied separately on sheets. Peel-able adhesives can permit dot removal and thus repeat uses of a given LARsponder card.

### C.11.2 Capture of Ordered Multiple Symbols by Sequential LARsponder “Reads”

In FIG. 23, items 2320 thru 2326 exemplify LARsponders which use a time-sequence of orientations to communicate a multi-member string of digits to LAR-Readers. The LARsponders shown are two-sided, with LARsponders 2320 and 2324 showing opposite sides. Many of the LARsponders described in this document can be so designed to double the possible choices available. In the present case, the LARsponder has five digits (1 thru 5) on its front face 2320 and five (6 thru 0) on its obverse face 2324. The user is cued by the LAR-System via video, audio or otherwise to enter the first desired symbol in the string, say a “3”. The user orients the LARsponder so the “3’ sector is vertical and in view of a LAR-Reader which captures the LARsponder's image. Then, the user is asked, upon a second cue from the system, to enter his/her second chosen symbol which may be, say, a “9”. The user turns the LARsponder to its obverse side 2324 and orients the LARsponder so the 9 is vertical then holds the 2324 side facing a LAR-Reader. As depicted, 2320 indicates a cued response of “1” and 2324 indicates a cued response of “6”. If desired, one or both sides of the LARsponder can also carry a LARcode 2314 with user-specific or other data.

This process can sequentially send a string of digits of any arbitrary length. Masses of users can be cued to show/hold their first digit choice, then say 3 seconds later cued to show their second digit choice etc. Collection from any number of “players” within a venue equipped with a LAR-System can be handled in parallel and simultaneously. Collection of, say, 49,990 specific and individual entries can accomplished in ˜3 seconds×five digits=15 seconds. A sequence of 12 digits (a 100 million member universe) can be “harvested” from 100,000 venue participants in approximately 30 seconds.

As already discussed at length in earlier in PART C, many other forms of LARsponders can be designed/used to conveniently convey lengthy symbol strings. See, for instance, FIGS. 13, 15 and 16. The “Slider” design shown in FIG. 13 (see 1312), for example, could carry 5, 10 or more choices per side. The “Pointer Wheel” (see 1324) can conveniently carry even a larger array of choices. Note that games, lottery number choices etc. or other activities involving entry of lengthy symbol or digit strings need NOT require that all symbols be entered in a single urgent effort.

While not discussed in detail here, more elaborate form of LARsponders can be used for entry of symbol strings. These can include, for example, multiple manually positionable rotating members (disks or wheels (as in mechanical odometers) with e.g. 0 to 9 numbered and distinctively color-coded RR regions around their periphery. Furthermore, as discussed elsewhere herein, active LARsponders with wireless communications and/or RFID features can be employed in certain types of venues where the necessary infra-structures exist.

At the simplest level, a LARsponder capable of only a “yes” or “no” (or merely a passive no indication “null” response) can be used to build a five digit number by signaling “yes” as digits for the first (the possible 10,000's place digits-0 to 9, then the 1000's place digits-0-9, etc. appear sequentially on displays, voiced on PA systems other channels in the venue. The users can be cued to signal their first desired digit when it appears before it changes. Time remaining for choice before a given digit on the displays disappears and next digit appears can be indicated by a count-down clock. If 5 seconds per digit are allowed in which to make a choice and a five digit decimal number is to be specified, the total data collection time will be of the order of 50 seconds per digit.

For a five digit number (99,999 possibilities), the total time required/occupied during actual “choice-making” is ˜5 minutes in this example and is essentially independent of crowd size. NOTE: The number of correct guesses for each digit or sequence entered by the above methods can be determined and announced within seconds after the time to choose it runs out. This can lend excitement, special small prizes can be awarded etc. until the event is completed.

### C.12 COUNTER-MEASURES TO FORGED/IMITATION LARcodes/LARsponders

Assembly-by-user LARcode and LARsponder designs not only can save overall production costs but also facilitate a variety of verification and anti-forgery mechanisms. For example:

Separately-supplied RRs components or Kits can carry bar-codes or other features (covert or otherwise) on their fronts, backs, or borders and/or also can be uniquely-shaped. Upon inspection, they can thus be identifiable as valid for a particular time or event for Award or other special recognition purposes.

Tactics such as “no release” within a venue or environs until near time/place of use of kits, add-on stickers, separate RR components of unique shapes and/or overlying color gels or other elements needed to complete valid codes and themselves valid for only a defined time after issuance (per coded data on the item).

Use of fluorescent/phosphorescent coatings as some or all of the color code Blocks.

Use of fluorescent marking and patterns within the LARcodes/LARsponders which are not part of the main coding function but are present exclusively to confirm validity upon UV inspection.

Steganographic methods can be used to hide verification data.

### C.13 About Response Collusion and “Spying”

While, in many cases, collusion between near-by “fans” can be an important aspect of the collective “fun” of sharing a venue event experience, in some circumstances it can be desirable to minimize “spying” or collusion etc. among users of LARsponders. Collusion, for example, can be made difficult by forcing it to be very quick. One example of doing this is to cause any LARsponder choice or maneuver occurring before the “zero time” of a count-down) to be blocked and/or possibly the user temporarily disqualified for “guessing” etc. The time window for an acceptable response input is then made very short—e.g. 1 second and starts only after the challenge is revealed to all.

Spying on neighbor LARsponder user choices etc. can be made difficult (while providing users with a sense of privacy) by, e.g. randomizing the positions of choices or orientation directions signifying a particular response on the LARsponders involved and/or using, say, half a dozen different appearing LARsponders all equally valid as input devices for the LAR-System. In the case of randomized positions or appearance, a LARcode associated with the LARsponder can communicate to the LAR-Data Server the exact type of LARsponder design/layout being used so the LAR-System handles the user's response appropriately.

### C.14 Some Security Applications, “Stand-Off” Id and Imposter/Intrusion Detection

LARcodes and LARcodeNESTs as in FIG. 22 and as briefly noted earlier can serve as simple but secure ID cards and access control Badges. They can also offer unique and useful properties/capabilities that reach beyond typical “civilian access control applications.

They are secure, inexpensive, passive, and can track motions, gestures, and/or ‘mid-air’ signatures.

They can be read at safe stand-off distances.

The required LAR-Readers are simple, economical and versatile, use available mass-produced hardware and are easily/quickly deployed in many different ways.

A LARcode and particularly a LARcodeNEST ID being used under duress or by imposters can be quickly and safely detected with high probability as further explained below.

An associated valid KEY can be required in addition to the NEST itself and the KEY can be changed/re-issued/re-coded in a changing format etc. by appropriate authorities from time-to-time for security reasons.

In some instances, the NEST and changeable Key can be kept separate from each other until needed for ID. The KEY can include High-Level Data about the ID holder such as name, address, serial number etc.

Portions, but typically all, of the detailed information in the NEST can be encrypted and hence rendered inaccessible not only to the legitimate ID holder but also to anyone attempting improper use of the ID or attempting to coerce the ID holder to do so.

A LARcodeNEST can serve as an encrypted Q&A Repository readable by LARcode Readers and which can contain a very substantial number of trivial, detailed and/or very innocuous personal and other biographical facts that can collectively be known only to the legitimate holder of the ID.

### The Q&A Repository Concept

The data placed in the Q&A Repository can be a culled sub-set of brief words or phrases given as responses to an extensive but easy and non-threatening written questionnaire or answers given during structured verbal interviews of the ID applicant. Precautions can be taken to insure the Applicant is not able to record or copy his/her own responses to the questionnaire or interview so he, himself, cannot remember all questions he was asked and cannot recall/reveal them, e.g. even under torture.

A random selection (not revealed to the prospective ID card holder) of perhaps 50 or more of BOTH the questions and their correct answers are then encrypted and placed in the NEST. The resulting Q&A Repository can thus contain a large amount of mundane, personal and culture-specific data such as names of childhood friends, old home addresses, parents, children ages and birthdays, most favored food, most favored drink, favorite book, movie star, teacher in first school, favorite city in home country, favorite sport, favorite sports star, favorite musical group, favorite song, mother maiden name, favorite cleric, names of deceased and distant relatives, names of present or past pets, etc. etc. Different set of Q&A's from the original interview/questionnaire or from the Q&A Repository can obviously be chosen on different occasions.

### Capabilities for ID and Clearance at a Safe Distance

Before allowing a close approach to a Control Point, Secured Gate or Checkpoint etc. by individuals or vehicles (including driver and other passengers) moving toward or in waiting lines, persons can be required to present their IDs and Keys at one or several LAR-Reader stations variously positioned along their line of approach. Such Reader stations can use any of the apparatus and methods previously disclosed. They can be based on simple low-cost (and only slightly modified) commercial “Point and Shoot” cameras.

Readers can be hand-held (if considered safe), can be carried on motion-stabilized mounts or mounted on aerostats, tethered balloons, helicopters, light aircraft, UAVs or drones, poles/walls/moveable/mobile and/or/robotic platforms etc. Several Readers can be deployed at a given station and these can wirelessly deliver various views of a vehicle interior, its passengers and their IDs. LARcode Readers can have telephoto and stabilized imaging capabilities, including among others, those based on the methods and apparatus described elsewhere herein which employ (or are assisted by) RRs on the targeted LARcodes/LARcodeNESTS containing the Q&A Repositories.

Reader stations can include voice-to-ground or other public address systems, two-way audio booths at unmanned query points (as in some Drive-In Restaurants) which can be used to converse with persons wishing to approach a Control Point. The System can also include voice recognition and auto-translation capabilities to enable the interrogation techniques described below. Challenges, interactive confirmations and/or authorizations can be conveyed not only by audio but by digital signage or via data delivered through networked devices such as smart-phones etc.

Detection of Imposters and/or Safe Detection of Responders under Duress

Person(s) approaching a Control Point can be required before moving any closer to a Control Point to present their IDs in a cooperative posture or “pose” facilitating reading by one or more suitably deployed LAR-Readers. (Approaching persons can also be challenged to give the visual “PASS-GESTURE” of the day while viewed by LAR-Readers.)

These transactions can be conducted with a large separation between an initial user ID presentation attempt before allowing close approach to manned terminals, scanners, security guards, access gates and the like. This capability obviously implies more opportunity for safe early challenge of unauthorized persons, more time for warning, clarification of user status, instructions to desist, etc.

The High-Level Data KEY “reads” of a presented ID can be used by the System to access the Q&A Repository Data contained in the ID's LARcodeNEST and present it to the Control Point authority. Alternatively, such Q&A Repository data may already be available in a local database because of previous transits through the same Control Point.

Obviously, answers to multiple challenge questions drawn from the Q&A Repository data as previously supplied by the legitimate ID holder can only be known unhesitatingly (or perhaps with brief thought) to the holder of that of the ID. Selections from the Q&A data are used to interrogate and/or challenge the ID holder's knowledge or legitimacy. If the ID Holder is an imposter, he/she will not know many, if any, correct answers, thus alerting the Security personnel. If answers to LARcode or NEST-based challenge questions are being coerced out of the ID holder, he/she can covertly alert the Control Point security personnel by deliberately providing a series of wrong answers. If a challenged person “panics” and forgets a correct answer as originally supplied, he/she can be quickly given several chances to answer alternative questions before taking “intercept or exclusion” actions etc.

Codes of the general types as described herein are passive and the data represented by a LARcode KEY can provide basic ID information such as name, rank, serial number, passport number, home address, etc. of the Holder which can be read at large stand-off distances compared to passive RFID tags.

Detailed information contained in a LARcodeNEST can be encrypted so the ID holder/user CANNOT read it. RFID tags can be stolen or counterfeited. Photo-IDs can be disguised or counterfeited, passwords can be given up under threat or sold, eye Iris pattern and vein pattern-reads require one-on-one close-up interaction with sophisticated equipment, Magnetic stripes can be copied, fingerprint methods are subject to interference from dirt etc. No one is likely to have instant correct answers to random personal questions except the one person who knows all the answers inherently—the legitimate holder of the ID.

### Part D

### LAR-System Installation Technologies and Venues-Some Examples

### D.01 Introduction

A LAR-System installation can be as simple and small as one inexpensive LAR-Reader covering a space measured in cubic inches, a desktop, or a portion of a room. It can use only one or a few LARcodes or LARsponders. At the other extreme, a LAR-System installation can involve hundreds of LAR-Readers, perhaps including some with special or diverse capabilities, working simultaneously with tens or even hundreds of thousands of LARsponders in a single venue. A system can use LAR-Readers based on very advanced digital cameras with extreme resolution and pixel counts. Some can be mounted on aerial survey platforms. Still others in the same system can be man-mobile, equipped with adaptive optics and specialized ROI or other capabilities.

Individual LARcodes, in the various configurations disclosed in PART B of this document, serve primarily as one-way sources of fixed pre-defined encoded data content to be delivered to a LAR-System. If appropriate software is available in the LAR-System's Data-Servers, a LARcode's encoded content can be processed along with data on its 2-D or 3-D coordinates in image space. In some applications, the “pose” of the LARcode source being imaged by the LAR-Reader or Readers can also be determined.

LARsponders, as described in PART C, when used with appropriate LAR-System software, add a wide range of 2-way response modes and other capabilities which include but reach beyond those offered by fixed code content LARcodes. For this reason, PART D will be focus on venues in which LARsponders might typically be used with the understanding that such systems also accommodate LARcodes. “Large” venues are emphasized in the following.

Certain of the deployment methods and apparatus to be discussed obviously may not be appropriate in smaller venues such as Sports-bars, classrooms, etc. or other spaces of comparable or somewhat larger scale.

### D.02 Some Candidate Large Venues

LAR-Systems can adapt to AND can drive sales and revenues for the owners and operators of almost any traditional type of collective audience and/or group activity space such as:

| | |
|---|---|
| Stadiums | Band-Shells |
| Legitimate Theaters | Town Squares |
| Motion Picture Theaters (IMAX, etc.) | Casinos |
| Assembly Halls | Open-Air Festivals |
| Concert Halls | Convention Centers |
| Shopping Malls | Arenas |
| Mega-stores & Retail Outlets | Waiting Lines at Attractions |
| | e.g. DisneyWorld |
| Race Tracks | Hotel Lobbies |
| Parade Stands | Passenger Ship Facilities |

### D.03 Deployment Methods for LAR-Readers & PLCMs

A LAR-Reader consists of one or more imagers with LARCA (LAR-code Adapter), IM-(Illumination Manager) and PLCM (Power & Light Control Module) with associated Illuminator lights sources. Several different types and combinations of LARsponder Illuminators can be used as discussed elsewhere in this document.

System Field-of-View (FOV) operational requirements for a given venue can be met in various ways. These include, but are not limited to mounting a number of fixed-location (but removable if/when desired) LAR-Readers in the venue. NOTE: Outboard PLCMs and Illuminators (if not attached to moveable Imagers) can be mounted similarly but, when desirable, inconspicuously positioned as explained in PART A.

Suitable “fixed” locations for LAR-Readers include:

On venue walls/ceilings/roofs or partial covers/fences/trees/overlooks, mobile cranes, exteriors or in windows of surrounding buildings

On or hanging below undersides and/or fronts of balconies/upper tiers/proscenium arches

On “flagpole” masts in participant/audience spaces (e.g. grand-stands, other seating, race tracks, rinks, aisles, etc.)

On suspensions using extension rods or wires from elevated wire networks or guy-wires above the action and/or audience spaces

Clusters of “Omni-view” LAR-Readers can be suspended in fixed locations from venue ceilings or equivalent with Lines of Sight in 3-4 fixed directions or the LOS could mechanically rotate to cover 360 degrees

Vertical “fans” of LAR-Readers can be used to cover sloped linear-seating sections and optionally such arrays laterally on trolleys to cover long grandstands

Multiple LAR-Readers can be mounted outward-looking on “n” spokes of a horizontal wheel to cover curved sections (e.g. stadium end-zone seating etc.)

In addition, and depending upon the event and the physical characteristics of a given facility or venue, operational Field-of-View (FOV) requirements can be met with LAR-Readers deployed on mobile, moveable, and/or man-portable mounts such as:

On mobile carts, platforms/towers/masts or booms (robotically, remotely, or manually maneuvered and/or aimed)+

On tethered balloon “Elevators”

Hand-held, mono-pods, or “Steadi-Cam” mounts etc. for free-roaming LAR-Readers carried/maneuvered by ushers or other venue staff. (These can, for example, be dispatched to cover “prompted” audience areas for reactions on a section by section basis—e.g. “Section 6, choose now!”)+

LAR-Readers carried aloft on “blimps” as often engaged to provide “Major Event” advertising and “bird's-eye” views of a venue (as in TV coverage of Pro Football and Bowl games, etc.)+

LAR-Readers mounted on helicopter, airship, or fixed-wing aircraft (A version of this type of Reader can be based on “leased-for-the-event” digital aerial survey and mapping cameras to which demountable custom communications, PLCM, and IM accessory gear and high intensity Illuminator light sources) can be added. Progress in unmanned recon micro-aircraft and drones can also enable their use as LAR-Reader platforms

One or more LAR-Readers can also be mounted on pre-existing (or purpose-installed) motorized wire-supported remotely-controlled video cameras as are currently used to isolate and follow wide-ranging goal-line to goal-line action on a playing field, e.g. football. The LAR-Reader FOV can be aimed so as to collect a sequence of audience areas between plays on the field.

LAR-Readers can be co-mounted on TV cameras covering an event and the Reader's FOV parameters and other settings automatically coordinated with the video or controlled manually by the TV camera operator.

The FOV of a LAR-Reader (and associated Illuminators) can include image relay mirrors (flat, spherical, etc.) optionally supported by image rectification processing by the LAR-System

Given a cooperative agreement with the owners/operators of video cameras providing TV, cable or other sources of live programming of venue events, their coverage cameras (with co-mounted LAR code Illuminators under wireless flash etc. timing control by the LAR-Servers) can collect LAR-Reader imaging data between action shots of the venue events themselves. Whenever a camera is available to provide such images (e.g. during commercials with which LARsponder activities might interact) they would be routed by the Network or another TV coverage provider's video-switcher computers to LAR-Data Servers etc.

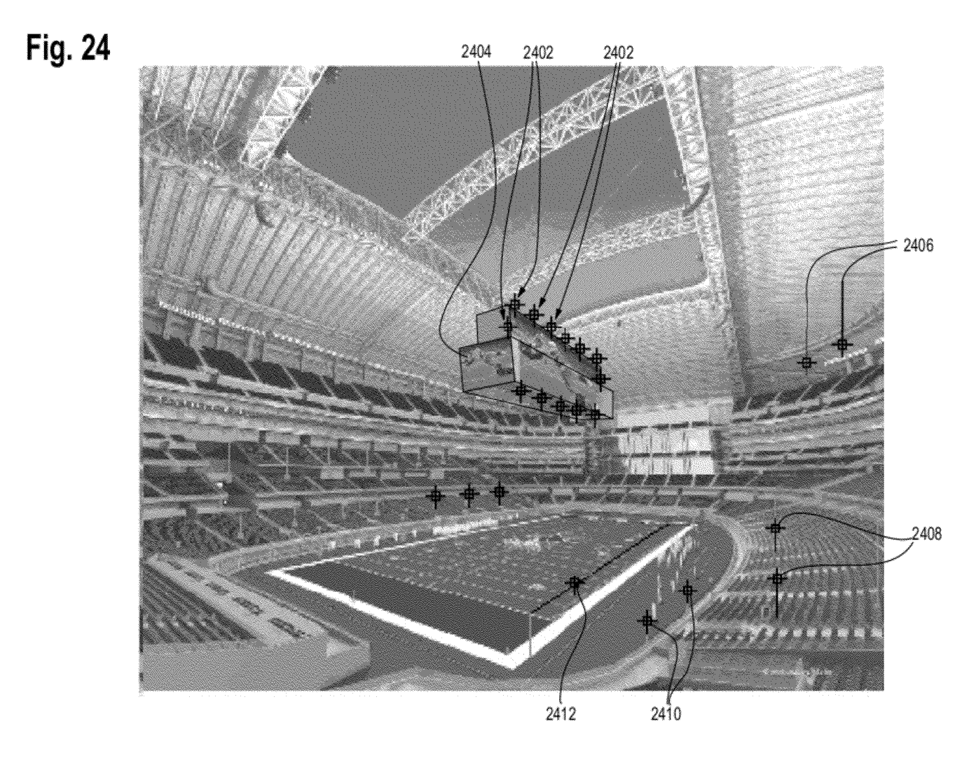

FIG. 24 is suggestive of a few typical locations in a very large sports venue where LAR-Readers have been installed. The symbols are MUCH larger than the actual physical LAR-Readers would be. Examples of quantities etc. of LAR-Readers needed in large and small venues are discussed in later sections of PART D.

2402 denotes LAR-Readers on the perimeter of a giant video display 2404 on which imagery can be displayed that offers interactive challenges to an entire audience of 80,000+ event attendees OR to subgroups as designated by on-screen information, audio etc. 2406 shows a few examples of the LAR-Readers covering upper deck right-side seats. 2408 shows a few mast-mounted LAR-Readers serving the Main or first level tiers of seats. 2410 indicates a couple of man-mobile LAR-Readers while 2412 is a LAR-reader assembly mounted as a small accessory on the high speed mobile robot side-line video camera system typically used to enhance network and local video coverage.

Elevated LAR-Readers can view audience areas from the rear or from the front. Users simply may hold their LARsponders accordingly—upward and facing toward backward or backward. Look-down FOV LAR-Readers obviously can read LARsponders that are positioned “face-up”.

The great variety of mounting methods, both fixed and mobile, and the multiple locations available for LAR-Reader installations combined with the wide range of design features which can be incorporated in individual LARsponders minimizes or eliminates occultation issues.

A given area of particular interest in the venue (e.g. a “team” of audience members) can be viewed by both fixed LAR-Readers and intermittently also by mobile LAR-Readers.

LAR-Readers can be GPS located and tracked. Such data can be used to provide alerting information or about the sun's relative position with respect to specific LAR-Reader sight-lines in order to avoid solar retro-reflections from certain

LARsponders or temporarily block data from them. The software generating warnings or blocking can reside in the Servers.

### D.04 Venue Reference Markers

Stationary Markers

Multiple temporary or permanently-installed stationary Reference Markers within the FOVs of one or some LAR-Readers in a venue can provide pre-determined and precise 3D coordinate reference data in imagery captured by LAR-Readers. Some or all Reference Markers can be generic and referenced to the known fixed architectural features of a venue. Some or all Reference Markers can carry optically-coded information readable by LAR-Readers which direct the system to their ID precise pre-calibrated 3D locations and other data or unique attributes. Since markers can be of known physical size and shape, their images, as captured by a given LAR-Reader, whether fixed or mobile, can also be used for scaling and estimating distances and pose (3D orientation) of LARsponder elements with respect to that LAR-Reader and its LOS. Markers can be coded (e.g. LARcodes) and cylindrical so they can used by multiple LAR-Readers having a variety of LOS's.

As with mounting locations for LAR-Readers, Reference Markers can also be located on or above stairwells, aisles, fences, masts etc and on fixed LAR-Readers in the FOV of other Fixed LAR-Readers. In addition, they can also be placed on backs of seats or on undersides of fold-up seats to use as geometric spatial references when in view.

Pre-calibrated Reference Marker data and/or data regarding the Line of Sight (LOS) and FOV of fixed-position LAR-Readers can be used to determine the exact seat number or the standing location of the person using a LARsponder in an image captured by a LAR-Reader. This can be accomplished by conventional computer-based geometric scaling of vector distances between available Reference Markers and that particular LARsponder of interest. In the case of fixed FOV LAR-Readers, portions of the required geometric calculations can be done in advance and held in LUTs (Look-Up Tables) or other accessible memory.

Variable, Moveable, or Other Temporary-location Reference Markers

LAR-Readers can also carry Reference Markers. These Markers can be optically coded to provide ID and the current location etc. of a given moveable LAR-Reader as viewed by other (e.g. fixed-position) LAR-Readers. Such data, in turn, enables computation of precise locations of LARsponders in the FOV of the moveable LAR-Readers. Moveable LAR-Readers can also be equipped to use conventional tracking, transponders, tilt and rotation transducers, GPS and/or enhanced high precision GPS, and ranging methods etc. for determining and/or reporting relevant properties such as FOV, instantaneous LOS pose, 3D location etc. and can report internal software-controlled LAR-Reader internal parameters, e.g. current focal-length setting etc.

If a specific participant voluntarily “opts-in” and is using a uniquely-coded personalized LARsponder, the actual identity etc. of that person can be determined and displayed or announced publicly etc. Similarly, any/all specified “opt-in” members of any kind of sub-groups (i.e. teams) in a venue who meet defined criteria and/or who make “valid’ responses or choices can be located. Such information can then be used to direct video coverage, generate announcements on the facility's digital sign banners, or make audio public address announcements etc. concerning those respondents (“winners” etc.).

D.05 LAR-reader coverage & cost of LAR-systems

Digital camera and imaging technologies are evolving and improving rapidly. The examples below are merely representative of a few specific approaches using current and widely available cameras. Impending availability of very large CCD and CMOS sensors at increasingly economical cost levels and other impending advances in the general state of this art will have significant positive implications for exploiting many of the teaching of this disclosure.

D.05.1 Fixed LOS/FOV LAR-Readers—an Example

NOTE: Multi-spectral Illuminators, retro-reflective color-code regions, spectral modulation techniques etc. as disclosed earlier in this document, can be used to substantially reduce the assumed minimum pixel areas (64 or 100 pixels) needed for readable blocks. Such techniques potentially increase the total venue area coverage per LAR-Reader or conversely reduce the minimum size of LARsponders or LARcodes that can be used in a venue equipped with a fixed number and type of LAR-Readers. The simplified examples and discussions presented in Sections D.5.1 and D.5.2 do not exploit these available options and techniques.

Assume, for illustration, one mast-mounted or suspended LAR-Reader installed in a venue above seats in typical inclined-ramp fashion. The LAR-Reader views the seats along a line-of-sight (LOS) orthogonal to the plane of the audience area.

Assume 12 megapixel digital cameras which are readily available, feature-rich, and inexpensive are used in the LAR-Readers installed in the venue.

Assume that an 8×8=64 pixel image area is required per LARcode or LARsponder color block, RR, or “element” (when its plane is roughly orthogonal to a LAR-Reader LOS) for correct color determination and processing by the LAR-System. This allows a significant margin to accommodate fore-shortening can be caused, for example, by a user's “careless” display of his LARsponder with respect to his/her designated LAR-Reader's Line of Sight despite being cued.

(Note: See additional comments below re providing cues to users to orient their LARsponders.)

Given the above assumptions, the total FOV of a single 12 megapixel LAR-Reader frame contains 12×10⁶/64˜19×10⁴ “features”.

If LARsponder or LAR-code Blocks or other elements of interest are, e.g. squares 1″×1″ in actual physical size then the total physical area of FOV of the assumed resolution LAR-Reader encompasses 19×10⁴ in² hence 1,319 ft².

Assume each audience member seated or standing space occupies roughly ˜2 ft×3 ft=6 ft² (this estimate allows for aisles and stairs etc.) then one captured LAR-Reader frame covers 1319/6 or space for roughly 220 audience seats. (A seating area 18 seats wide×12 rows deep holds 216 seats at the assumed 2 ft×3 ft size.)

An 18 seat wide by 12 row deep area (−36 ft×36 ft) can be covered by a ˜50 degree fixed focal length lens using a ˜40 foot viewing distance. (In this simple and very approximate analysis, the effects of non-square 3×4 or 16×9 aspect ratios of sensor pixel arrays and the square-law reduction in image area occupied by 1″×1″ physical blocks located near the edges of the LAR-Reader's FOV are ignored.)

In many types of venues, and depending on the mounting locations and sightlines of the LAR-Readers, some audience spaces in sloped seating areas will be fore-shortened with respect to the FOV sight-lines. For example, if the venue uses 9.5 inch riser step heights and 36 inch deep steps from row to row, the inherent fore-shortening slant is ˜15 degrees. LAR-Readers can be mounted with lines of sight that are vertically down from above the seating, slanted upward from below the seat deck or slanted downward from above and behind the seat deck.

Audiences equipped with LARsponder can be instructed in advance, and also during use, that their LARsponders should be positioned/presented, (i.e. hand-held etc.) so as to be roughly orthogonal to a particular LAR-Reader's line of sight whether fixed, mobile, or on an over-flying aerial platform of some sort. (The last-named would, of course, use imagers with much higher pixel counts.) Users can be alerted to perform this approximate alignment by a preliminary light-flash, or by audio, video, radio, digital signage, smart-phone signal or any other source of cues.

Compared to the preceding very simplistic “flat field” example covering 216 seats, these factors can change the effective “packing density” and hence the number of participants/responders that can be covered per LAR-Reader. Furthermore, some LAR-Readers can be installed with somewhat overlapped FOVs and somewhat convergent LOSs. These can be co-located as shown in PART A-FIG. 4 “CamClusters” 52.

In venues or areas where participants are standing or walking, the effective density can obviously range from very close-crowding to sparse.

As a more specific example, consider a LARsponder of the “Orientation Response” type (similar to 1520 in FIG. 15 which offers four distinguishable orientation choices and is the size of a postcard 4.5″×6″.

Such a LARsponder has an effective area of about 27 square inches (hence assume ˜20 square inches allowing for substantial angular foreshortening etc.). Each of the four key “elements” (other than the RR strip) on the LARsponder is ˜5 square inches in area. Assume in this instance 100 pixels are required for reliable orientation and color code “Reads” of an element. A single 12 megapixel LAR-Reader can therefore cover (12×10⁶)×5/100=6×10⁵ sq inches. This is seating space for ˜700 audience members (allowing 6 sq ft per person) all of whom can be viewed by a LAR-Reader operating from ˜70 feet above the seats.

Many other combinations of number of LAR-Readers, lens focal lengths, types of mounting etc. than those assumed above are obviously possible. The key point is the total approximate number of fixed LOS and FOV LAR-Readers with their associated accessory hardware required in these examples is demonstrably modest on a per participant basis and this is likely to be the case in numerous other applications of the teachings herein.

D.05.2 Coverage with Variable-Parameter LAR-Readers (LOS/FOV Etc.)

In any installation, in addition to the fixed LOS/FOV LAR-Readers examples above, the option exists of using LAR-Readers that include motorized zoom lenses mounted on PZT (Pan, Zoom, Tilt) mechanisms to cover a venue or certain portions thereof. These can also incorporate f/stop control and other features. All such parameters can be pre-programmed and can include adaptive features/capabilities on a viewed region-by-viewed region basis. Control can be based on weather, time of day, environmental/ambient factors and/or can include data obtained by monitoring of margins of error and repeatability etc of LARcodes read by specific LAR-Readers and/or read accuracy behavior against standardized test targets positioned in various locations the system operating space.

The capabilities of given LAR-Reader using associated LAR-Data Server/System software can, among others, include the following:

Upon cuing of the venue occupants, capture one or more short time-series of still frames (e.g. preferably over a few seconds or less) during which LAR-Reader variables such as focus are stepped (or rolled) over a range, exposure is stepped (or rolled) over a range, zoom is stepped or rolled over a range, LOS is moved over a pan/tilt range, Illuminator properties are varied. Such time series can be acquired re either one variable at a time or in series of adaptive combinations. Image processing techniques can then be used to improve selected or general data detail and accuracy by combining data from some or all or a given set of such time series using scaling, de-blur, spatial correlations, color analysis, image stitching etc. These manipulations can be assisted by reference to known data re fixed Reference Markers or other unchanging elements in the varying FOV. Results of time series can be used iteratively to modify subsequent time series and the types ranges of parameters used to capture them.

While the teachings of this document emphasize “still-pictures” and/or short sequences of still pictures, the concepts can also be applied to data obtained from “full motion” or short bursts of “n” frame video sequences e.g. footage captured using motion-capable HD video cameras. During such capture sequences, zoom, pan and focus and aperture parameters can be caused to vary automatically or adaptively on the basis of previously obtained results.

The data so obtained can, as noted above, be referenced to fixed Reference Markers or other points of reference with pre-established known spatial locations as seen in the video FOV. Computer-based image analysis and correlation across multiple frames can then be used to improve the read accuracy of any given frame or area of interest. For example, a particular LARcode image that is out of focus, partially occulted or underexposed etc in one frame can be tracked across several frames as LAR-Reader parameters that control focus, FOV, LOS etc. are altered and the collective data can then be used to interpretation accuracy of the original data set or future ones.

D.05.3 LAR-Systems in Small, Miscellaneous, or Non-Traditional Venues

It is not practical to attempt to list or provide system design examples of the many types of “smaller” e.g. Sports-Bars, Coffee Houses, cocktail lounges, classrooms, etc. or the more “non-traditional” venues and particular circumstances as exemplified below in which LAR-System technology can be permanently or temporarily employed.

Non-traditional venues of interest can include “open” spaces that do not routinely host performances/events presented to seat-assigned audiences. Others can be unexploited simply for lack of suitable or affordable ideas for uses. Still others can be surplus areas embedded in larger active spaces only infrequently set up for special events.

A sampling of venues in which LAR-Systems (leased or owned) can be quickly, economically, and temporarily or permanently installed along with examples of features, modes of use, along with a few suggestive “scripts” suited to such venues when equipped with LAR-Systems is provided below:

Open spaces which are accessible to the public such as parks, beaches, sidewalks, hotel lobbies, transportation system waiting areas and terminals

“Digital Out Of Home” (DOOH) digital signage is a developing channel for advertisers. DOOH displays, in some cases, use touch screens for response purposes and/or cameras viewing passers-by to identify their sex and age for more personalized marketing purposes. The capabilities of these and similar installations can be substantially augmented by using a LAR-Reader viewing passers-by who have or are given access to LARsponders.

Under-used, temporarily or permanently-closed venues such as dis-used motion picture theaters, meeting halls, amphitheaters etc. can be periodically re-opened to host special types of entertainments and/or revenue-producing “action”.

Individual audience members, and/or pre-formed or ad hoc groups in an equipped venue can compete with each others playing on-line games or in other activities using free LARsponders provided by mail from an event sponsor, with purchase of refreshments etc.

Partisan competing audiences, even in different kinds of venues AND in different cities can simultaneously and remotely contest with each other by, e.g. predicting the next play, race winner or outcome regarding a specific sports, talent competitions etc. or other special event using LIVE video over-the-air, satellite, cable, or web-cast feeds etc. as a basis.) Participants get the shared excitement of having a live LOCAL crowd of fans around them.

Venue-specific “banner” challenges running across bottom of the event display screen or displayed proprietary venue digital signage can be used.

LOCAL gambling and prize awards can be permitted given suitable legal arrangements.

Venues can be equipped for gambling using no digitally network-connected smartphones, computers or any other active personal devices whatever. For example, a completely passive LARsponder as a disposable card (personally purchased by each gambler) can be used for placing bets in the venue on e.g. craps while viewing randomly generated dice throws on a large screen.

Incentives can be offered to audiences in a LAR-System equipped venue to act as FOCUS groups by using their LARsponders to register their opinions of advertisements, quality of products, packaging preferences etc. electronically displayed on venue displays OR on Smartphones etc. with NO particular or special apps being required to be installed/used in the devices providing the basic event images.

Substantial space in thrill-ride and theme park facilities and other large venues is devoted to audience pre-loading and crowd-control. Large numbers of people are often left with little to do except wait for “curtain time” or for exiting crowds to clear. To participate in the pre/post event activities in such areas, audience members can be equipped with LARsponders by give-aways or as premiums accompanying purchase of some revenue producing item such as refreshments or souvenirs. LARsponder-based action using Video screens and LAR-Readers mounted along crowd-control pathways can be used for games to entertain and “pace” such crowds and reduce annoyance impatience.

Passenger aircraft, trains, and buses, especially those already equipped with passenger video screens offer another type of unconventional collective interactive entertainment environments for “team” games, product and/or other promotions, and even gambling. Note that a few dozen LAR-Readers can cover a Jumbo-Jet. A bus or train car can be covered with a single “roaming LAR-Reader carried by a cabin attendant etc.

Large-screen Home Theater Entertainment Centers typically are used with video games that accommodate one, two, or perhaps three ACTIVE participants while other persons, if any, can merely watch. LAR-System technology installed in such a venue can accommodate game adaptations that can involve not only one or two but also 3 to dozens if desired, without requiring special hardware. The additional participants can bet, predict, offer video-graphic and verbal advice etc. without necessarily requiring any modifications to the original game software or user interfaces etc. and, in some instances, actually play as “collectives” or teams. This can be done, e.g. by averaging or otherwise combining multiple individual inputs/actions etc into single team input that can be accepted by the original game software.

NOTE: Most of the above types of venues (and many others) can be quickly, economically, and safely outfitted with permanent fixed or temporary and/or mobile installations of LAR-System equipment to convert them into new-use interactive group facilities. In un-used or under-used venues, temporarily installed large-screen Video projectors, as well as other Displays and audio systems in addition to “live” Hosts can be easily provided as “packaged” Support Equipment at low economic risk for “short-run” ventures/performances.

D.05.4 Bi-Directional Data Flow—LARsponder User to/from LAR-System

In many applications of LARsponder and related technologies, it can be desirable (or even essential) that users can quickly input and get proper System reaction to their LARsponder inputs, be promptly informed of a LAR-System's specific acknowledgment, action taken (e.g. purchase recorded) and/or other feed-back. There are several methods and apparatus that can be used to accomplish this depending upon the venue, types of activities, audience parameters and other factors:

Via “Open” Venue Channels

As has been detailed elsewhere in this document, two-way feedback to a user or users can be accomplished via dynamically up-dated venue video and/or other digital displays. These can be large screens viewed by thousands, poster size, or small screens at counters or tables, seat video for passengers etc. Alphanumeric by methods such as venue audio, lighting effects etc. Importantly, all of these “open” methods can be scaled to handle single, a few, or very large numbers of venue users via the fast local processing and response capabilities of the venue LAR-System.

Via “Private” MIDs, Smartphones and/or LARsponders Incorporating Them

LARsponders incorporating commercial network-enabled devices (MIDs, Cellphones, Tablets etc.) as component elements have also been disclosed in this document. These can provide users with private input and feed-back capabilities from the LAR-System.

Note: If an event requires very rapid responses (e.g. sub-second) to unscheduled challenges or randomly-timed happenings in the venue it may be necessary to continuously maintain connectivity via the service-provider's general purpose communications infra-structure. The network-enabled LARsponders must be “on”; using the proper “App” and “at the ready” to function effectively. Furthermore, the network must be able to handle near-simultaneous data exchange with users with very low latency, particularly when large numbers of co-located LARsponder users (e.g. stadium crowds of many thousands) may all be attempting to respond (upload) or download different personalized information in seconds or less.

It is also noteworthy that there are many locations in the world where large crowds can congregate, but where communications coverage, data speed, device affordability/availability and necessary infra-structure may be rudimentary and/or sparse.

Via Active LARsponder Accessories for Private Data Exchange

There are certain applications or circumstances where LAR-Systems and LARsponders can be useful but data-flow such as specific information, feed-back, order size confirmations/changes, or acknowledgments to individual LARsponder users is desired or essential, but no suitable “small audience” or ‘private” coverage displays are available and other methods e.g. audio or PA channels can be inappropriate or can compromise privacy.

In such situations, local short-range low bit-rate wireless channels can be used to communicate to and from individually addressable actively-powered (e.g. battery, photovoltaic, etc.) user-carried LARsponder Accessories. Accessories with the required types of active capabilities can be inexpensive. Well-known technologies are available to handle all communications, display and data input-output functions required. They can be given, loaned, purchased, or otherwise provided to LARsponder users and can take several forms.

For example, the active accessory can be a small credit card-sized device. A simple version can use a number of small LEDs which flash and or light in various combinations etc. to signify acknowledgment, or other simple quantitative or qualitative data sent to or received from the LAR-System. Well-developed technologies based upon LCD, OLED, eINK, and similar thin and small displays suited to card format as well as others are available to support more sophisticated two-way alpha-numeric information exchanges. Touch and alpha-numeric key input areas can be provided on the active device.

In some applications, simple audio “beepers”, tone generators or “vibratory alerts/confirmations built into the accessory can be adequate for information exchange.

The active accessory need not be in card format. However, one preferred embodiment combines the active accessory with LARsponder features as illustrated in FIG. 22 of Part C.06 showing integration with IDs, Charge-Cards, and LARcodes.

Any of the above described active accessory capabilities can be designed and configured to be independently acquired and used as a complement to a range of types of LARsponders. Alternatively, they can be attachable, “snap on” or tightly integrated and combined with a given LARsponder's physical structure and mode of use.

NOTE: An active accessory can also include a capability to automatically (or upon the user's request) alert a LAR-System and/or user that it is within that LAR-System's venue service range.

D.05.5 Estimated LAR-Reader Unit Production Costs

Assumptions:

| | |
|---|---|
| Small Quantities-(e.g. 100 unit runs initially) | |
| Fixed location and FOV LAR-Readers including | |
| Accessories LARCAs, PLCMs, IMs (See PART A) | |
| Parts Cost and Assembly | |
| Excludes installation costs, site-specific custom | |
| engineering, LAR-System computers, software, | |
| including O/H, R/D costs and proto-typing | |
| development amortized cost recovery, sales cost | |
| and profit | |
| 12 Megapixel Digital Camera | $350.00 |
| (Sourced from OEM with modified software) | |
| (Priced for quantity acquisition) | |
| Packaging and Interface hdwr | 50.00 |
| LARCA and IM: | 200.00 |
| Exposure Control | |
| Data Pre-Processing | |
| Wireless Data Comm Sub-System | |
| Illuminator Control | |
| Maintenance and Diagnostics Sub-system | |
| PLCM: | |
| Illuminator Assembly (Typical) | 150.00 |
| Power Supply Sub-system | 100.00 |
| Wiring, etc. | 50.00 |
| Mtg Hdwr (wall or ceiling suspension). | 50.00 |
| LAR-Reader Unit Cost | TOTAL $950.00 |

The basic cost presented above suggests that a system using Fixed Location “Look-Down” mode line-of sight LAR-Readers (with each Module serving ˜200 participants), the basic LAR-Reader front-end hardware “install-ready” cost (note the above excluded items) will be of the order of $5-6 per seat.

The basic raw cost of materials and fabrication of items (as defined above) for equipping a 60,000 seat Stadium by installation of an estimated 300 LAR-Readers (in simple fixed mounts) as required to cover audiences in such a venue can be estimated at ˜$360,000. This suggests that a total “all-in” up-and-running LAR-System cost for a conventional 60,000 seat stadium should be less than $1 million or about $17 per seat.
NOTE: The use of multiple fixed LOS and FOV LAR-Readers, as illustrated above, is only one approach to covering a given venue. One quite different and alternative approach, for example, would use a much smaller number of LAR-Readers on automated Zoom, Pan and Tilt mounts along with image-stitching software to cover many or all areas of the venue.

D.05.6 Other Costs—LAR-Data Servers, Customized Venue Features Etc.

A portion of the cost-difference between the $1 million estimated figure and the basic cost of $360,000 cited above is made up of additional items/costs. These can be priced in separately in an initial one-time detailed “Project Design and Implementation Fee”. In some cases, portions of these can be out-sourced to appropriate Engineering firms as approved by the venue owner. Additional costs typically can include items such as:

Design and implementation of special mechanical, electrical and custom lighting effects for the specific stadium, theater, urban space etc.

Generic and customized LAR-Data Server computer hardware

Licensing fees for LUXELAR-owned LAR-System proprietary software used for collecting and processing inputs/choices, selection data etc. from LARsponders.

Integration costs of the LAR-System with the venue's pre-existing Visual Displays, Digital Signage, and Public Address systems

Design and fabrication assistance/mgmt of venue (or product or event specific) LARcodes and LARsponders

D.05.7 “Small” LAR-System Basic Cost Examples

### EXAMPLE I

A 100 seat “ramp-style” Lecture Hall equipped for multiple choice or similar types of LARsponders

| | |
|---|---|
| One 12 Megapixel LAR-Reader | $350.00 |
| (Includes motorized pan/tilt ceiling/wall mount, image-stitching | |
| software, & wireless SSD card) | |
| One Combined mini-LARCA, PLCM, and IM | 250.00 |
| Illuminator Assembly Sub-system (hard-wired for power) | 100.00 |
| | $700.00 |

Assumes availability of a suitable PC and a Venue Video display. Student Records and Administrative software not included. Production costs assume quantities of 100+.

### EXAMPLE II

A long-haul Bus or Rail-Road Passenger car designed for “2 seats-aisle-2 seats” per row and 20 rows hence 80 passengers (no standing passengers). Two fixed FOV and LOS LAR-Readers per row.

Each LAR-Reader (mounted over seat pair) comprises:

| | |
|---|---|
| 2 Mass-produced 1 megapixel video cameras at ~$5.00 ea | $10.00 |
| 2 LED Illuminators and 1 power supply | 10.00 |
| 1 Simplified LARCA incl. local com to & interface to Vehicle | 30.00 |
| video | |
| 1 PC running LAR-System software (per seat pair) | 10.00 |
| | $60.00 |

Basic costs for 80 seat coverage (40 pairs) are $30 per seat or ˜$2,400. NOTE: The above estimated costs are for basic parts and production/assembly in quantities of 100+. Assumes pre-existing Video displays and excludes cost of one PC running LAR-System per Bus or Rail Car. In aircraft, these costs/passenger would potentially double or more because of airborne equipment regulations etc.

D.05.8 “Easy-Mount” LAR-Readers

LAR-Readers to implement “home-scale” LAR-Systems such as those that might cover areas or venues such as a desk-top, a family room, a child's play area or any other location where a TV or other display is also available. An “Easy-Mount” LAR-Reader can be comprised of a small digital camera, or a Webcam or equivalent with support apparatus as described in PART A. One or more such LAR-Reader assemblies, each mounted on an individual adjustable tilt and rotate member, can simply be screwed into standard desk or reading lights, floor-lamps, ceiling fixture lamp sockets and/or clamp-on work lights etc. Commonly available dual-light socket adapters can be used to also accommodate the original lamp-bulb if desired. Obviously, other methods of “home-style” or temporary hanging or mounting can be used.

A given LAR-Reader can be powered by the existing venue electrical system or can use on-board photo-voltaic or separately charged batteries. The USB port built into the camera or in its plug-in data storage card can provide a wireless data and control channel to the venue computer supporting the LAR-System. (Data transfer over venue power wiring could also be used.)

### Part E. Methods and Apparatus for Automated Auctions, Point of Purchase and Impulse Purchasing

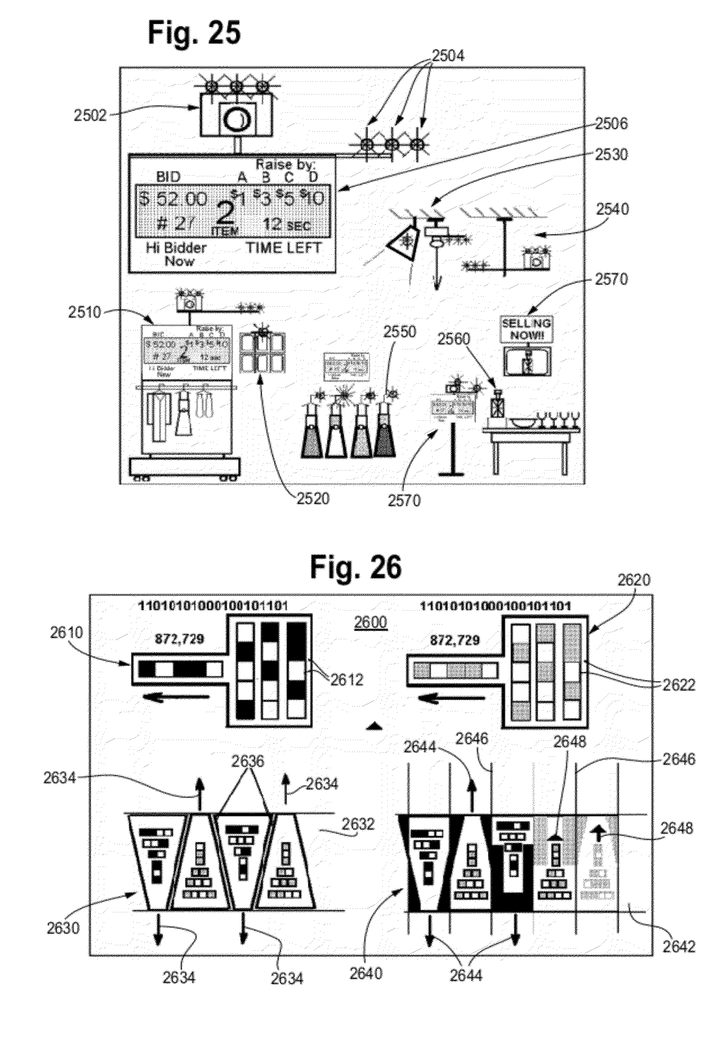

FIG. 25 schematically displays examples of some salient features of methods and apparatus useful for implementing and/or conducting novel “Automated Auctions” or other “live-action” purchasing activities. Particular versions of the apparatus and system can be aptly described as “Automated Auction Stations” or “Auctions in a Box”.

A typical LAR-Reader 2502 (See also PART A of this disclosure) is connected to a LAR-System or Systems serving a venue in which automated auctions and other types of merchandizing events or activities, contests etc. take place. One or several types of LAR-Readers together with supporting apparatus, e.g. PLCMs, Illuminators and software etc., can be operating in the venue and can also be installed in associated approaches or environs. Participation in venue-based events can require that participants use LARsponders/LARcodes of particular types which can be obtained or acquired in conformance with criteria defined by the LAR-System operator/owner or event sponsor.

LARsponders intended for use in a particular venue or at a particular event can be distributed via direct mail, newspaper inserts, tip-in Ads, on-site handouts etc. and can be disposable or re-useable. They can be “card-like” 2D or other forms of LARsponders. They can be fully or partially coded and/or can optionally require further validation.

Validation for example, may a pre-printed, uniquely coded LAR-sticker (which can include Locate regions such as retro-reflective areas) which the Venue Operator issues to a Bidder at “check-in”. This LAR-sticker can be adhered to the Customer/Bidder's LARsponder Card which (along with a pre-printed Base Code on the LARsponder if desired) renders the LARsponder operational. The LAR-System can, for example, require that all data Blocks in both the Base Code and Sticker Code must be in view and/or in proper relative spatial relationship to each other.

Each validated LARsponder can be assigned a unique identifier number (“Paddle Number”) and the LARsponder becomes the participant's Bidder's Paddle in the traditional jargon of auctions.

A user's Paddle Number can reference the LAR-System Data base for the user's identity, address, credit limits, demographics, date and time limits etc. or other restrictions on its validity as approved by the Event or Venue Operator. Using these general types of data, each attempt to signal a bid to a LAR-Reader can be instantly accepted or rejected by the LAR-System.

The LAR-System data processing software can require that some additional qualifying action on the part of the user is needed to produce a firm bid interpretable and/or acceptable by the System. For example, to avoid an “inadvertent bid” offering, a valid bid can (but optionally need not) also require a follow-up wave, gesture movement or other confirmation action executed by the bidder. Similarly, the LAR-System software can require motions such as waving and holding up the Paddle until the bid is acknowledged by the LAR-System. This can also minimize paddle occultation issues. In addition and in some circumstances, e.g. crowded venues, LARsponders can also be designed to be mounted on stick-like extension handles for presentation to LAR-Readers.

NOTE: LARsponders used as Paddles can typically be passive devices, but actively-powered response devices and combinations of both active and passive apparatus can also serve as Bidder Paddles if desired by the venue operator. Such active devices can be Smart-phones, Tablets, and similar mobile devices (MIDs) with networked and bi-directional communications data-exchange capabilities as described in earlier Sections of this disclosure. These can be adapted for use as Bidder Paddles by installation of LARsponder software and physical LARsponder features and/or LARcodes. These physical features (RRs, aiming directions, etc.) allow LAR-Readers in the venue to collect user inputs via images of the Paddle orientation, motions etc. without necessarily relying on fast, high-quality third party communications provider support.

An installed “AuctionApp” software (or similar versions which can have additional non-auction uses as well) can accommodate entering timely Bids using system-assigned Paddle numbers.

The wireless network can be monitored by the LAR-System to insure data handling has sufficiently low latency required for fast-changing bidding.)

Additionally, Network-based Paddle users working with bi-directional and personal links can enable LAR-Systems to send and exchange many other types of useful data, e.g. newly added auction items tailored to a user's interests, individualized, special time-dependent buying opportunities available elsewhere in the venue etc.

2504 is a generic representative of Illuminators which can facilitate LAR-Reader data acquisition operations and which can be mounted in locations laterally displaced from a given LAR-Reader's LOS.

2506 is a display presenting dynamically variable data and information needed by LARsponder users participating in the event. Each Auction, while running, is automatically updated by the LAR-System software and the current high-bid or winning Paddle number is posted. During action typical of auctions, basic data, as shown on display 2506, can include the item being auctioned-here ITEM #2, the current high BID, here $52.00 held by LARsponder BIDDER #27 and bidders are also informed that there are 12 seconds remaining before the “sold” hammer falls. A “Topping” bid Raise, in this illustrative case, can be an increment chosen from among, say, four choices—$1, 3, 5, or 10 dollars. In this illustration, a bid raise can be signaled by a LARsponder user who timely “presents” a Raise choice of A, B, C, or D to a LAR-Reader.

Timing remaining before “hammer” can be counted-down both on Venue display screens and by voice audio in appropriate areas.

The number and the size of permissible increments can vary with the item being auctioned and can be scaled to the price estimate of the item.

Acceptable increments of bidding can vary dynamically during the bidding process and can take into account a public minimum acceptable price and/or an “unseen reserve price” for each item being auctioned.

In cases of tied bids (occurring within a Software-defined time interval of each other), visual and audio notification thereof can be followed by announcement of a new bid opportunity at the next scheduled or at a programmed dynamically adjusted bid increment.

LARsponders and a venue's LAR-System can also enable other types of bidding, interactive and responsive actions using various methods and apparatus described herein.

The above described classes of functional components (other than the LARsponders) can be packaged (boxed”) together for reasons such as convenience of installation, mobility, etc. 2510 exemplifies one form of such an “Automated Auction Station” on wheels. Display space is provided for items being offered for auction, e.g., items of clothing on a rack.

Automated Auction Stations can be located in store windows, corridors, aisles, entry-ways etc. Additional video displays and arrays of video picture frames 2520 can show on-auction items to potential bidders who are not in the immediate vicinity of a Station. 2530 illustrates a LAR-Reader and Illuminator mounted separately from a display (not shown). Such assemblies can be associated with other venue light sources for aesthetic or other reasons.

2540 makes the point that separately-mounted light sources can serve as system-controlled Illuminators offset from a Reader's LOS.

Items not located at an Auction Station but nevertheless going “on the block” can be high-lighted by LAR-System controlled flashing tag-lights. They can, for example, be placed on hangers 2550; on objects; on tables 2560 and shelves. These can be battery-powered and wirelessly connected to the LAR-System. Such powered lighted tags can carry LARcodes or themselves be in the form of LARcodes comprised of illuminated color-coded regions interpretable by LAR-Readers.

Digital displays or highlighted photos of an item on auction can be positioned within view of potential bidders 2570 who are not near a Station. Their LARsponder Bids can be read by LAR-Reader Module assemblies such as in 2530, 2540, and 2570.

Miscellaneous demarcated areas in a venue wherein LAR-Reader Modules (e.g. mounted as in 2540) can view Auction participants/bidders and their LARsponder can be indicated via signs, floor stripes, lighting etc.

Start of periodic or “surprise” AUCTION ACTION in a venue can be signaled by flashing signs, sound and light effects, PA announcements etc.

Actual items “On the block” at any given time can be highlighted by system-controlled spotlights, eye-safe laser beams.

Optionally and if desired in certain circumstances or to create a sense of competition and excitement, auction current high-bidder holders and/or final winners can be high-lighted by servo-aimed lights or other methods since the physical location of any winner is available to the LAR-System from the LAR-Reader(s) viewing the winner's LARsponder.

In addition to capabilities and methods described above, Venue LAR-System software can offer numerous other features, attractions, and “entertaining” functions including but not limited to item, event, or user-tailored capabilities such as:

“Buy it now” pre-emptive bid” signaling can be offered real-time.

Synthetic voices of auctioneers can be available to audiences via PA, wireless earphones, smart-phone apps etc.

Animated images and/or computer-synthesized auctioneer “characters” or human surrogates can be displayed on Auction display screens

Display and simultaneous participation in in-process auctions taking place elsewhere in the venue or in another venue) can be accommodated while a user is waiting in demarcated area for a different impending Auction to begin.

A given LAR-Reader can be multiplexed to route an appropriately-coded Paddle's Bid signals to more than one auction.

Real-time Bid status cues to ‘bid NOW” etc. can be wirelessly relayed to a Paddle user via wireless local and/or personal audio channels assigned by the venue or can be conveyed via registered cellphones etc.

Similarly to the above, suggestions, guidance, and/or specific directions to closely-related items which can be found in-store or elsewhere can be conveyed to losing bidders. These suggestions can also include items scheduled to be auctioned subsequently or at some specific time in the future.

### Part F. Methods and Apparatus for Personalized Inputs, Group Inputs, & Related System Responses

### F.01 “Locate” Elements as Simplified Larsponders

Certain classes and types of LOCATE elements in LARsponder and/or LARcodes can, themselves, convey responses via user manipulation of the Element's “pose” in 3D-space and time. Examples of such LOCATE elements are Elements 1402, 1406, 1404 in FIG. 14, Element 1520 in FIG. 15, and Element 2016 in FIG. 20. One prominent or principal vector direction axis is typically very apparent in these types of Elements or can be made so by adding graphic or structural features. Orienting such a Locate Element with a principal vector axis posed up/down, left/right, at an angle etc. and/or the user causing motions or position displacements of a principal axis or other axes comprises a considerable repertoire of response behaviors. NOTE: While the emphasis here is on Locate Elements typified by the examples listed above, triads of vector directions (as in 3 axis rectilinear coordinate systems) can provide more extensive repertoires of response signaling options as discussed elsewhere herein.

In some situations wherein LOCATE type elements are serving as basic LARsponders, accompanying color code data may be minimal or may not be required. In the latter case, the “scene-ambient brightness levels” (i.e., areas not at retro-reflective brightness”) relatively small color code blocks representing data need not be captured and precisely analyzed. This can enable retro-reflective areas to be relatively larger for a given overall size of LARsponder. This, in turn, can permit a significantly larger area venue and audience size to be serviced by a single LAR-Reader with a given image resolution. In practice, several thousand venue seats can be covered per Reader compared to several hundred seats per Reader as in the illustrative example presented in Section D.05.5.

Without the need for precise color block reads, deliberate under-exposure of the general venue scene can be used to render images of RR regions of LARsponders, when excited by a LAR-Reader's light source (single flash or sequence of flashes), as very bright areas against a dark venue background. Well-known image analysis software can be used to find and precisely locate the coordinates of the bright “blobs” (the RRs). “Convex hull” algorithms, for example, can create definitely-shaped enclosing boundaries around a given isolated RR blob. These and/or other well-established image analysis methods can be used to very rapidly determine what choices, what particular vector orientations, what changes of locations and/or directions of movement etc. multiple LARsponder users are signaling to a LAR-Reader or a group of LAR-Readers.

### F.02 Binary Coded Retro-Reflective LAR-Sponders and Related Matters

Examples of RRLARcodes (Retro-Reflective LARcodes) have been disclosed earlier in this document. Sections A.15, A.16, B.08 and B.09 among others, are particularly relevant to what follows.

Retro-reflective coded areas can be used as components of LARsponders and/or LARcodes. LARsponders using RR “LOCATE” shapes, graphics, or other design features have been described earlier. In this Section, methods and apparatus are disclosed which retain the general repertoire of response modes described above in F.01, but which, in addition, can optionally provide other capabilities, notably the binary encoding of data such as User IDs, user special privileges, Responder validity limitations, etc. all of which can be carried on the LARsponder and all of which can be located and read by LAR-Readers at long stand-offs.

FIG. 26 shows several LARsponders in an area 2600. 2610 illustrates an example of a binary-coded LARsponder according to the teachings herein. Note the inherent shape-defined principal vector of the paddle-like LARsponder. Other principal vector shapes, among many, have already been mentioned. The LARsponder shown can be a surface that is entirely retro-reflective. The surface can carry an array of blacked-out blocks making up, for example, the binary code for the ID number 872,749. The black block “1's” can be laser-printed using ordinary black or other opaque pigment toner that adheres to and covers/obscures the glass micro-bead reflectors. (Typical ink-jet inks do not adhere.). Certain RR microsphere (and/or micro-prism type RR) sheets and tapes are supplied faced with a transparent film that is bonded to the RR layer 2612 in such a way (e.g. not in intimate contact with the micro-spheres) that their RR properties are not significantly degraded. Roadstar Reflective Material Co., Ltd. is one source of such materials. These particular types of RR's can be coded by applying pigments or inks for which the overlying layer is (or can be made) what the art terms “receptive” (to color).

2620 shows an alternative method of binary block coding offering certain aesthetic and novel security advantages can be used to encode data on retro-reflectors that are fabricated by allowing micro-spheres to partially protrude out of the retro-reflective surface. (3M RR sheet and tapes Type 8830 are examples of this type of material.) For such RR materials, overprinting code blocks (or other graphics) on the RR surface 2622 can be done with a clear pigment carrier (such as used for laser pigments but without the pigment particles). In 2620, this is represented by the lightly dotted patterns. Other graphical features, art, etc. can be printed in a similar manner. In general, any adherent clear over-coatings with indices of refraction high enough to severely alter the normally desired microsphere glass/air refraction effects can be used. Any such over-coated areas will appear very dark and easily readable by an imager dependent upon receiving retro-reflected light but will appear as clear un-coded areas under general ambient illumination.

Another useful capability of the coding method just described is its ability to allow another and non-retro-reflective color code to occupy the same area as the over-printed RR code. The former is encoded using transparent color gels, dyes or inks on a thin transparent layer overlying the RR but not in intimate contact with it thus allowing the air/microsphere refraction effects to be maintained

While binary block coding has been used for the discussion thus far, it is important to emphasize that other forms of codes (e.g. bar-codes, holes, edge notches, QR codes etc. whose specific overall orientation in space per se does not change the code's message can be used in the same way as taught above. They can be placed on an RR base object which has a shape and/or other feature(s) that define at least one principal vector direction. This combination can simultaneously signal messages to an information system which contain BOTH user-controllable variable responses/inputs via orientation (e.g., “I want 1, 2, 3, or four of those.”) etc. along with any associated fixed-data coded on the LARsponder.

2630 portrays another example of a Reflective LARsponder shape with an obvious principal vector axis 2634. Here, the binary code blocks are positioned to make efficient use of the available LARsponder RR area 2632. In addition, the RR shape and its fabrication method shown cuts, along separator or cut lines 2636, the LARsponders from a roll of RR tape material 2632 with near-zero waste. Both opaque pigment (represented in black) and clear over-print coding examples are shown.

2640 shows a production method using printing (e.g. laser) on an RR tape 2642 where, in the three left-hand examples shown, the principal vector axes 2644 are made evident by black (or other opaque) pigment coated areas plus (optionally) code element arrays “stacked” in triangular patterns. The latter allow inference of a vector axis direction for both participating users and for the system's image analysis/decoding software. The two right-hand examples in 2640 show the use of straight “Guillotine” cut lines 2646 which are simple to automate and very effective in conserving RR material. Use of clear-overprinting which is nearly invisible to a casual observer defines a vector axis in RR light. Such areas can display color texts, color codes, Ads and/or other graphics if these are printed on a carrier film arranged to be slightly air-spaced off of the RR micro-spheres, micro-prisms etc. Two typical examples of ordinary opaque overprinted arrows 2648 for user guidance are also shown.

Note that any of the above described methods adapt well to high-speed printing. Furthermore, they can exploit existing high speed product labeling technologies and can easily accommodate changes of active RR shapes etc which can be read by imagers and used for a variety of purposes (e.g. distinguishing different groups of users in a single venue or otherwise and/or for conveying other information such as expiration dates, limitations on use, event types etc. Note further that silk-screening technologies may be a method of choice for production of the above-described and for other forms/features of LARsponders mentioned previously in other Sections of this Disclosure

Add-on methods using RR stickers and/or decals can also be used to carry information in the forms described and can be a method of choice notably in comparatively short-run production of RRLARsponders.

### F.03 Features and Use of Group Forming and Individually Coded Larsponders

The methods and apparatus described above can assign codes to individual LARsponders that are unique to the individual users thereof and/or can signal membership in defined groups, teams or other criteria/qualifications for association and/or for participation in a given event or events. These codes can be read along with the choices/responses signaled on cue by each participant. The results can be reported to the audience in the venue in which the live “action”, challenges, or other opportunities for choices or other from of response are presented. Collective responses and scores can be reported for “audience teams”, seating sections, pre-registered members of Fan-clubs and/or any other types of groups etc. attending the event.

### F.03.1 Multi-Site, Individual, and Team Real-Time Participation

Selective live-feeds of the challenges, predictions, results, answers, choices, etc. made by or to the primary live-venue audience using Responders can also be electronically reported, e.g. via internet, WiFi, video, etc. to other venues including Stadiums, theaters, Casinos, Sports-Bars, etc. These remote venues can also be equipped with LAR-Readers and the audiences in such venues can be provided with Responders. Thus, they can participate real-time and on almost equal footing in the happenings taking place in the primary originating site. Multiple remote audiences can observe and timely engage in and respond to the same challenges seen by the primary in-venue live audience and/or other participating remote sites. This enables unique forms of real-time Crowd against Crowds competitions and other modes of direct event participation and input to distant events.

If network or other transmission delays from the originating site to the remote sites are significant to some forms of inter-venue competitions, e.g. first to chose correctly, time-limits on picking an answer, predicting a race winner etc., these can be compensated by time-stamping the incoming challenges etc. to the remote sites, the timing of any cues or limits they are given to respond to such inputs and their subsequent response times. Such local time-stamping can be based upon widely available precision time signals broadcast by government agencies and other sources. Assume, e.g, 30,000 attendees, some with Responders, are at a tennis match, a golf tournament, a political rally or a live debate etc. Real-time media coverage (Broadcast TV, Cable, Net-Casting, WI/FI, Smartphone Feeds/Apps, etc.) of the event is being provided to national or even international audiences among which are audiences who are gathered and watching in venues other than at the event site itself. These can be what otherwise might be “dark” stadiums, theaters, concert halls, city squares, etc. The total capacity involved could be 10× or much more than the size of the originating venue.

Assume such sites are equipped with LAR-Readers and real-time capabilities for display of imagery of events in progress and the event attendees are supplied with Responders (e.g. disposable versions). The Responders allow them to input massed opinions, answers etc. in the same sub-second (effectively instantaneous) manner that is available to the originating venue's Responder-equipped members of the “live” audience. Both live and remote audience inputs/choices can be instantly available for incorporation in the originating live coverage itself. Thus, instead of merely real-time “observing” of a distant live event, large masses of participants present in these “outlying” venues can comment, quantitatively express agreement or disapproval, predict an outcome, vote, and affect the “live” broadcast commentary of experts and/or “authoritative personalities” covering the originating event etc.

In addition, the originating venue management can choose to invite inputs from individual users of “social media”, texting inputs and the like. The live event directors can then choose certain of these commentaries etc. and invite and receive instant quantitative reaction data from the much larger cumulative audiences in the participating remote venues.

Another novel aspect of the above described methods and apparatus is an ability to organize and operate COMPETITIONS between venues. Collective responses to questions, making choices from among options, choosing right answers among wrong answers, and signaling predictions, e.g. “who will score the most points in the last 3 minutes of the third quarter of the basketball game now going on in Miami?” etc. are all possible to answer en mass and can be quickly communicated using Responders. Venues can be divided into teams and/or an entire venue population can be a team competing against another entire venue. Many forms of real-time contests can be implemented as entertainment. Venue data and video displays as well as audio systems, real objects as moving targets etc. and various board-game moves etc. can present and/or be the basis of the competitions. Furthermore, as described in some detail in Section C.03, Joy Stick Responders (FIG. 17) and precision “Aiming” Responders (FIG. 16) can be supplied and used simultaneously by audience members formed into teams to play many types of dynamic real and image-based games. These can, among many other types of challenges, involve pointing at fixed or moving targets, pointing as a means of fast selection or “defense”, predicting trajectory motions and the like. The time-dependent inputs during a given task performed by each team or an entire venue can be averaged or otherwise weighted/scored to determine which team (or entire competing venue) was more accurate at, e.g. tracking a moving target in a video sequence or a fast moving spot light on the stadium floor—“prizes to be awarded” etc.

F.03.2 High Frequency Wagering and/or Bidding

Responders of various types can carry code numbers that are unique to the specific user/owner. See 2610, for an example of this general class of Responders. Such codes (in binary as shown, or in other formats) allow a User to be instantly located and identified by a LAR-Reader System The coded Responder can also qualify the user, e.g. signify pre-set credit limits, pre-determined bet sizes, etc. They can provide a basis for novel and exciting high-speed (essentially instantaneous) “High-Frequency” betting which can take place “on-cue” during many types of events. Note that Responders can be up-dated and coded with added Stickers giving access to specific transaction types/events/credit limits, validity dates etc.

“HF Betting now open” cues can take many forms: Flashing lights, video clocks, voice announcements, sirens etc. which can prompt bidding and/or wagering and similar actions by Responder users during an event.

At a Race Track, for example, a pre-registered audience member in a LAR-System-equipped venue can signal a pre-agreed size bet on, say, one of four different horses. High Frequency (HF) Bets can be placed on a horse race ALREADY in progress as distinct from (and/or in addition to) the traditional bets laid down before the race starts. This can be done by presenting one of four orientations of the (e.g.) Responder type 2610 to a venue LAR-Reader on cue and holding it until e.g. a bright flash etc. signals “all bets acquired betting closed”. (The bright flash can be the LAR-Reader's RR illuminator capturing an image showing the location and “pose” of the Responders held by participating users.)

For horse races, the window open cues can be understood by bettors to mean that HF betting is now open for, e.g., four seconds, and will be triggered just as the lead horse passes the quarter pole. HF Betting ‘windows” can be similarly opened again at several pre-announced later points in the same race, such as at the half and the three quarter poles.

For Basketball, Hockey, Auto Racing and similar activities, HF Betting windows can be opened at various times and/or for appropriate durations and especially at times when the games become particularly exciting, e.g. the last quarter of a basketball game or the last 36 laps of the Indy 500 etc.

HF Betting “action” does not require that the pre-qualified bettors be physically at the event. Video or other types of coverage can be used to implement HF Betting in Casinos, SportsBars, etc. equipped with LAR-Readers.

### F.03.3 Intra-Venue Private Competitions & Wagering

LAR-System equipped venues can offer opportunities for private personalized fan VS fan or group VS group betting and interactions even if the fans are not seated in close proximity. Using coded Responders, for example, Seat 36C can bet against Seat 127G or the DELTA Frat can bet against the ALPHA Frat and records of results reported by the local Venue System post-facto. It would seem possible that private bets/wagers of this type may not require making use of typical government-regulated communications channels.

I claim:

1. A participation method whereby one or more persons who are physically present in a venue can convey information, comprising:
a) providing a digital imager in a venue, the digital imager having a field of view,
b) providing one or more persons with a passive, user-manipulated personal data-source device that are visible within the field of view, wherein the user manipulate the device to convey information,
c) taking an image of the devices using the digital imager,
d) computer analyzing the image to determine the conveyed information from the manipulated device, and
e) outputting the conveyed information.
